(19) United States
(12) Patent Application Publication
(10) Pub. No.: US 2019/0056541 A1
(43) Pub. Date: Feb. 21, 2019

(54) System and Method for Efficient Reflection

(71) Applicant: Cedar Ridge Research LLC, Huntsville, AL (US)

(72) Inventors: Mark D. Roberts, Huntsville, AL (US); Prentiss W. Haines, IV, New Hope, AL (US); Michael P. Demos, Huntsville, AL (US)

(73) Assignee: Cedar Ridge Research LLC, Huntsville, AL (US)

(21) Appl. No.: 16/051,520

(22) Filed: Aug. 1, 2018

Related U.S. Application Data
(60) Provisional application No. 62/546,952, filed on Aug. 17, 2017.
(60) Provisional application No. 62/617,898, filed on Jan. 16, 2018.
(60) Provisional application No. 62/762,552, filed on May 9, 2018.

(51) Int. Cl. G02B 5/122; G02B 5/136

(52) U.S. Cl. CPC G02B 5/122; G02B 5/136

(57) ABSTRACT

An improved reflective surface includes multiple first truncated triangular trihedral corner reflectors and multiple second truncated triangular trihedral corner reflectors, each including a retro-reflecting component and a scattering component corresponding to a truncation of a triangular trihedral corner reflector by a truncating object having a plurality of corners and a triangular or rectangular shape. The retro-reflecting component is a remaining triangular trihedral corner reflector that remains after the truncation of the triangular trihedral corner reflector and the scattering component is a portion of the truncated triangular trihedral corner reflector other than the remaining triangular trihedral corner reflector, where no corner of the plurality of corners of the truncating object is in alignment with a corner of the opening of the triangular trihedral corner reflector.

### CROSS-REFERENCE TO RELATED APPLICATIONS

This United States Non-provisional Application claims priority to U.S. Provisional Applications Ser. No. 62/546,952, filed Aug. 17, 2017, titled “System and Method for Efficient Reflection”, Ser. No. 62/617,898, filed Jan. 16, 2018, titled “System and Method for Efficient Reflection” and Ser. No. 62/762,552, filed May 9, 2018, titled “System and Method for Efficient Reflection”, which are all incorporated by reference herein in their entirety.

### FIELD OF THE INVENTION

The present invention relates generally to a system and method for efficient reflection. More particularly, the present invention relates to a system and method for efficient reflection of light rays, radio frequency signals, or other electromagnetic waves.

### BACKGROUND OF THE INVENTION

In certain applications, reflective surfaces are used to cause the specular or mirror-like reflection of light rays, radio frequency (RF) signals, or other electromagnetic (EM) waves, where the reflected light rays, RF signals, or other EM waves have the same angle to the reflective surface normal as the incident light rays, RF signals, or other EM waves.

In other applications, reflective surfaces are used to cause the diffuse reflection of light rays, RF signals, or other EM waves, where the light rays, RF signals, or other EM waves that encounter the reflective surfaces are scattered at many angles.

In other applications, reflective surfaces of devices known as retro-reflectors are used to retro-reflect (or redirect) light rays, RF signals, or other EM waves back towards their origin (i.e., source location) with a minimum of scattering, where a EM wave is reflected back along a vector that is parallel to but opposite in direction from the wave's source. Examples of retro-reflectors include spherical retroreflectors and corner reflectors such as triangular trihedral corner reflectors, square trihedral corner reflectors, and circular trihedral corner reflectors. Radar corner reflectors made of metal are used to reflect RF signals and optical corner reflectors called corner cubes made of three-sided prisms made of glass or plastic are used to reflect light waves.

In other applications, reflective surfaces such as parabolic (or paraboloid or paraboloidal) reflectors are used to collect or project EM waves. In optics, for example, parabolic mirrors are used to gather light in reflecting telescopes and to project a beam of light in flashlights and headlights. Similarly, parabolic antennas are used to radiate narrow beams of RF waves for communications and radar applications.

In other applications, it is desirable to have reflective surfaces that result in a combination of the specular reflection, diffuse reflection, retro-reflection, and/or parabolic reflection of light rays, RF signals, or other EM waves.

FIGS. 1A-1C depict oblique, projected, and front views of an exemplary prior art triangular trihedral corner reflector 100 having three faces 102a-102c that are each isosceles right triangles where adjoining faces are 90° relative to each other. Each of the three faces 102a-102c has two sides of length a and a third side of length c, where c=a√2, and a′a|√2 sin(60)≈0.8165a. The outer opening of the triangular trihedral corner reflector 100 has three points corresponding to three intersections of the outer edges of the three faces 102a-102c with the x, y, and z axes and is an equilateral triangle having three sides 104a-104c of length c. FIG. 1A depicts the triangular trihedral corner reflector 100 as if one face 102c is lying flat on a surface corresponding to a XY plane, where Z=0. FIGS. 1B and 1C depict the triangular trihedral corner reflector 100 as if its center point 106, which is the only common point of all three faces 102a-102c, is located on a surface, where the opening 108 of the triangular trihedral corner reflector 100 is parallel to the surface. The symmetry axis 110 of the triangular trihedral corner reflector 100 extends from its center point 106 through its opening 108 along a line that is perpendicular to the XY plane as shown in FIG. 1B. The height h of the triangular trihedral corner reflector 100 is also shown in FIG. 1B, where h=a/√3=c/√6=a′/2. In FIG. 1C the symmetry axis 110 would extend from the center point 106 directly outward from the drawing.

FIG. 1D depicts a face 102 of the triangular trihedral corner reflector 100 of FIGS. 1A-1C, which is an isosceles right triangle having two sides of length a and a third side of length c, where c=a√2.

FIG. 1E depicts a combination of the side view of the face 102 of the triangular trihedral corner reflector 100 provided in FIG. 1D overlaid on to the projected view of the triangular trihedral corner reflector 100 provided in FIG. 1B, which is indicated by a thicker boundary line. Referring to FIG. 1E, as the view of the face 102 transitions from a side view of the face in a two-dimensional plane to the projected view of face 102 as part of the three-dimensional triangular trihedral corner reflector 100 the angle at the bottom corner of the face 102 changes from 90° to 120°, the angles at the top left and top right corners both change from 45° to 30°, and the dimensions of the equal length sides of the face 102 change from a to a′, where a′≈0.8165a.

FIGS. 2A-2C depict oblique, projected and front views of an exemplary prior art square trihedral corner reflector 200 having three faces 202a-202c that are each squares having four sides of length a, where, as described above, a becomes a′ in the projected view, where a′≈0.8165a. The three faces 202a-202c have a center point 106 from which extends a symmetry axis 110 as is the case with the triangular trihedral corner reflector 100 of FIGS. 1A-1D, where the height of the square trihedral corner reflector 200 is 2h. Dashed lines between three points corresponding to three intersections of the outer edges of the three faces 202a-202c with the x, y, and z axes form an equilateral triangle 206 with three sides of length c, which are in a first (lower) plane that is comparable to the plane of the outer opening 108 of the triangular trihedral corner reflector 100 of FIGS. 1A-D. However, the opening 208 of the square trihedral corner reflector 200 corresponds to a second (upper) plane 210 that can be represented by a triangle that includes the three outermost points of the three faces 202a-202c of the square trihedral corner reflector 200, where the opening 208 could be described as having a hexagonal shape that includes six points in the second (upper) plane 210 including the three points indicated by the triangle depicted in the second (upper) plane 210 and three additional points also in the second (upper) plane 210 that are directly above the three points of the triangle depicted in the first (lower) plane 206. In other words, the opening 208 would correspond to the hexagon shaped outer perimeter of square trihedral corner reflector 200 as shown in the front view of FIG. 2C. EM waves can enter the square trihedral corner reflector 200 from above or through any one of its three side openings 212a-212c between the lower plane 206 and the upper plane 208. As such, the opening 208 of the square trihedral corner reflector 200 could be otherwise described as having a top portion corresponding to the second (upper) plane 210 and also having side portions corresponding to the side openings 212a-212c.

FIG. 3A depicts a front view of an exemplary prior art theoretical diagram 300 showing the coverage pattern obtainable from a conventional triangular corner reflector as found in U.S. Pat. No. 2,872,675. Referring to FIG. 3A, a first circle 302 corresponds to a 3 dB below peak boundary that substantially corresponds to a total 40° cone angle that is twice the 20° angle δ₀ indicated by a second circle 304, where δ₀ is the angle between the symmetry axis and the line of sight of a radar.

FIG. 3B depicts a front view of a prior art triangular trihedral corner reflector 100 having what is described as an effective area 306 corresponding to a hexagon shape defined by points a-f about the outer edges of the corner reflector, which was presented by Sloan. D. Robertson in “Targets for Microwave Radar Navigation”, Bell System Technical Journal, Vol. 216, pp. 852-869, October 1947.

FIG. 3C depicts a front view of a prior art triangular trihedral corner reflector 100 like that of FIG. 1C, which has three faces 102a-102c that are each right isosceles triangles having two sides of length a and one side of length c, where the three sides of length c form a equilateral triangle corresponding to the opening 108 of the triangular trihedral corner reflector 100. The corner reflector 100 is shown to have a hexagon-shaped acceptant area 306 and three corners 308a-308c identified as being dead zones, which are disclosed in “New Retroreflector Technology for Light-collecting Systems” found at http://opticalengineering.spiedigitallibrary.org/article.aspx?articleid=1088439.

FIG. 3D depicts a front view of a prior art symmetrically truncated triangular trihedral corner reflector 310, which is disclosed in U.S. Pat. No. 4,990,918, where the three corners, or dead zones, of a triangular trihedral corner reflector have been removed by truncating the triangular trihedral corner reflector 100 along planes 312a-312c that are each parallel to the symmetry axis 110 of the triangular trihedral corner reflector 100. As such, the symmetrically truncated triangular trihedral corner reflector 310 corresponds to the diagonally striped hexagonal portion of the triangular trihedral corner reflector 100.

FIG. 3E depicts a front view of the prior art triangular trihedral corner reflector 100 of FIG. 3B having an acceptant or effective area 306 corresponding to a hexagon shape defined by points a-f and what could be described as a rectangle shape 314 indicated by a dot-dash line representing a truncation of the corner reflector 100. Referring to FIG. 3E, the rectangle shape has a corner interfacing with interfacing edges of two abutting faces of the corner reflector 100 and having an opposite corner interfacing with the midway point of the top edge of the other face of the corner reflector 100, which could be used to truncate the corner reflector 100 such as is disclosed in U.S. Pat. No. 3,924,929.

FIG. 3F depicts a front view of the prior art triangular trihedral corner reflector 100 of FIG. 3B having an effective area 306 corresponding to a hexagon shape defined by points a-f and what could be described as a rectangle shape 316 indicated by a dot-dash line representing a truncation of the corner reflector 100. Referring to FIG. 3F, the rectangle shape 316 has a first corner interfacing with interfacing edges of first and second faces of the triangular trihedral corner reflector 100 and having a second corner interfacing with interfacing edges of second and third faces of the triangular trihedral corner reflector 100 and having a third corner interfacing with the outer edge of the first face of the triangular trihedral corner reflector 100 and having a fourth corner interfacing with the outer edge of the third face of the triangular trihedral corner reflector 100, which could be used to truncate the corner reflector 100 as disclosed in U.S. Pat. No. 3,926,402. The rectangle shape 316 has two sides that are each perpendicular to an interfacing edge of two sides of the corner reflector 100.

FIG. 3G depicts a front view of the prior art triangular trihedral corner reflector 100 of FIG. 3B having an effective area 306 corresponding to a hexagon shape defined by points a-f and what could be described as a rectangle shape 318 indicated by a dot-dash line representing a truncation of the corner reflector 100. Referring to FIG. 3G, the rectangle shape 318 has a first side interfacing with the outer edge of a first face of the triangular trihedral corner reflector 100, and two opposite corners interfacing with the outer edges of second and third faces of the triangular trihedral corner reflector 100, which could be used to truncate the corner reflector 100 as disclosed in U.S. Pat. No. 6,015,214. The rectangle shape 318 has two sides that are each perpendicular to an interfacing edge of two sides of the corner reflector 100.

FIG. 3H depicts a front view of the prior art triangular trihedral corner reflector 100 of FIG. 3B having an effective area 306 corresponding to a hexagon shape defined by points a-f and what could be described as a rectangular shape 320 indicated by a dot-dash line representing a truncation of the corner reflector 100. Referring to FIG. 3H, the rectangle shape 320 corresponds to a rectangle corresponding to the points a-c-d-f, which could be used to truncate the corner reflector 100 as is disclosed in a Full Cube Corners Video on reflectivity that can be found at http://solutions.3m.com.my/wps/portal/3M/en_MY/APAC_Roadway/Safety/Resources/Science-of-Roadway-Safety/understanding-reflectivity-and-sign-performance/understanding-retroreflectivity/. The rectangle shape 320 has two sides that are each perpendicular to an interfacing edge of two sides of the corner reflector 100.

### SUMMARY OF THE INVENTION

In accordance with one aspect of the invention, a reflective surface includes a plurality of first truncated triangular trihedral corner reflectors each having three first faces and a plurality of second truncated triangular trihedral corner reflectors each having three second faces, the plurality of first truncated triangular trihedral corner reflectors and the plurality of second truncated trihedral corner reflectors being configured into an array where outer edges of each one of the three first faces of a first truncated triangular trihedral corner reflector of the plurality of first truncated triangular trihedral corner reflectors aligns with outer edges of a corresponding one of the three second faces of a corresponding second truncated triangular trihedral corner reflector of the plurality of second truncated trihedral corner reflectors, each of the three first faces and each of the three second faces comprising a retro-reflecting component portion and a scattering component portion, the retro-reflecting component portion and the scattering component portion corresponding to a truncation of a triangular trihedral corner reflector by a truncating object having a plurality of corners, a plurality of sides, and one of a triangular shape or a rectangular shape, each the first truncated triangular trihedral corner reflector of the plurality of first truncated triangular trihedral corner reflectors and each the second truncated triangular trihedral corner reflector of the plurality of second truncated triangular trihedral corner reflectors having a remaining triangular trihedral corner reflector, the scattering component portion aligning with additional scattering component portions in the array to produce a scattering component, wherein during the truncation of the triangular trihedral corner reflector no corner of the plurality of corners of the truncating object and no side of the plurality of sides of the truncating object is in alignment with a corner of an opening of the triangular trihedral corner reflector when the truncating object has a rectangular shape.

In accordance with another aspect of the invention, a method for producing a reflective surface includes producing a plurality of first truncated triangular trihedral corner reflectors each having three first faces and producing a plurality of second truncated triangular trihedral corner reflectors each having three second faces, the plurality of first truncated triangular trihedral corner reflectors and the plurality of second truncated trihedral corner reflectors being configured into an array where outer edges of each one of the three first faces of a first truncated triangular trihedral corner reflector of the plurality of first truncated triangular trihedral corner reflectors aligns with outer edges of a corresponding one of the three second faces of a corresponding second truncated triangular trihedral corner reflector of the plurality of second truncated trihedral corner reflectors, each of the three first faces and each of the three second faces comprising a retro-reflecting component portion and a scattering component portion, the retro-reflecting component portion and the scattering component portion corresponding to a truncation of a triangular trihedral corner reflector by a truncating object having a plurality of corners, a plurality of sides, and one of a triangular shape or a rectangular shape, each the first truncated triangular trihedral corner reflector of the plurality of first truncated triangular trihedral corner reflectors and each the second truncated triangular trihedral corner reflector of the plurality of second truncated triangular trihedral corner reflectors having a remaining triangular trihedral corner reflector, the scattering component portion aligning with additional scattering component portions in the array to produce a scattering component, wherein during the truncation of the triangular trihedral corner reflector no corner of the plurality of corners of the truncating object and no side of the plurality of sides of the truncating object is in alignment with a corner of an opening of the triangular trihedral corner reflector when the truncating object has a rectangular shape.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIGS. 1A-1C depict oblique, projected, and front views of an exemplary prior art triangular trihedral corner reflector;

FIG. 1D depicts a face of the prior art triangular trihedral corner reflector FIGS. 1A-1C;

FIG. 1E depicts a combination of the side view of the face of the triangular trihedral corner reflector provided in FIG. 1D overlaid on to the projected view of the triangular trihedral corner reflector provided in FIG. 1B;

FIGS. 2A-2C depict oblique, projected and front views of an exemplary prior art square trihedral corner reflector;

FIG. 3A depicts a front view of an exemplary prior art theoretical diagram showing the coverage pattern obtainable from a conventional triangular corner reflector;

FIG. 3B depicts a front view of a prior art triangular trihedral corner reflector having what is described as an effective area corresponding to a hexagon shape;

FIG. 3C depicts a front view of a prior art triangular trihedral corner reflector having a hexagon-shaped acceptant area;

FIG. 3D depicts a front view of a prior art symmetrically truncated triangular trihedral corner reflector 310, where the three corners, or dead zones, of a triangular trihedral corner reflector have been removed by truncating the triangular trihedral corner reflector;

FIGS. 3E-3H depict front views of prior art triangular trihedral corner reflectors having an acceptant or effective area corresponding to a hexagon shape and what could be described as different rectangle shapes representing different truncations of the corner reflector;

FIG. 4A depicts a front view of a triangular trihedral corner reflector like that depicted in FIGS. 1C and 3B having an opening that is a first equilateral triangle within which a second equilateral triangle is indicated with a dashed line and a circle encompassing the corner reflector indicating rotations of the second equilateral triangle relative to the first equilateral triangle in accordance with the invention;

FIG. 4B depicts a front view of the triangular trihedral corner reflector like that of FIG. 4A, where three planes corresponding to the truncating equilateral triangle of FIG. 4A are each parallel to the symmetry axis of the corner reflector;

FIG. 4C depicts an oblique view of the truncation of the triangular trihedral corner reflector of FIGS. 4A and 4B in accordance with the invention;

FIG. 4D depicts a side view of a face of the triangular trihedral corner reflector of FIGS. 4A-4C;

FIG. 4E depicts a side view of the remaining right kite shaped face of the triangular trihedral corner reflector of FIGS. 4A-4C after truncation;

FIG. 4F depicts a first equilateral triangle truncated triangular trihedral corner reflector having three truncated right kite-shaped faces such as shown in FIG. 4E;

FIGS. 4G-4J depict top, front, and back views of the first truncated corner reflector in accordance the invention;

FIGS. 4K-4O depict various three-dimensional views of the first equilateral triangle truncated triangular trihedral corner reflector of FIGS. 4F-4J;

FIG. 4P depicts exemplary triangular faces that can optionally be used to fill the openings of the first equilateral triangle truncated triangular trihedral corner reflector of FIGS. 4F-4O;

FIGS. 4Q-4T depict front, side, and oblique projection views of an exemplary equilateral triangle truncated triangular trihedral corner reflector array in accordance with the invention;

FIG. 4U depicts a right kite-shaped face 404 like that shown in FIG. 4E that has been rotated;

FIG. 4V depicts a first equilateral triangle truncated triangular trihedral corner reflector like that of FIG. 4F with dashed lines corresponding to a triangular trihedral corner reflector;

FIG. 4W depicts an exemplary array of six of the first truncated corner reflectors arranged in a circular pattern having an outer boundary having a hexagonal shape;

FIG. 4X depicts a projected view of the right hexagonal pyramid of FIG. 4W;

FIG. 4Y depicts multiple views of the face of FIG. 4U including a top view, four side views and four isometric views;

FIGS. 4Z-4AB depict projected views of alternative ‘taller’, ‘shorter’, and ‘inverted’ right hexagonal pyramids that could be used in the array of FIG. 4W in place of the right hexagonal pyramid depicted in FIG. 4X;

FIGS. 5A and 5B each depict a front view of a corner reflector like that depicted in FIGS. 1C and 3B having an opening that is a first equilateral triangle within which a second equilateral triangle is indicated with a dashed line and a circle encompassing the corner reflector indicating rotations of the second equilateral triangle relative to the first equilateral triangle, where in FIG. 5A the second equilateral triangle points left and in FIG. 5B the second equilateral triangle points right;

FIG. 5C depicts a front view of the corner reflector like that of FIG. 5A, where three planes that are each parallel to the symmetry axis of the corner reflector are shown intersecting with the three sides of the second equilateral triangle of FIG. 5A;

FIG. 5D depicts a front view of the corner reflector like that of FIG. 5B, where three planes that are each parallel to the symmetry axis of the corner reflector are shown intersecting with the three sides of the second equilateral triangle of FIG. 5B;

FIG. 5E depicts a side view of a face of the corner reflector of FIGS. 5A and 5C, which has three faces that are each isosceles right triangles;

FIG. 5F depicts a side view of a right trapezoid-shaped face that remains after truncation of the face of the corner reflector depicted in FIG. 5E;

FIG. 5G depicts a second equilateral triangle truncated triangular trihedral corner reflector having three truncated right trapezoid-shaped faces such as depicted in FIG. 5F;

FIG. 5H depicts a side view of a face of the corner reflector of FIGS. 5B and 5D, which has three faces that are each isosceles right triangles;

FIG. 5I depicts a side view of a right trapezoid-shaped face that remains after truncation of the face of the corner reflector depicted in FIG. 5H;

FIG. 5J depicts a third equilateral triangle truncated triangular trihedral corner reflector having three truncated right trapezoid-shaped faces such as depicted in FIG. 5I;

FIGS. 5K-5N depict front and back views of the second truncated corner reflector of FIG. 5G;

FIGS. 5O-5T depict various three-dimensional views of the second truncated corner of FIG. 5G;

FIGS. 5U-5X depict front and back views of the third truncated corner reflector of FIG. 5J;

FIGS. 5Y-5AD depict various three-dimensional views of the third truncated corner reflector of FIG. 5J;

FIGS. 5AE-5AH depict top, side, and oblique projection views of an exemplary second equilateral triangle truncated triangular trihedral corner reflector array in accordance with an aspect of the invention;

FIG. 5AI depicts a right trapezoid-shaped face like that shown in FIG. 5F except it is rotated;

FIG. 5AJ depicts a right trapezoid-shaped face like that shown in FIG. 5I except it is rotated;

FIG. 5AK depicts a second truncated corner reflector like that of FIG. 5G with dashed lines corresponding to a corner reflector having three faces each being an isosceles right triangle;

FIG. 5AL depicts a third truncated corner reflector like that of FIG. 5J with dashed lines corresponding to a corner reflector having three faces each being an isosceles right triangle;

FIG. 5AM depicts an exemplary array of three of the second truncated corner reflectors and three of the third truncated corner reflectors arranged in a circular pattern having an outer boundary having a hexagonal shape;

FIG. 5AN depicts a projected view of the right triangular pyramid of FIG. 5AM;

FIGS. 5AO-5AQ depict projected views of alternative ‘taller’, ‘shorter’, and ‘inverted’ right hexagonal pyramids that could be used in the array of FIG. 5AM in place of the right triangular pyramid depicted in FIG. 5AN;

FIG. 6A depicts a projected view of an exemplary triangular trihedral corner reflector such as depicted in FIG. 1B overlaid onto a projected view of an exemplary square trihedral corner reflector such as depicted in FIG. 2B;

FIG. 6B depicts a front view of the exemplary triangular trihedral corner reflector, square trihedral corner reflector, and trihedral corner of FIG. 6A, where the rotational plane of FIG. 6A is shown to be a circle;

FIG. 6C depicts the exemplary trihedral corner and exemplary rotational plane of FIGS. 6A and 6B with a truncating equilateral triangle instead of the exemplary triangular trihedral corner reflector and square trihedral corner reflector;

FIG. 6D depicts how each of the three corners of the equilateral triangle corresponding to the opening of the triangular trihedral corner reflector can be designated as being a reference 0° rotation;

FIG. 7A depicts a side view of an exemplary isosceles right triangle such as is depicted in FIG. 1D;

FIGS. 7B-7H depict side views of the exemplary isosceles right triangles of FIG. 7A having dashed lines indicating the lower portions of the faces produced from equilateral triangle truncations of a triangular trihedral corner reflector with truncation rotations of 5°, 10°, 20°, 30°, 40°, 50°, and 60°, respectively;

FIG. 7I depicts the exemplary isosceles right triangle of FIG. 7A having dashed and solid lines that indicate the lower, upper, and truncated portions of the isosceles right triangle 102a corresponding to truncation rotations of 5°, 10°, 20°, 30°, 40°, 50°, and 60°;

FIG. 7J depicts the exemplary isosceles right triangle of FIG. 7A having dashed and solid lines that indicate the lower, upper, and truncated portions of the isosceles right triangle 102a corresponding to truncation rotations of 5°, 10°, 20°, 30°, 40°, 50°, 60°, 70°, 80°, 90°, 100°, 110°, and 115°;

FIG. 8A depicts a front view of a triangular trihedral corner reflector without a truncating equilateral triangle;

FIG. 8B-8G depict front views of equilateral triangle truncated triangular trihedral corner reflectors that correspond to equilateral triangular truncations of a triangular trihedral corner reflector in accordance with the invention at 5°, 10°, 20°, 30°, 40°, 50°, and 60° rotations, respectively;

FIG. 8I depicts the exemplary triangular trihedral corner reflector of FIG. 8A overlaid with each of the equilateral triangle truncated triangular trihedral corner reflectors that correspond to equilateral triangular truncations of a triangular trihedral corner reflector in accordance with the invention at 5°, 10°, 20°, 30°, 40°, 50°, and 60° rotations, respectively;

FIG. 9A depicts an exemplary array of six triangle triangular trihedral corner reflectors;

FIGS. 9B-9G depict front views of exemplary arrays each comprising three equilateral triangle truncated triangular trihedral corner reflectors produced by equilateral triangular truncations of a triangular trihedral corner reflector in accordance with the invention at 5°, 10°, 20°, 30°, 40°, and 50° rotations, respectively, in an alternating pattern with three ‘mirror image’ equilateral triangle truncated triangular trihedral corner reflectors produced by equilateral triangular truncations of a triangular trihedral corner reflector in accordance with the invention at 115°, 110°, 100°, 90°, 80°, and 70°, rotations, respectively;

FIG. 9H depicts the exemplary array of six first truncated corner reflectors produced in accordance with the invention using a 60° truncation rotation;

FIGS. 10A-10H depict side views of the arrays of FIGS. 9A-9H;

FIGS. 11A-11H depict opposite side views of the arrays of FIGS. 9A-9H;

FIGS. 12A-12H depict front views of the arrays of FIGS. 9A-9H each with dashed lines to indicate six triangular trihedral corner reflectors and with dark solid lines to indicate scattering components;

FIGS. 13A-13H depict oblique views of arrays that are similar to the arrays of FIGS. 9A-9H except they comprise additional truncated equilateral triangle truncated triangular trihedral corner reflectors and multiple scattering components;

FIG. 14A depicts a front view of the relative sizes and orientations of three equilateral triangles corresponding to the equilateral triangular truncation scenario involving a truncation rotation of 60° described relative to FIGS. 4A-4Y;

FIG. 14B depicts a projected view of a triangular trihedral corner reflector prior to equilateral triangular truncation using a truncation rotation of 60°, the first truncated corner reflector, and the remaining triangular trihedral corner reflector of the triangular trihedral corner reflector after truncation;

FIG. 14C depicts a front view of the relative sizes and orientations of three equilateral triangles corresponding to the equilateral triangular truncation scenario involving a truncation rotation of 30° described above relative to FIGS. 5A-5AN;

FIG. 14D depicts a projected view of a triangular trihedral corner reflector prior to equilateral triangular truncation using a truncation rotation of 30°, the second and third equilateral triangle truncated triangular trihedral corner reflectors, and the remaining triangular trihedral corner reflector ′ of the triangular trihedral corner reflector after truncation;

FIGS. 15A-15H depict relative sizes and orientations of the equilateral triangles for truncation rotation angles of 0°, 5°, 10°, 20°, 30°, 40°, 50°, and 60°;

FIGS. 16A-16H depict relative sizes and orientations of the equilateral triangles for truncation rotation angles of 0°, 5°, 10°, 20°, 30°, 40°, 50°, and 60°;

FIG. 17 depicts an exemplary mathematical model for centered equilateral triangle vertical truncations;

FIGS. 18A-18H depict photographs of approximately 3.5 inch×3.5 inch×0.25 inch high boxes having reflective surfaces corresponding to arrays each made up of reflective components that are each one-quarter inches in height, which were producing using a 3D printer and spray painted using a reflective paint;

FIG. 19 depicts a front view of an exemplary vertical isosceles right triangle truncation of a triangular trihedral corner reflector using an isosceles right triangle shaped truncating object having a 0° truncation rotation angle in accordance with the invention;

FIGS. 20A-20C depict exemplary faces produced by truncating the triangular trihedral corner reflector using an isosceles right triangle shaped truncating object having a 0° truncation rotation angle in accordance with the invention;

FIG. 21 depicts multiple views of an isosceles right triangle truncated triangular trihedral corner reflector produced by truncating the triangular trihedral corner reflector using an isosceles right triangle shaped truncating object having a 0° truncation rotation angle in accordance with the invention;

FIG. 22A depicts an exemplary array of isosceles right triangle truncated triangular trihedral corner reflectors in accordance with the invention;

FIGS. 22B and 22C depict an exemplary larger array made up of nine of the arrays of FIG. 22A, which are configured in three rows and three columns;

FIG. 23 depicts a front view of an exemplary vertical isosceles right triangle truncation of a triangular trihedral corner reflector using an isosceles right triangle shaped truncating object having a 27.36° truncation rotation angle in accordance with the invention;

FIGS. 24A-24C depict exemplary faces produced by truncating the triangular trihedral corner reflector using an isosceles right triangle shaped truncating object having a 27.36° truncation rotation angle in accordance with the invention;

FIG. 25 depicts multiple views of an isosceles right triangle truncated triangular trihedral corner reflector produced by truncating the triangular trihedral corner reflector using an isosceles right triangle shaped truncating object having a 26.36° truncation rotation angle in accordance with the invention;

FIG. 26A depicts an exemplary array of truncated corner reflectors in accordance with the invention;

FIGS. 26B and 26C depict an exemplary larger array made up of nine of the arrays of FIG. 26A, which are configured in three rows and three columns;

FIG. 27 depicts a front view of an exemplary vertical isosceles right triangle truncation of a triangular trihedral corner reflector using an isosceles right triangle shaped truncating object having a 60° truncation rotation angle in accordance with the invention;

FIGS. 28A-28C depict exemplary faces produced by truncating the triangular trihedral corner reflector using an isosceles right triangle shaped truncating object having a 60° truncation rotation angle in accordance with the invention;

FIG. 29 depicts multiple views of an isosceles right triangle truncated triangular trihedral corner reflector produced by truncating the triangular trihedral corner reflector using an isosceles right triangle shaped truncating object having a 60° truncation rotation angle in accordance with the invention;

FIG. 30A depicts an exemplary array of truncated corner reflectors in accordance with the invention;

FIGS. 30B and 30C depict an exemplary larger array made up of nine of the arrays of FIG. 30A, which are configured in three rows and three columns;

FIG. 31 depicts a front view of an exemplary vertical isosceles triangle truncation of a triangular trihedral corner reflector using an isosceles triangle shaped truncating object having a 0° truncation rotation angle in accordance with the invention;

FIGS. 32A-32C depict exemplary faces produced by truncating the triangular trihedral corner reflector using an isosceles triangle shaped truncating object having a 0° truncation rotation angle in accordance with the invention;

FIG. 33 depicts multiple views of an isosceles triangle truncated triangular trihedral corner reflector produced by truncating the triangular trihedral corner reflector using an isosceles triangle shaped truncating object having a 0° truncation rotation angle in accordance with the invention;

FIGS. 34A and 34B depict front and oblique views of an exemplary array of truncated corner reflectors in accordance with the invention;

FIG. 35 depicts a front view of an exemplary vertical isosceles triangle truncation of a triangular trihedral corner reflector using an isosceles triangle shaped truncating object having a 0° truncation rotation angle in accordance with the invention;

FIGS. 36A-36C depict exemplary faces produced by truncating the triangular trihedral corner reflector using an isosceles triangle shaped truncating object having a 0° truncation rotation angle in accordance with the invention;

FIG. 37 depicts multiple views of an isosceles triangle truncated triangular trihedral corner reflector produced by truncating the triangular trihedral corner reflector using an isosceles triangle shaped truncating object having a 0° truncation rotation angle in accordance with the invention;

FIGS. 38A and 38B depict front and oblique views of an exemplary array of truncated corner reflectors in accordance with the invention;

FIG. 38C depicts a front view of an exemplary array produced by tiling two rows and two columns of the array of FIGS. 38A and 38B with filler structures added to the four corners of the arrays in order to fill the gaps between the arrays;

FIG. 39 depicts a front view of an exemplary vertical isosceles triangle truncation of a triangular trihedral corner reflector using an isosceles triangle shaped truncating object having a 30° truncation rotation angle in accordance with the invention;

FIGS. 40A-40C depict exemplary faces produced by truncating the triangular trihedral corner reflector using an isosceles triangle shaped truncating object having a 30° truncation rotation angle in accordance with the invention;

FIG. 41 depicts multiple views of an isosceles triangle truncated triangular trihedral corner reflector produced by truncating the triangular trihedral corner reflector using an isosceles triangle shaped truncating object having a 30° truncation rotation angle in accordance with the invention;

FIGS. 42A and 42B depict front and oblique views of an exemplary array of truncated corner reflectors in accordance with the invention;

FIG. 43A depicts the exemplary trihedral corner and exemplary rotational plane of FIG. 6C except the exemplary truncating equilateral triangle is replaced by an exemplary truncating rectangle;

FIG. 43B depicts a front view of an exemplary vertical rectangle truncation of a triangular trihedral corner reflector using an rectangle shaped truncating object having a 39.51° truncation rotation angle in accordance with the invention;

FIGS. 44A-44C depict exemplary faces produced by truncating the triangular trihedral corner reflector using an rectangle shaped truncating object having a 39.51° truncation rotation angle and L/W ratio of approximately 1.26 in accordance with the invention;

FIG. 45 depicts multiple views of a rectangle truncated triangular trihedral corner reflector produced by truncating the triangular trihedral corner reflector using a rectangle shaped truncating object having a 39.51° truncation rotation angle and L/W ratio of approximately 1.26 in accordance with the invention;

FIGS. 46A-46C depict front, side and oblique views of an exemplary array of truncated corner reflectors in accordance with the invention;

FIGS. 47A-47C depict front, side, and oblique views of an exemplary array comprising nine arrays of FIGS. 46A-46C;

FIGS. 48A and 48B depict oblique and front views of exemplary offset equilateral triangle truncation of a triangular trihedral corner reflector;

FIGS. 49A-49C depict exemplary centered versus offset isosceles triangle truncation scenarios using isosceles triangle shaped truncating objects having a 60° truncation rotation angle in accordance with the invention;

FIGS. 50A-52C depict front, side, and oblique views of exemplary isosceles triangle truncated triangular trihedral corner reflector arrays produced in accordance with the three isosceles triangle truncation scenarios of FIGS. 49A-49C;

FIG. 53A depicts an oblique view of an exemplary non-vertical truncation of a triangular trihedral corner reflector by a truncating equilateral triangle;

FIG. 53B depicts an oblique view of an exemplary offset non-vertical truncation of a triangular trihedral corner reflector by a truncating equilateral triangle;

FIG. 54 depicts an exemplary non-vertical equilateral triangle truncation of a triangular trihedral corner reflector using an equilateral triangle shaped truncating object having a 30° truncation rotation angle and a 12.44° non-vertical axis rotation angle τin accordance with the invention;

FIGS. 55A-55C depict exemplary faces produced by truncating the triangular trihedral corner reflector using an equilateral triangle shaped truncating object having a 30° truncation rotation angle and a 12.44° non-vertical axis rotation angle in accordance with the invention;

FIG. 56 depicts multiple views of an equilateral triangle truncated triangular trihedral corner reflector produced by truncating the triangular trihedral corner reflector using an equilateral triangle shaped truncating object having a 30° truncation rotation angle and a 12.44° non-vertical axis rotation angle in accordance with the invention;

FIGS. 57A-57C depict front, side and oblique views of an exemplary array of equilateral triangle truncated triangular trihedral corner reflectors in accordance with the invention.

FIGS. 58A-58C depict front, side, and oblique views of an exemplary array comprising seven arrays of FIGS. 57A-57C.

FIGS. 59A and 59B depict an oblique and front view of an exemplary offset non-vertical equilateral triangle truncation of a triangular trihedral corner reflector using an equilateral triangle shaped truncating object having a 30° truncation rotation angle, a 12.44° non-vertical axis rotation angle τ, and an offset in accordance with the invention;

FIGS. 60A-60C depict exemplary faces produced by truncating the triangular trihedral corner reflector using an equilateral triangle shaped truncating object having a 30° truncation rotation angle, a 12.44° non-vertical axis rotation angle and an offset in accordance with the invention;

FIG. 61 depicts multiple views of an equilateral triangle truncated triangular trihedral corner reflector produced by truncating the triangular trihedral corner reflector using an equilateral triangle shaped truncating object having a 30° truncation rotation angle, a 12.44° non-vertical axis rotation angle and an offset in accordance with the invention;

FIGS. 62A-62C depict front, side and oblique views of an exemplary array of equilateral triangle truncated triangular trihedral corner reflectors in accordance with the invention;

FIGS. 63A-63C depict front, side, and oblique views of an exemplary array comprising seven arrays of FIGS. 62A-62C;

FIG. 64A depicts an exemplary method for equilateral triangle truncation of a triangular trihedral corner reflector in accordance with the invention;

FIG. 64B depicts an exemplary method for right isosceles triangle truncation of a triangular trihedral corner reflector in accordance with the invention;

FIG. 64C depicts an exemplary method for right triangle truncation of a triangular trihedral corner reflector in accordance with the invention;

FIG. 64D depicts an exemplary method for rectangle truncation of a triangular trihedral corner reflector in accordance with the invention;

FIG. 65 depicts an exemplary method for vertical truncation of a triangular trihedral corner reflector using an offset in accordance with the invention;

FIG. 66A depicts an exemplary method for non-vertical truncation of a triangular trihedral corner reflector in accordance with the invention;

FIG. 66B depicts an exemplary method for non-vertical truncation of a triangular trihedral corner reflector in accordance with the invention;

FIG. 67 depicts a photo of an exemplary fixture consisting of an array of six of the first equilateral triangle truncated triangular trihedral corner reflectors constructed by cutting six corners off of plastic BallCube® memorabilia display cases;

FIGS. 68A-68D depict front, side, side, and oblique views of an exemplary fixture having a surface corresponding to the exemplary array of FIG. 4W in accordance with the invention;

FIGS. 69A-69E depict photos of various views of the exemplary fixture of FIGS. 68A-68D;

FIG. 70A depicts a reflective device that is a solid piece of plastic having a flat surface on a top side and a geometry corresponding to a truncated trihedral corner reflector array in accordance with the invention on a bottom side opposite the top side, and a light source beneath the reflecting device shining light through the array;

FIG. 70B depicts the reflective device of FIG. 70A with the light source illuminating the reflective device from its top side;

FIG. 71A depicts a large array comprising four arrays, where a light sensing device scanning from left to right can recognize different symbols;

FIG. 71B depicts a large array that comprises smaller arrays and inverted arrays;

FIG. 71C depicts a large array that has different areas that are made up of different sizes of a 3×3 array, which might be described as having different densities;

FIG. 71D depicts a large array that comprises three separated rows of truncated triangular trihedral corner reflector arrays that can be used to determine a location or to calibrate a sensor system;

FIGS. 72A-72E depict various architectures for determining information about an object;

FIG. 73A depicts three exemplary centered equilateral triangle vertical truncation scenarios involving first, second, third, and fourth truncating equilateral triangles each having a 60° truncation rotation angle;

FIG. 73B depicts an exemplary face of a triangular trihedral corner reflector;

FIG. 74 depicts an exemplary mathematical model for the truncation of outer triangle shaped portions from each of the three faces of a triangular trihedral corner reflector to produce the faces of a truncated triangular trihedral corner reflector in accordance with the modified centered equilateral triangle vertical truncation method described in relation to FIGS. 73A and 73B;

FIG. 75A-75C depict multiple views of exemplary truncated trihedral corner reflectors, which were produced in accordance with the invention using the modified centered equilateral triangle vertical truncation method and truncating equilateral triangles having 60° truncation rotation angles and relative sizes Z of 1.25, 1.5, and 3.0 times the unit size, respectively;

FIG. 76A depicts an alternative method for truncating a triangular trihedral corner reflector in accordance with the invention;

FIG. 76B depicts another alternative method for truncating a triangular trihedral corner reflector in accordance with the invention; and

FIGS. 77A and 77B depict exemplary truncated trihedral corner reflectors produced in accordance with the mathematical model of FIG. 76A.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in art. Like numbers refer to like elements throughout.

In accordance with an aspect of the invention, a triangular trihedral corner reflector 100 can be truncated based upon an equilateral triangle shape to remove three outer portions of the triangular trihedral corner reflector 100 to produce an equilateral triangle truncated triangular trihedral corner reflector. Multiple equilateral triangle truncated triangular trihedral corner reflectors can be combined into arrays that can be described as having triangular trihedral corner reflector portions and energy scattering portions. The relative size of the triangular trihedral corner reflector portions and the shape and relative size of the energy scattering portions can be controlled based on the rotation angle of the truncating equilateral triangle relative to the triangular trihedral corner reflector 100 thereby controlling the ratio of energy retro-reflection to energy scattering by the array.

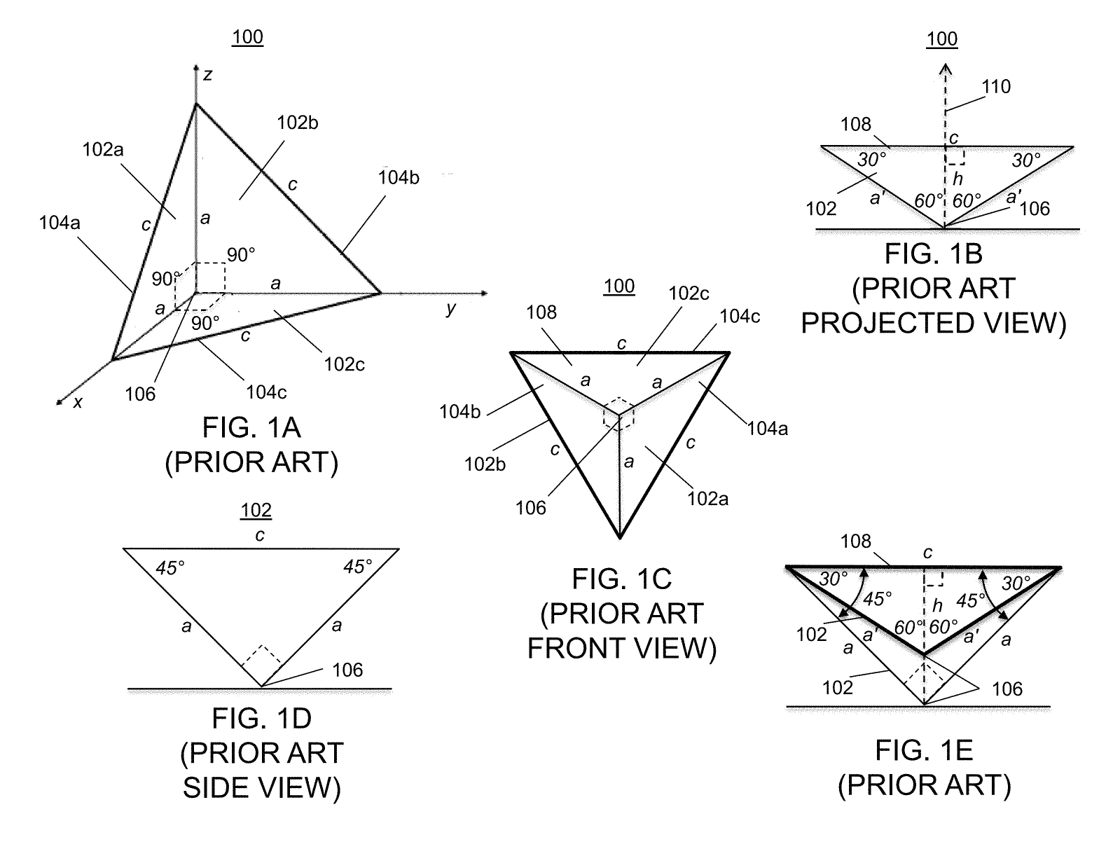

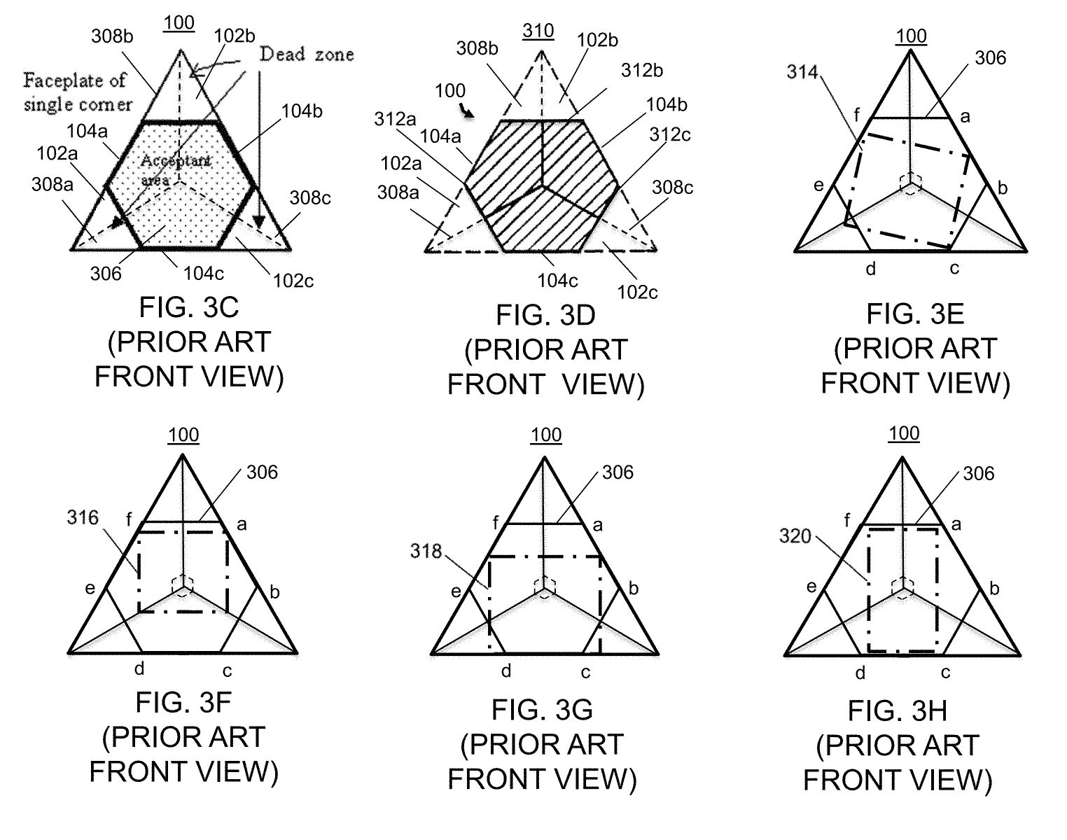

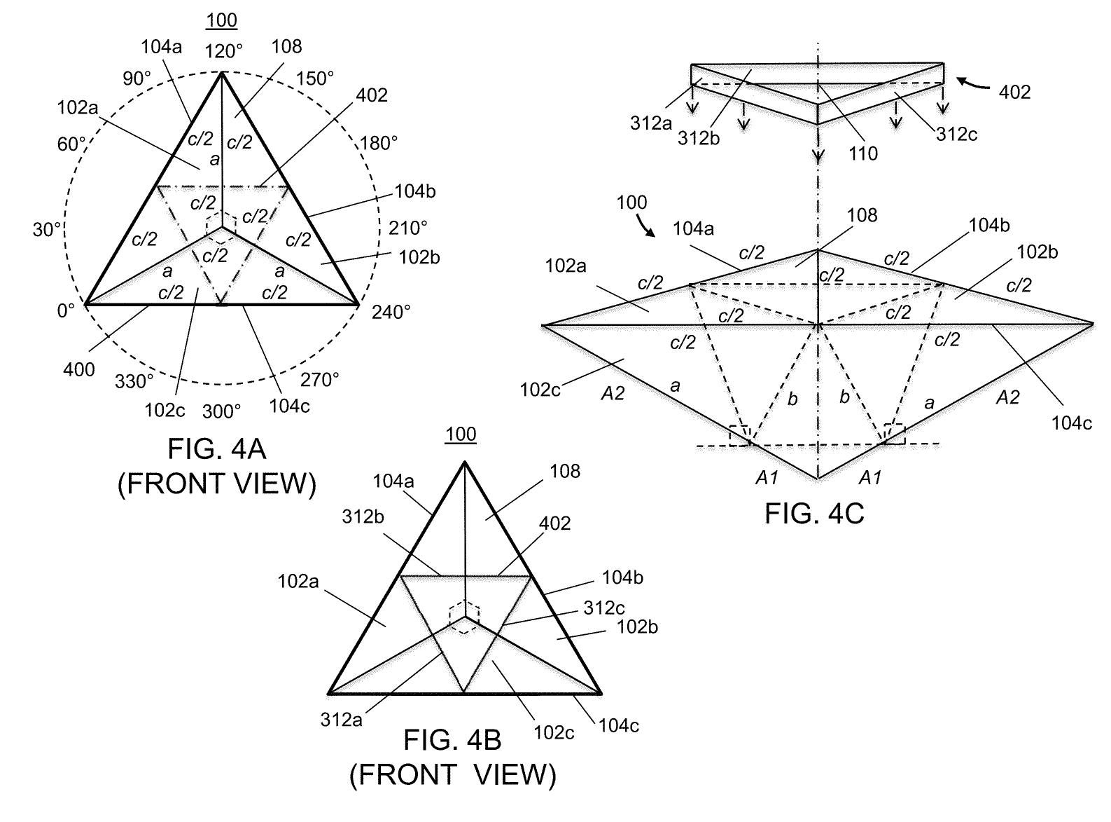

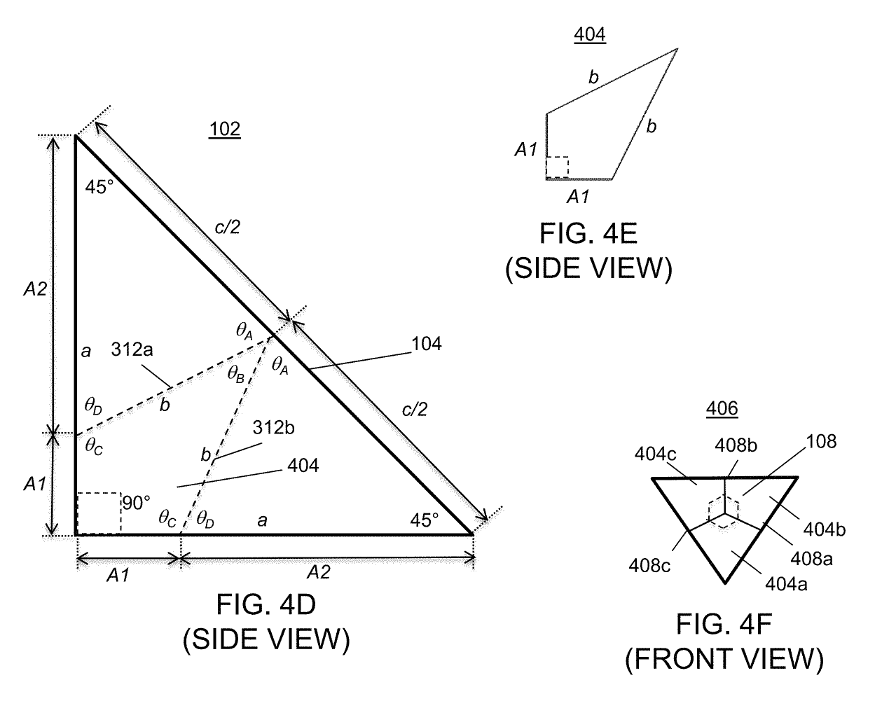

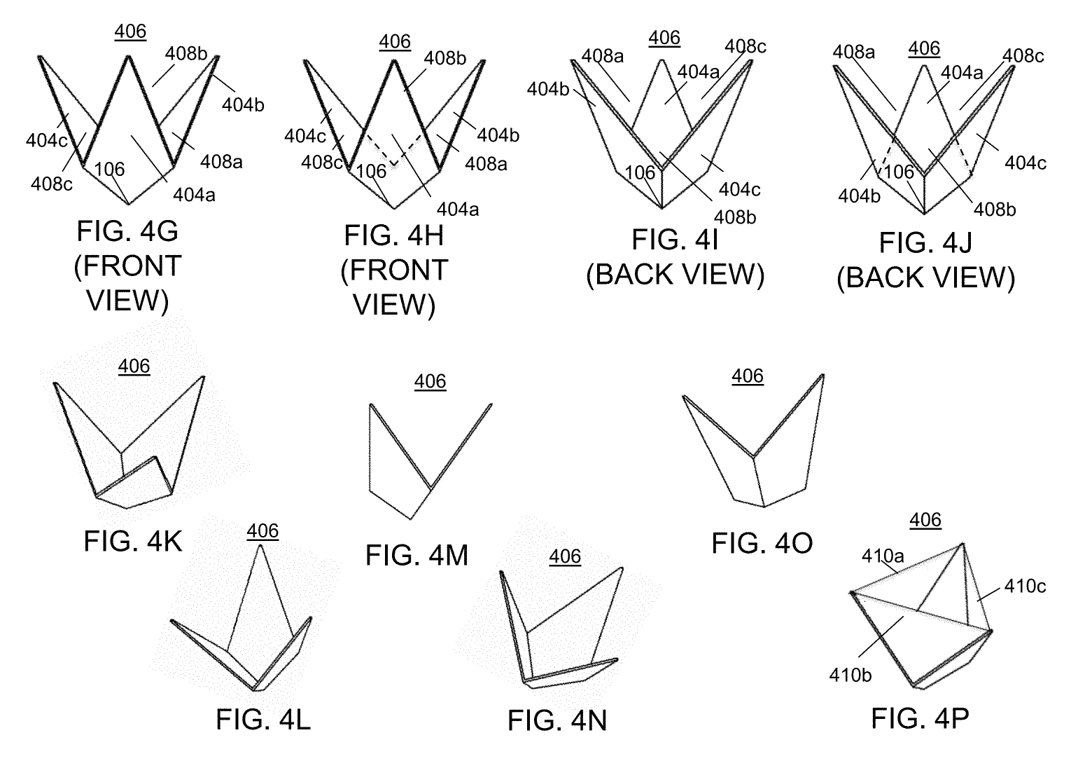

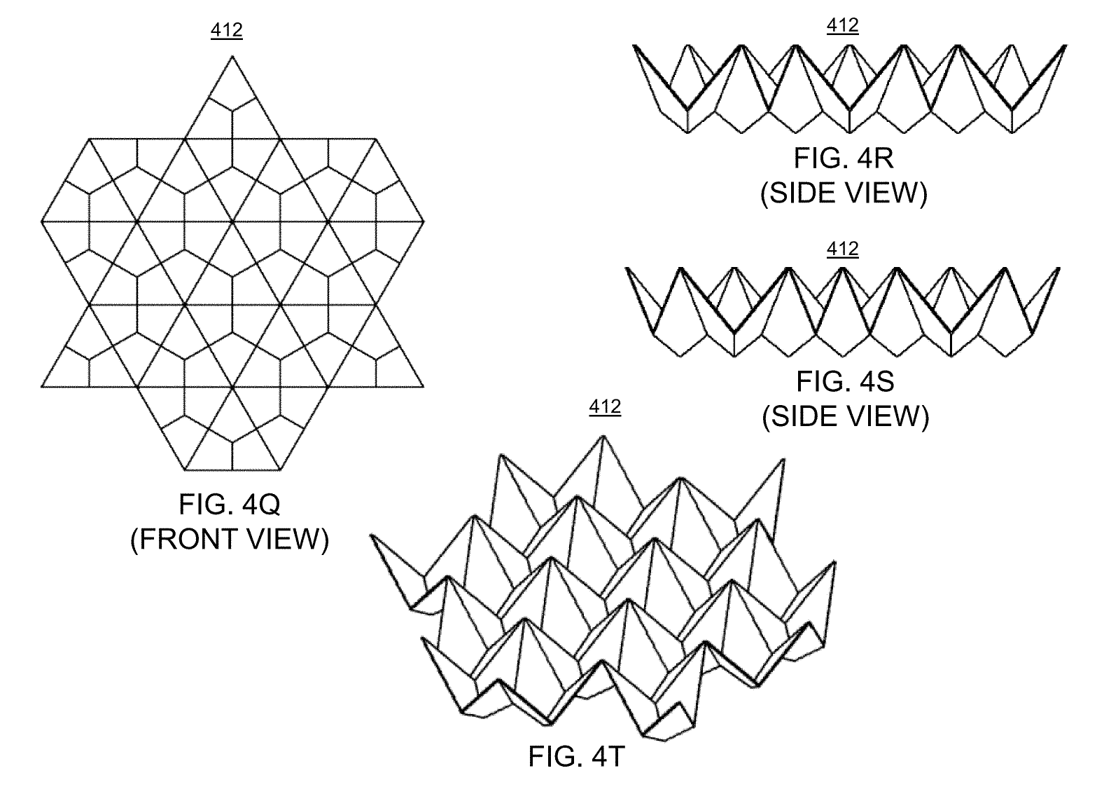

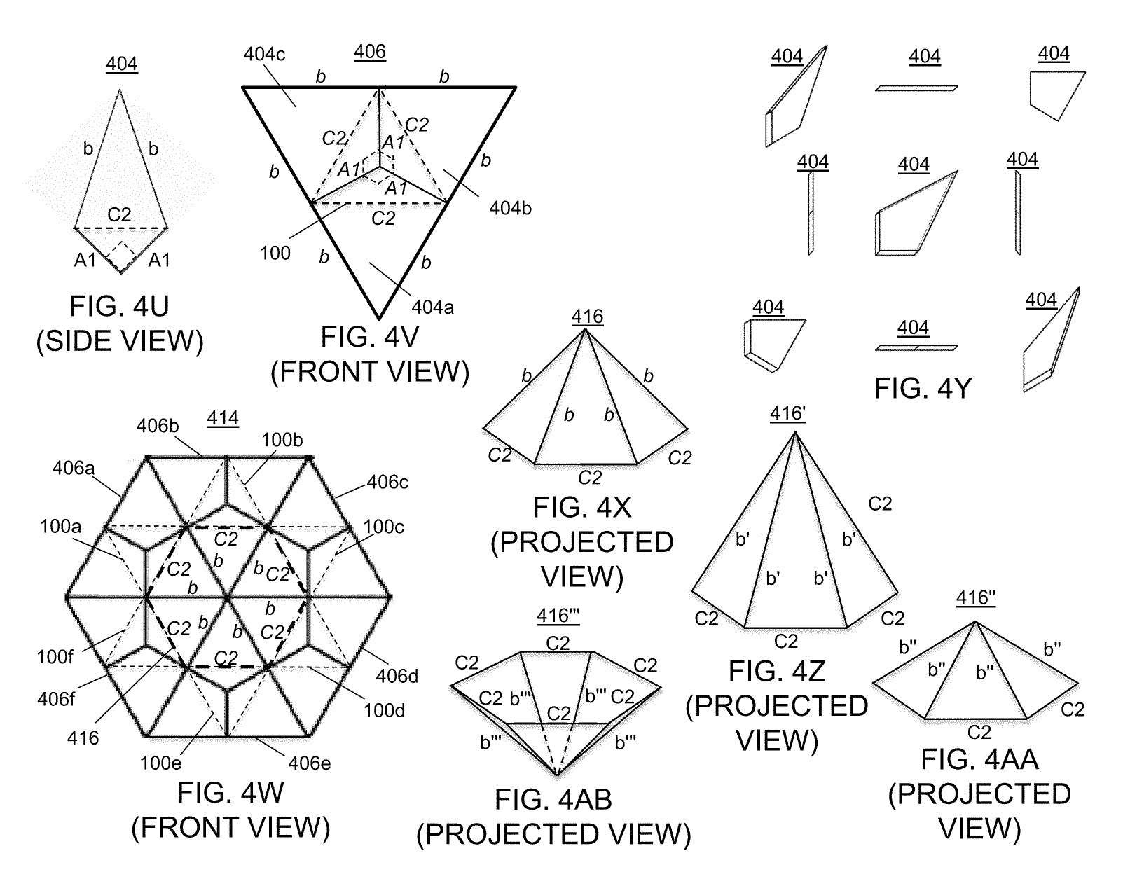

FIG. 4A depicts a front view of a triangular trihedral corner reflector 100 like that depicted in FIGS. 1C and 3B, which has three faces 102a-102c that are each right isosceles triangles having two sides of length a and one side of length c, where the three sides of length c form a first equilateral triangle 400 corresponding to the opening 108 of the triangular trihedral corner reflector 100. A second equilateral triangle 402 inside the first equilateral triangle 400 has three sides each having length c/2 that extend between the three half-way points of the three sides of length c of the first equilateral triangle 400 corresponding to the opening 108 of the triangular trihedral corner reflector 100. The first equilateral triangle 400 can be described as being subdivided into four equilateral triangles each having three sides of length c/2 including the second (innermost) equilateral triangle 402.

In accordance with the invention, the second equilateral triangle 402, which can be referred to as a truncating equilateral triangle, can be described as having a 60° rotation angle relative to the first equilateral triangle 400 and, more particularly, can be described as having a 60° rotation angle relative to the triangular trihedral corner reflector 100. The concept of rotation of a truncating object (e.g., a truncating equilateral triangle) relative to a trihedral corner reflector (e.g., a triangular trihedral corner reflector 100) in accordance with the invention is described in further detail below.

FIG. 4B depicts a front view of the triangular trihedral corner reflector 100 like that of FIG. 4A where three planes 312a-312c corresponding to the truncating equilateral triangle 402 of FIG. 4A are each parallel to the symmetry axis 110 of the corner reflector 100. The three planes can be described as forming a truncating equilateral triangular prism like shape that truncates the corner reflector 100 in what could be described as an equilateral triangle truncation method where the truncating equilateral triangle truncates the corner reflector 100 much like a cookie cutter cuts through cookie dough. Because the three planes (or cutters) 312a-312c of the truncating equilateral triangle are all parallel to the symmetry axis 110 of the corner reflector 100, the truncating of the corner reflector 100 can more specifically be described as being a vertical equilateral triangle truncation method. For simplicity, as described herein, “truncation” should be understood as meaning “vertical truncation” unless specified otherwise. The concept of non-vertical truncation is described in further detail below.

FIG. 4C depicts an oblique view of the truncation of the triangular trihedral corner reflector 100 of FIGS. 4A and 4B. Referring to FIG. 4C, the three planes 312a-312c of the truncating equilateral triangle move vertically downward to truncate (or remove) the three corners of the corner reflector 100 in accordance with the invention.

FIG. 4D depicts a side view of a face 102 of the triangular trihedral corner reflector 100 of FIGS. 4A-4C, which has three faces 102a-102c that are each isosceles right triangles. Referring to FIG. 4D, intersecting planes 312a and 312b indicate portions of the face 102 that can be removed to produce a right kite-shaped face 404 that is depicted in FIG. 4E, which has two sides of length A1 and two sides of length b and corner angles of 90°, θ_{C}°, θ_{B}°, and θ_{C}, where θ_{B}°≈36.86°, θ_{C}=116.57°. The two truncated corners of the face 102 each have a first side of length b, a second side of length A2, and a third side of length c/2 and corner angles of 45°, θ_{A}°, and θ_{D}°, where θ_{A}°=71.57° and θ_{D}°≈63.43°. The ratio of A2 to A1=3, where A2=0.75a and A1=0.25a.

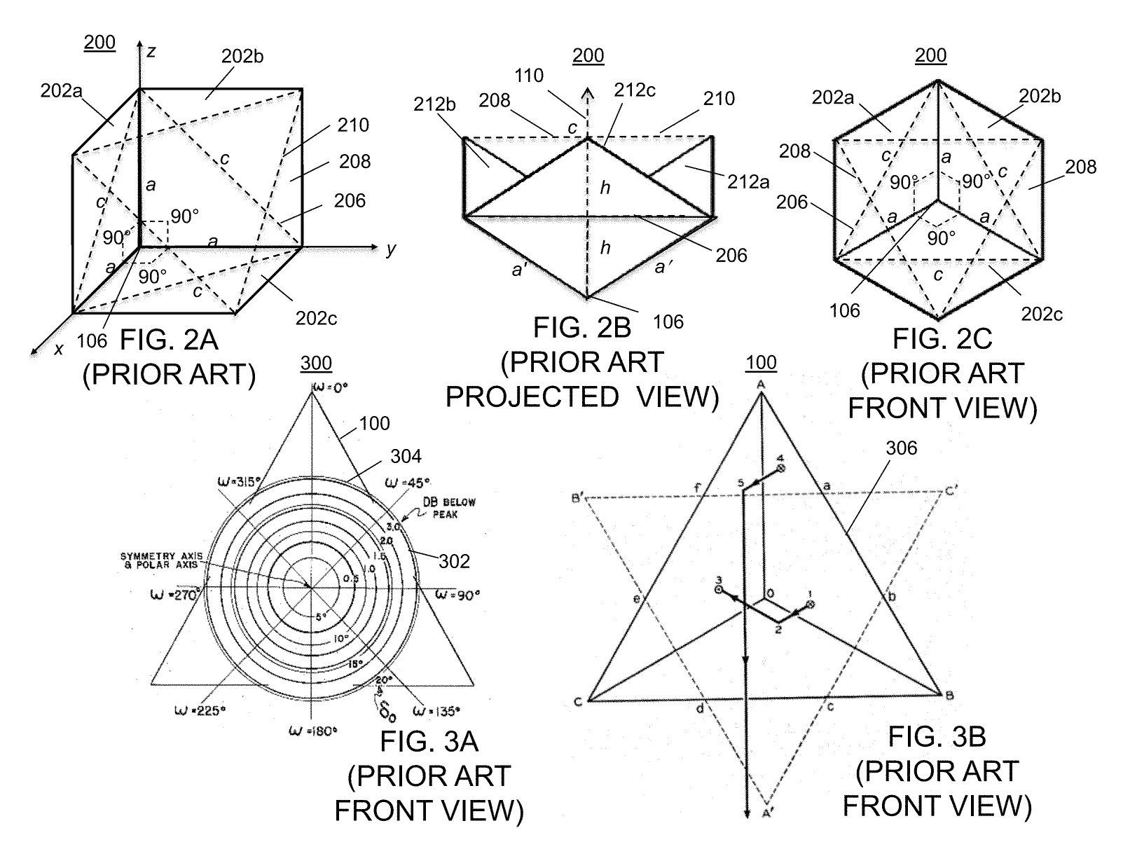

In accordance with an aspect of the invention, which is depicted in FIG. 4F, three truncated right kite-shaped faces 404a-404c can be used to construct a first equilateral triangle truncated triangular trihedral corner reflector 406. Referring to FIG. 4F, the first truncated corner reflector 406 also has three side openings 408a-408c similar to the side openings 212a-212c of the square trihedral corner reflector 200 described in relation to FIGS. 2A and 2B.

FIGS. 4G-4J depict top, front, and back views of the first truncated corner reflector 406 in accordance the invention. Referring to FIGS. 4G-4J, the first truncated corner reflector 406 comprises three faces 404a-404c like the face 404 depicted in FIG. 4E, where each of two sides of each of the three face 404a-404c abut a corresponding side of each of the other two faces of the three faces 404a-404c, and where there is a mutual point of intersection of the three faces 404a-404c at a center point 106. Three triangular openings 408a-408c can be seen where the three corners of a triangular trihedral corner reflector 100 have been truncated. For clarity, front and back views are depicted with and without dashed lines indicating hidden portions of the corner reflector 406.

FIGS. 4K-4O depict various three-dimensional views of the first equilateral triangle truncated triangular trihedral corner reflector 406 of FIGS. 4F-4J.

FIG. 4P depicts exemplary triangular faces 410a-410c that can optionally be used to fill the openings 408a-408c of the first equilateral triangle truncated triangular trihedral corner reflector 406 of FIGS. 4F-4O.

Two first truncated corner reflectors 406 can be combined into an array where the outer edges of the abutting faces of the two first truncated corner reflectors 406 align with each other since the outer edges of the abutting faces of the two first truncated corner reflectors 406 can be complementary to (or mirror images of) each other, where they have the same dimensions. The combining of two objects where the outer edges of the abutting faces of the two objects are all aligned is referring to herein as tiling with each other. Moreover, because the first truncated corner reflectors 406 are symmetrical in three directions, either of the two first truncated corner reflectors 406 can be rotated ±120° and will tile with the other first truncated corner reflector 406. Furthermore, additional first truncated corner reflectors 406 can be added to the array by tiling with any other first truncated corner reflector 406 of the array. It can be noted that two objects that do not tile with each other as described herein can also be combined with each other in accordance with the invention. The combining of non-tileable objects into arrays is described further below.

FIGS. 4Q-4T depict front, side, and oblique projection views of an exemplary equilateral triangle truncated triangular trihedral corner reflector array 412 in accordance with the invention comprising a plurality of the first truncated corner reflectors 406 like those of FIGS. 4F-4O. Generally, any of the first truncated corner reflectors 406 in the array 412 can be rotated to any one of three positions (0°, 120°, and 240°) relative to an adjacent first truncated corner reflector 406 in the array 412.

FIG. 4U depicts a right kite-shaped face 404 like that shown in FIG. 4E except it is rotated such that its corner having a right triangle points downward and its corner opposite the corner having a right triangle points upward. A dashed line is used to subdivide the face 404 into a lower portion that is an isosceles right triangle having sides of length A1, A1 and C2, where C2=A1√2, and an upper portion that is an isosceles triangle having sides of length b, b, and C2, where C2=b√/2. The lower portion is like the isosceles right triangle of FIG. 4D except it is smaller in size.

FIG. 4V depicts a first equilateral triangle truncated triangular trihedral corner reflector 406 like that of FIG. 4F with dashed lines corresponding to a triangular trihedral corner reflector 100 having three faces 404a-404c each being an isosceles right triangle having two sides of length A1 and a side of length C2 and having an opening corresponding to an equilateral triangle having three sides of length C2. Referring to FIG. 4V, the three faces 404a-404c of the first truncated corner reflector 406 also include upper portions each being an isosceles triangle having sides of length b, b, and C2.

FIG. 4W depicts an exemplary array 414 of six of the first truncated corner reflectors 406a-406e arranged in a circular pattern having an outer boundary having a hexagonal shape. Shown inside the six of the first truncated corner reflectors 406a-406e are corresponding six triangular trihedral corner reflectors 100a-100e. In the middle of the array 414, upper portions of six of the faces 404 of six of the first truncated corner reflectors 406a-406e form a right hexagonal pyramid 416 as indicated by the thicker dashed line. The right hexagonal pyramid has a hexagonal base with six sides of length C2 and has six triangular faces that are each equilateral triangles with two sides of length b and one side of length C2. Whereas each triangular trihedral corner reflector 100 can be described as a retro-reflecting component of the array 414, the right hexagonal pyramid 416 can be described as a scattering component, where larger arrays such as the array 412 may include multiple right hexagonal pyramids 416. Moreover, the array 414 is made up of faces 404, where each face corresponds to a portion of a triangular trihedral corner reflector 100 (or retro-reflecting component) and a portion of a right hexagonal pyramid 416 scattering component. Although referred to as retro-reflecting or scattering components, it should be noted that retro-reflecting components and scattering components can both retro-reflect and scatter energy depending on the direction of energy reflecting off of them.

Generally, an array of first truncated triangular trihedral corner reflectors that completely forms a scattering component as described herein can be referred to as a cell, for example, the scattering component 416 of the array 414 of FIG. 4W. Moreover, because the first truncated corner reflectors 406 that make up the array 414 are symmetrical in three directions, the array (or cell) 414 will tile with another cell 414 in any of six directions. As described below, cells other than the cell 414 of FIG. 4W that are not symmetrical in six directions may tile with another respective cell or with a mirror image of the respective cell. Generally, like cells can be tiled such that they are abutted against each other in a plane. Alternatively, cells can be tiled such that a given tile has an angle relative to an abutting tile such the tiles face in different directions or cells can be tiled such that they face in the same direction but where the front of the faces of the cells are in different planes (e.g., like stair steps).

FIG. 4X depicts a projected view of the right hexagonal pyramid 416 of FIG. 4W.

FIG. 4Y depicts multiple views of the face 404 including a top view, four side views and four isometric views (i.e., in the four corners). Referring to FIG. 4Y, the face 404 has a front side, a back side and a selected thickness. The face 404 has a first two connecting sides meeting at the 90° corner of the face 404 that have 45° angles relative to the front side and the back side that enable the lower portions of the three faces 404a-404c to be joined together to produce the first truncated triangular reflector 406 of FIG. 4F, where any two of the adjoining faces are 90° relative to each other. The face 404 has a second two connecting sides meeting at the corner opposite of the 90° corner of the face 404 that have 60° angles relative to the front side and the back side that enable second portions of six faces 404a-404g to be joined together to produce the right hexagonal pyramid 416 of FIG. 4X, where the six sides are 60° relative to each other.

FIG. 4Z depicts a projected view of an alternative ‘taller’ right hexagonal pyramid 416′ that could be used in place of the right hexagonal pyramid 416 in the array 414. Referring to FIG. 4Z, the alternative ‘taller’ right hexagonal pyramid 416′ has the same base as does the right hexagonal pyramid 416 but has six triangular faces that are each isosceles triangles with two sides of length band one side of length C2, where b′>b.

FIG. 4AA depicts a projected view of an alternative ‘shorter’ right hexagonal pyramid 416″ that could be used in place of the right hexagonal pyramid 416 in the array 414. Referring to FIG. 4AA, the alternative ‘shorter’ right hexagonal pyramid 416″ has the same base as does the right hexagonal pyramid 416 but has six triangular faces that are each isosceles triangles with two sides of length b″ and one side of length C2, where b″<b.

FIG. 4AB depicts a projected view of an alternative ‘inverted’ right hexagonal pyramid 416′″ that could be used in place of the right hexagonal pyramid 416 in the array 414. Referring to FIG. 4AA, the ‘inverted’ right hexagonal pyramid 416′′ has the same base as does the right hexagonal pyramid 416 but has six triangular faces that are each isosceles triangles with two sides of length b′″ and one side of length C2, where b′″<0. Alternatively, the right hexagonal pyramid 416 in the array 414 could instead be a plane in the shape of a hexagon having six sides of length C2 (i.e., where b=0), which is not shown. In yet another arrangement, the right hexagonal pyramid 416 in the array 414 could be replaced by various hexagonal pyramids that are comparable to the right hexagonal pyramids 416, 416′, 416″, and 416′″ but which are not right hexagonal pyramids.

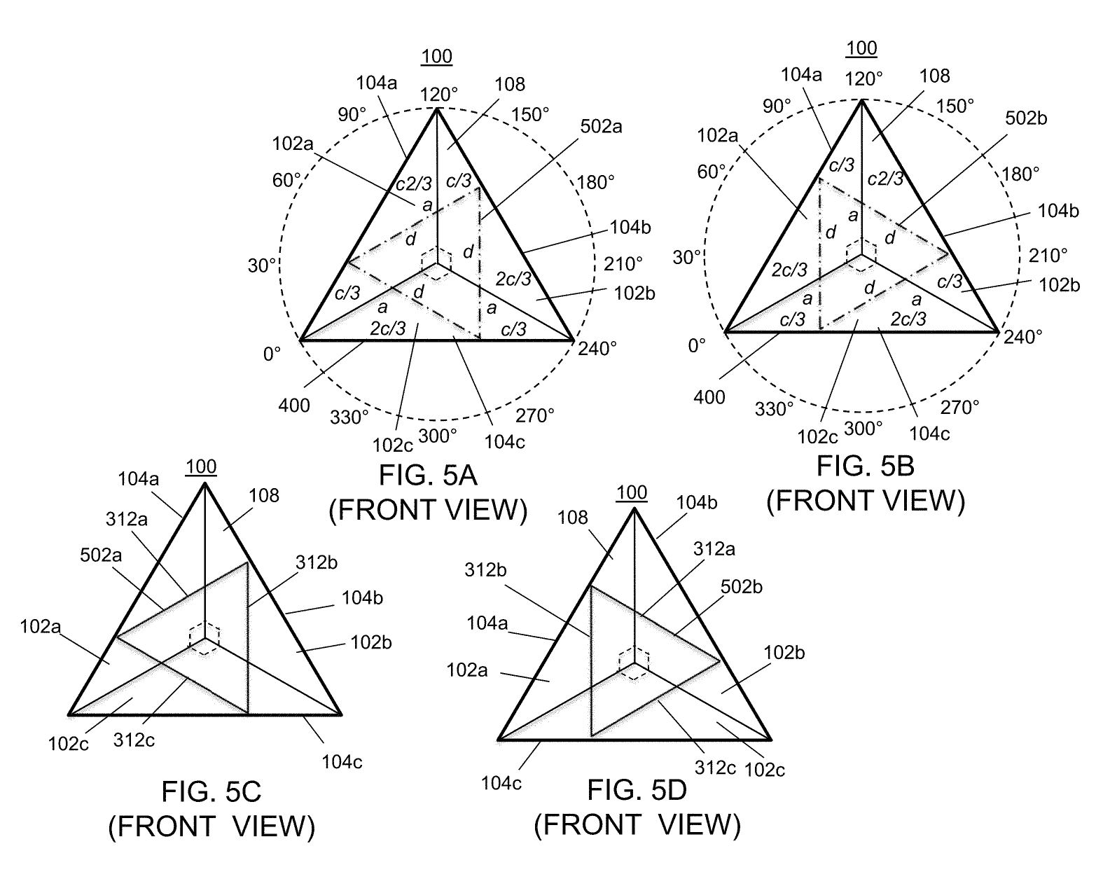

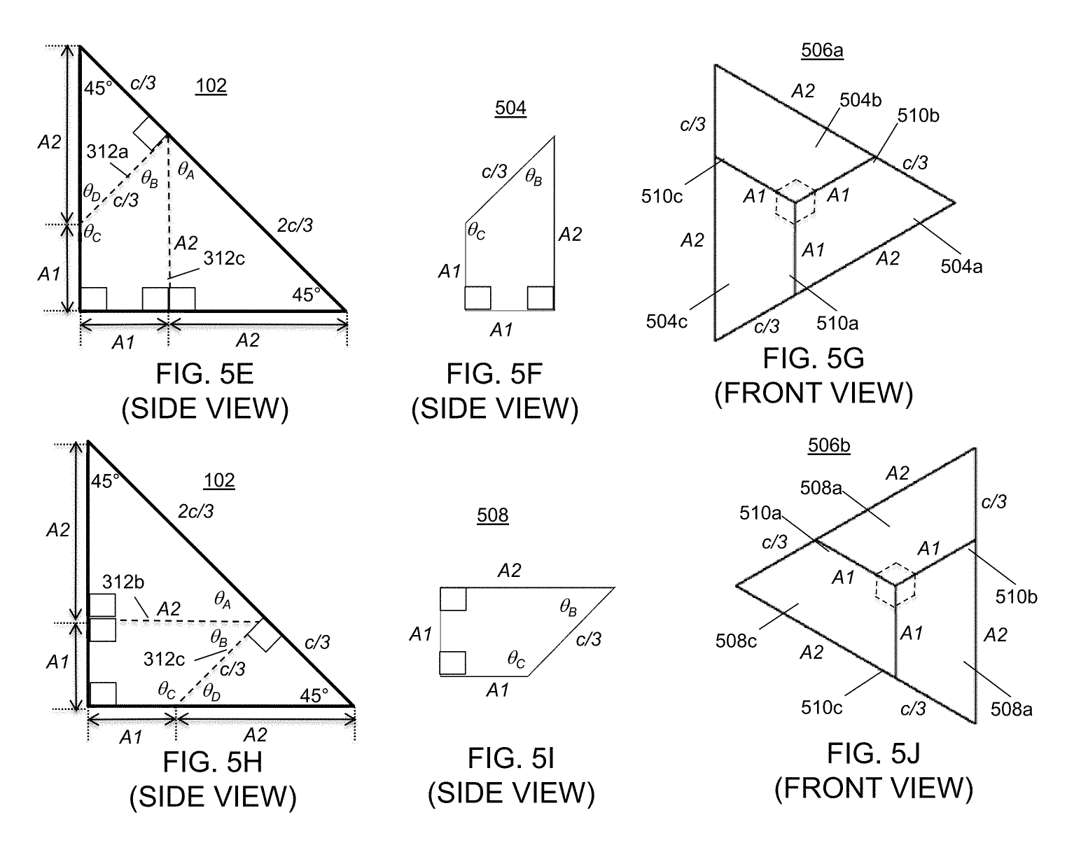

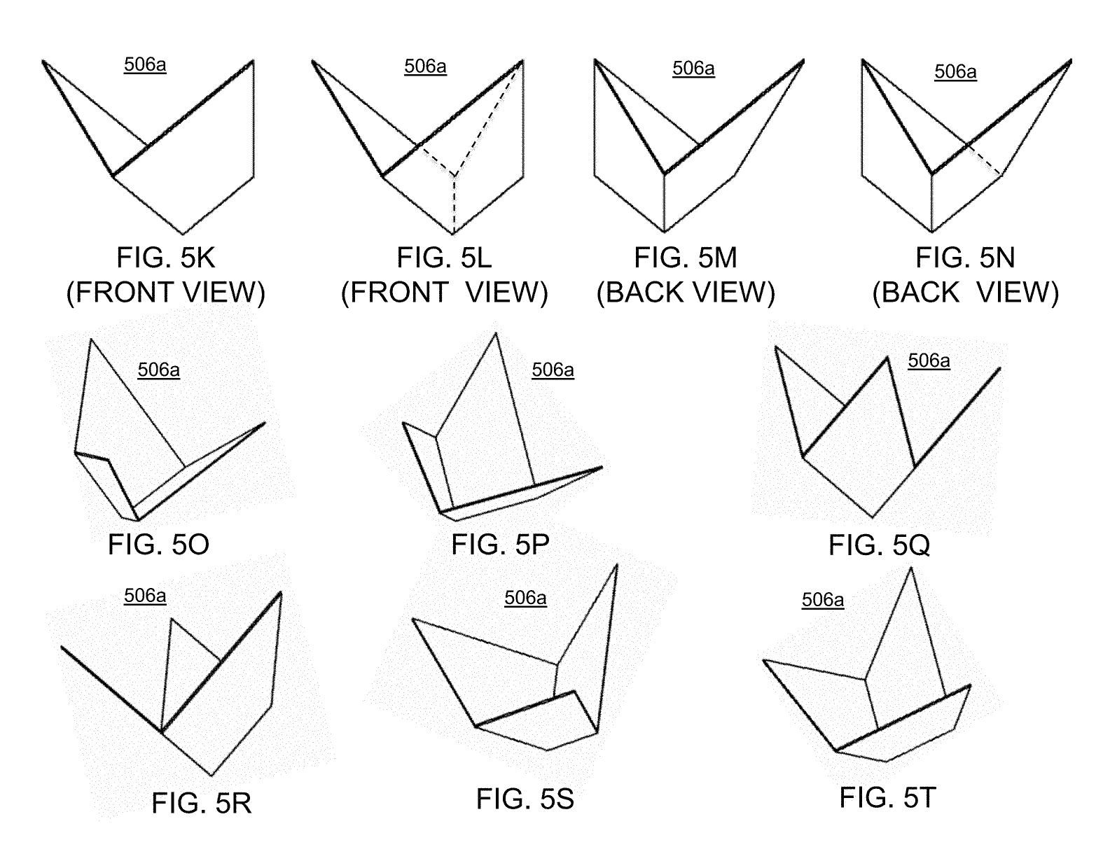

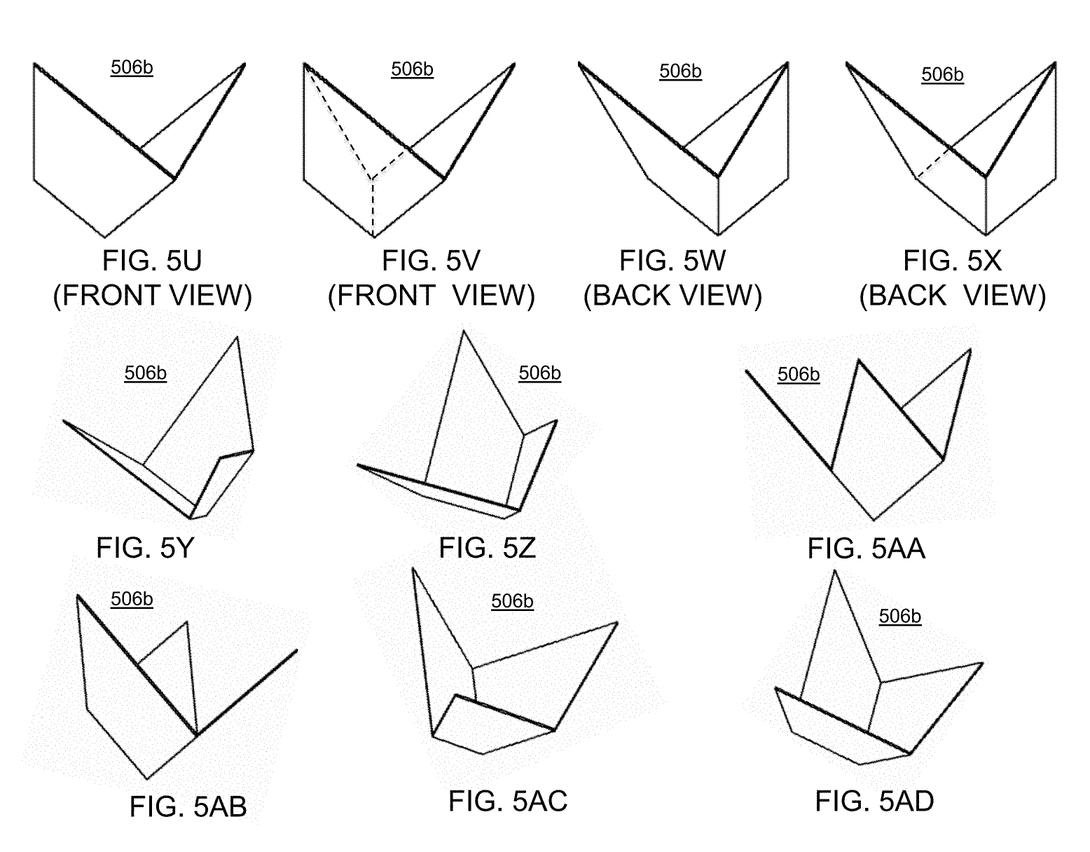

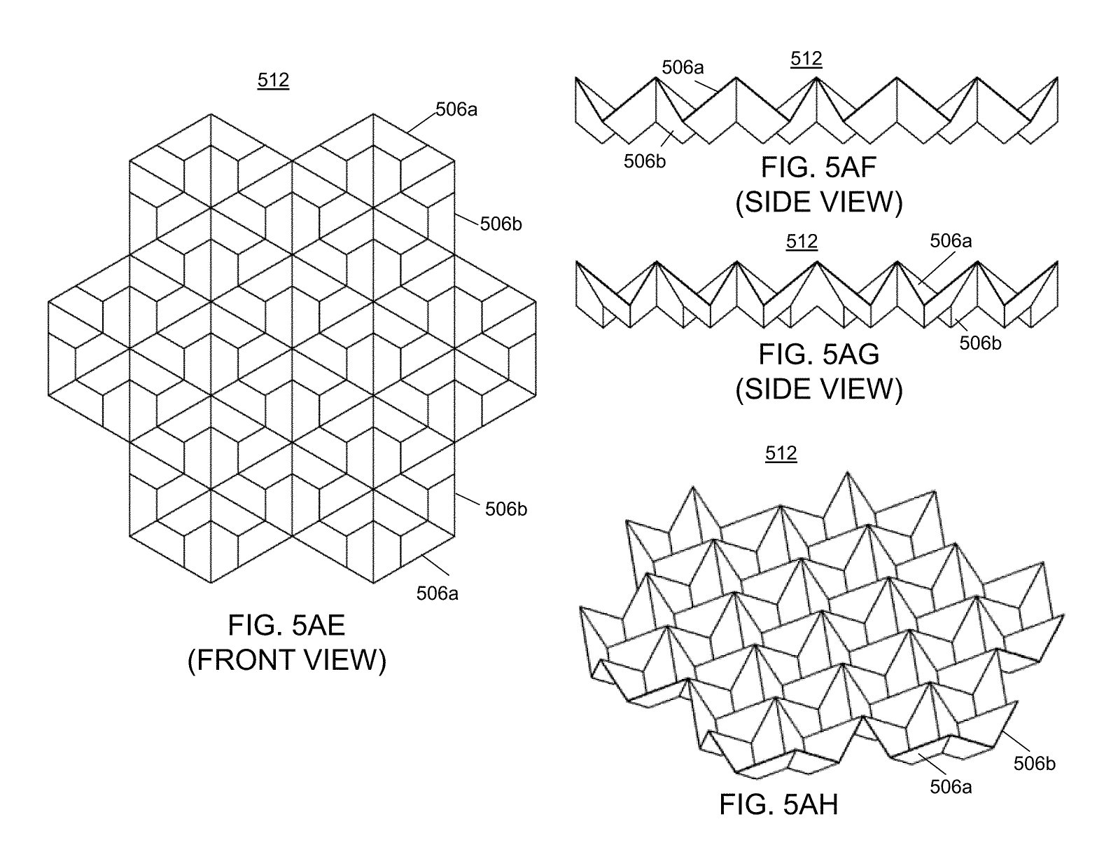

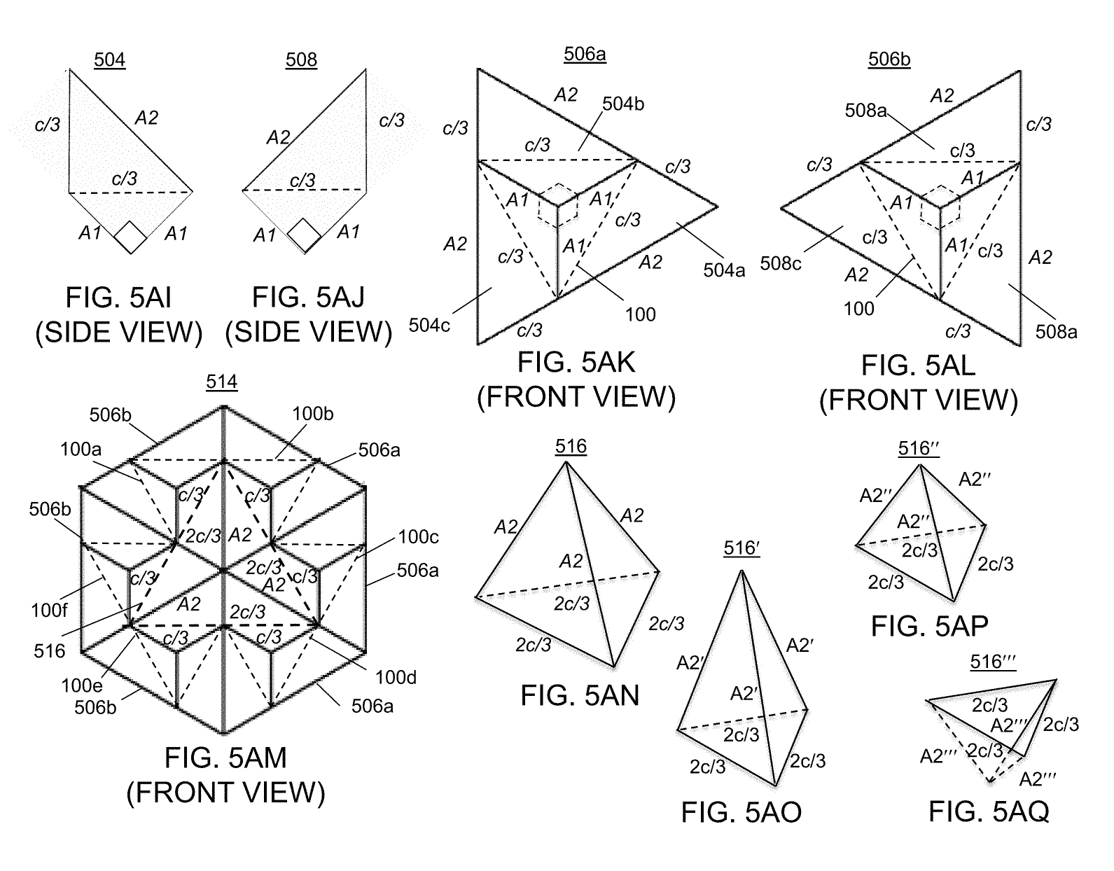

FIG. 5A depicts a front view of a corner reflector 100 like that depicted in FIGS. 1C and 3B, which has three faces 102a-102c that are each right isosceles triangles having two sides of length a and one side of length c, where the three sides of length c form a first equilateral triangle 400 corresponding to the opening 108 of the triangular trihedral corner reflector 100. A second equilateral triangle 502a inside the first equilateral triangle 400 has three sides each having length d that extend between the three one third-way points of the three sides of length c of the first equilateral triangle 400 corresponding to the opening 108 of the corner reflector 100. The first equilateral triangle 400 can be described as being subdivided into three right triangles each having three sides of length c/3, 2c/3, and d and a second (innermost) equilateral triangle 502a having three sides of length d.

FIG. 5B depicts a front view of a corner reflector 100 like that depicted in FIGS. 1C and 3B, which has three faces 102a-102c that are each right isosceles triangles having two sides of length a and one side of length c, where the three sides of length c form a first equilateral triangle 400 corresponding to the opening 108 of the corner reflector 100. A second equilateral triangle 502b inside the first equilateral triangle 400 has three sides each having length d that extend between the three two third-way points of the three sides of length c of the first equilateral triangle 400 corresponding to the opening 108 of the corner reflector 100. The first equilateral triangle 400 can be described as being subdivided into three right triangles each having three sides of length c/3, 2c/3, and d and a second (innermost) equilateral triangle 502b having three sides of length d. As such, the two second equilateral triangles 502a and 502b of FIGS. 5A and 5B are mirror images of each other, where the two second equilateral triangles 502a and 502b could be described as being a left pointing equilateral triangle and a right pointing equilateral triangle, respectively.

In accordance with the invention, the second equilateral triangle 502a and the third equilateral triangle 502b of FIGS. 5A and 5B, which can each be referred to as being truncating equilateral triangles having 30° and 90° rotation angles relative to the first equilateral triangle 400, respectively and, more particularly, can be described as having 30° and 90° rotation angles relative to the corner reflector 100, respectively. Moreover, the second equilateral triangle 502a and the third equilateral triangle 502b can be described as being complementary to each other (i.e., mirror images of each other) and can be referred to as being complementary truncating equilateral triangles, mirror image truncating equilateral triangles, or a matched pair of truncating equilateral triangles.

FIG. 5C depicts a front view of the corner reflector 100 like that of FIG. 5A where three planes 312a-312c that are each parallel to the symmetry axis 110 of the corner reflector 100 are shown intersecting with the three sides of the second equilateral triangle 502a of FIG. 5A. The three planes can be described as truncating the corner reflector 100 using the same equilateral triangle truncation method as described for FIG. 4B except the truncating equilateral triangle has been rotated from a 60° rotation to a 30° rotation.

FIG. 5D depicts a front view of the corner reflector 100 like that of FIG. 5B where three planes 312a-312c that are each parallel to the symmetry axis 110 of the corner reflector 100 are shown intersecting with the three sides of the second equilateral triangle 502b of FIG. 5B. The three planes can be described as truncating the corner reflector 100 using the same equilateral triangle truncation method as described for FIG. 4B except the truncating equilateral triangle is rotated from points half-way of the three sides to points two thirds-way of the three sides.

FIG. 5E depicts a side view of a face 102 of the corner reflector 100 of FIGS. 5A and 5C, which has three faces 102a-102c that are each isosceles right triangles. Referring to FIG. 5E, intersecting planes 312a and 312c indicate portions of the face 102 that can be removed to produce a right trapezoid-shaped face 504 that is depicted in FIG. 5F, which has two sides of length A1, one side of length A2, one side of length c/3 and corner angles of 90°, 90°, θ_{B}°, and θ_{C}, where θ_{B}°=45°, θ_{C}=135°. The upper left truncated corner of the face 102 is an isosceles right triangle having two sides of length c/3, a third side of length A2, and corner angles of 90°, 45°, and θ_{D}°, where θ_{D}°=45°. The bottom right truncated corner of the face 102 is also an isosceles right triangle having two sides of length A2, a third side of length 2c/3, and corner angles of 90°, 45°, and θ_{A}°, where θ_{A}°=45°. The ratio of A2 to A1=2, where A2=2a/3, A1=a/3, and A2=c√(2/9).

In accordance with an aspect of the invention, which is depicted in FIG. 5G, three truncated right trapezoid-shaped faces 504a-504c can be used to construct a second equilateral triangle truncated triangular trihedral corner reflector 506a. Referring to FIG. 5G, the second truncated corner reflector 506a also has three side openings 508a-508c similar to the side openings 408a-408c of the first truncated corner reflector 406 described in relation to FIG. 4F.

FIG. 5H depicts a side view of a face 102 of the corner reflector 100 of FIGS. 5B and 5D, which has three faces 102a-102c that are each isosceles right triangles. Referring to FIG. 5H, intersecting planes 312b and 312c indicate portions of the face 102 that can be removed to produce a right trapezoid-shaped face 508 that is depicted in FIG. 5I, which has two sides of length A1, one side of length A2, one side of length c/3 and corner angles of 90°, 90°, θ_{B}°, and θ_{C}, where θ_{B}°=45°, θ_{C}=135°. The lower right truncated corner of the face 102 is an isosceles right triangle having two sides of length c/3, a third side of length A2, and corner angles of 90°, 45°, and θ_{D}°, where θ_{D}°=45°. The upper left truncated corner of the face 102 is also an isosceles right triangle having two sides of length A2, a third side of length 2c/3, and corner angles of 90°, 45°, and θ_{A}°, where θ_{A}°=45°. The ratio of A2 to A1=2, where A2=2a/3, A1=a/3, and A2=c√(2/9).

In accordance with an aspect of the invention, which is depicted in FIG. 5J, three right trapezoid-shaped faces 508a-508c can be used to construct a third equilateral triangle truncated triangular trihedral corner reflector 506b. Referring to FIG. 5J, the third truncated corner reflector 506b also has three side openings 510a-510c similar to the side openings 408a-408c of the first truncated corner reflector 406 described in relation to FIG. 4F.

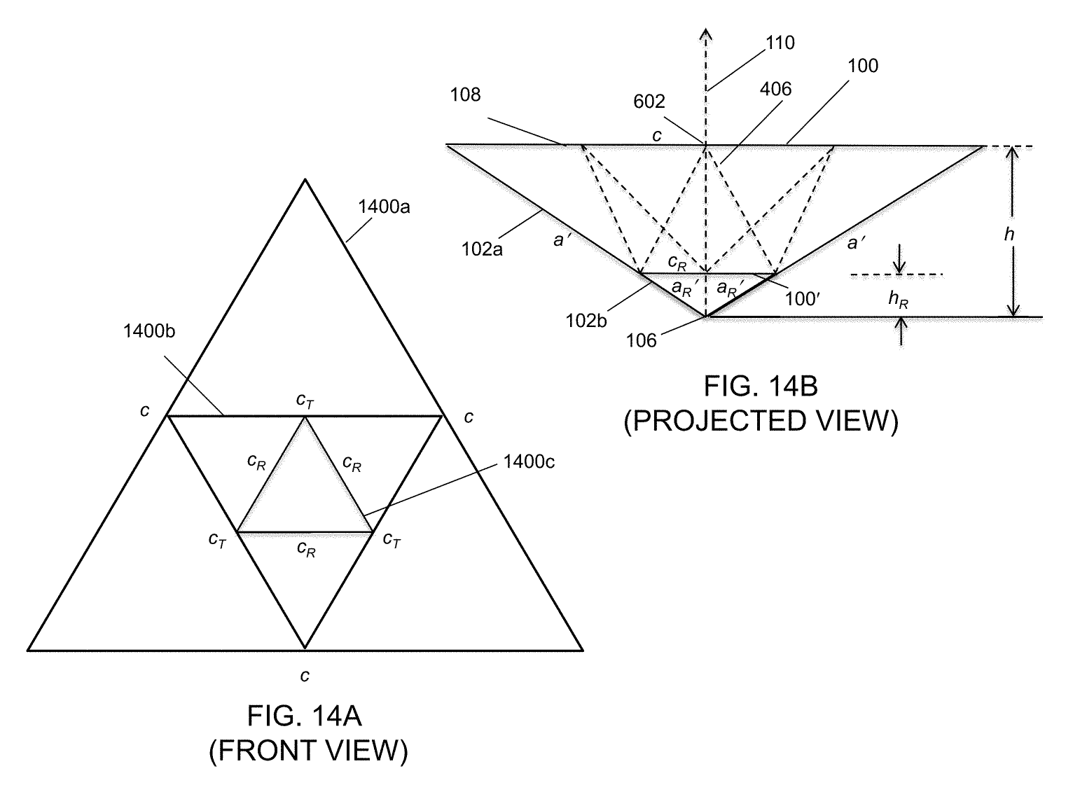

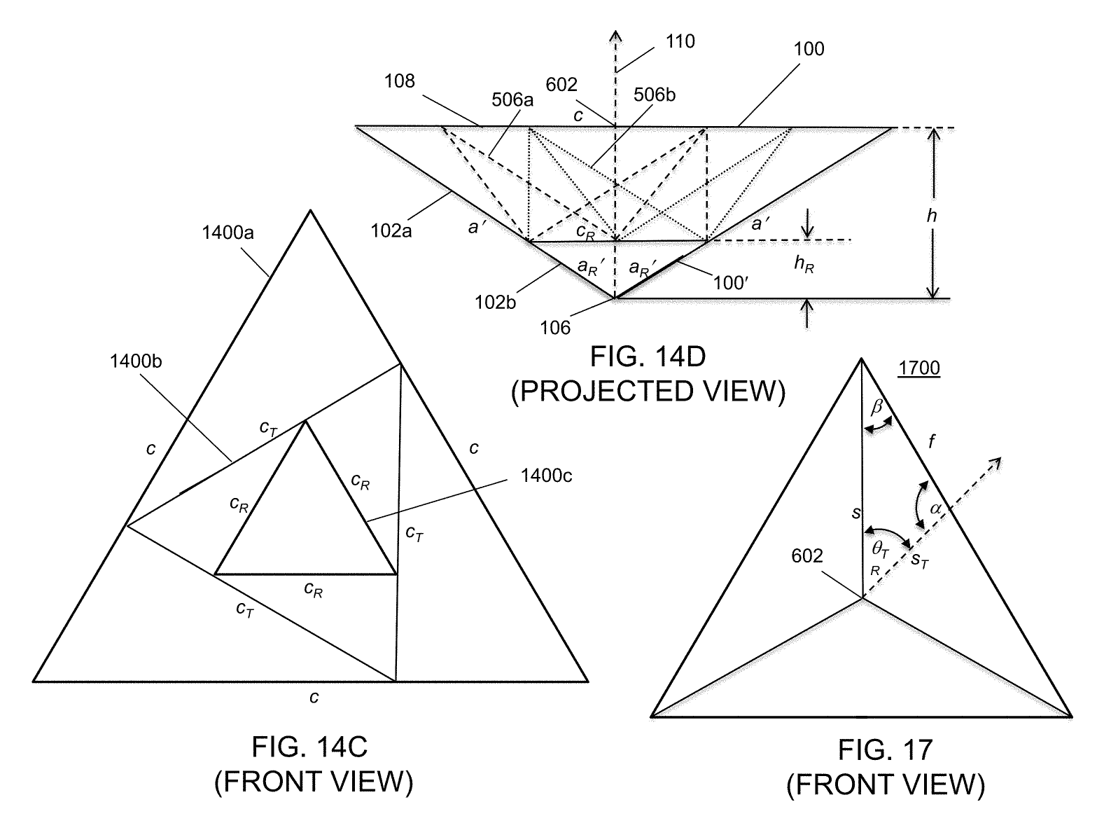

By comparing FIGS. 5E-5G to FIGS. 5H-5J it can be seen that when either the side 504 of FIGS. 5E-5G or the face 508 of FIGS. 14F-14H is turned over and rotated 90° the two faces 504 and 508 are the same. Moreover, it can be recognized that the second and third truncated corner reflectors 506a and 506b are complementary (i.e., mirror images of each other).

FIGS. 5K-5N depict front and back views of the second truncated corner reflector 506a. For clarity, front and back views are depicted with and without dashed lines indicating hidden portions of the second truncated corner reflector 506a.

FIGS. 5O-5T depict various three-dimensional views of the second truncated corner reflector 506a.

FIGS. 5U-5X depict front and back views of the third truncated corner reflector 506b. For clarity, front and back views are depicted with and without dashed lines indicating hidden portions of the third truncated corner reflector 506b.

FIGS. 5Y-5AD depict various three-dimensional views of the third truncated corner reflector 506b, where it can be seen that the various views of FIGS. 5K-5T are mirror images of the various views of FIGS. 5U-5AD.

A second truncated corner reflector 506a and a third truncated corner reflector 506b can be tiled into an array since the outer edges of the abutting faces of the second and third truncated corner reflectors 506a and 506b can be complementary to (or mirror images of) each other, where they have the same dimensions. Moreover, because the second and third truncated corner reflectors 506a and 506b are symmetrical in three directions, either the second or the third truncated corner reflectors 506a and 506b can be rotated ±120° and will tile with the other truncated corner reflector. Furthermore, an additional second truncated corner reflector 506a can be added to an array by tiling with any third truncated corner reflector 506b of the array (or an additional third truncated corner reflector 506b can be added to an array by tiling with any second truncated corner reflector 506a of the array).

FIGS. 5AE-5AH depict top, side, and oblique projection views of an exemplary second equilateral triangle truncated triangular trihedral corner reflector array 512 in accordance with an aspect of the invention. Referring to FIGS. 5AE-5AH, the second truncated corner reflector array 512 comprises a plurality of second truncated corner reflectors 506a like those of FIGS. 5K-5T and a plurality of third truncated corner reflectors 506b like those of FIGS. 5U-5AD, which are in an alternating pattern such that each second truncated corner reflector 506a only abuts (or is tiled with) one or more third truncated corner reflector 506b, and vice versa.

Two second truncated corner reflectors 506a can be combined into an array even though the outer edges of the faces of the two second truncated corner reflectors 506a do not align with each other (i.e., they do not tile), where triangular faces 410 can optionally be used to fill openings of the abutting second truncated corner reflectors 506a. Similarly, two third truncated corner reflectors 506b can be combined into an array even though the outer edges of the faces of the two third truncated corner reflectors 506b do not tile with each other, where triangular faces 410 can optionally be used to fill openings of the abutting third truncated corner reflectors 506b.

FIG. 5AI depicts a right trapezoid-shaped face 504 like that shown in FIG. 5F except it is rotated such that a corner having a right triangle points downward and its corner opposite and furthest from the right triangle points upward. A dashed line is used to subdivide the face 504 into a lower portion that is an isosceles right triangle having sides of length A1, A1 and c/3, where c/3=A1√2, and an upper portion that is an isosceles right triangle having sides of length c/3, c/3, and A2. The lower portion is an isosceles right triangle like that of FIG. 5E except it is smaller in size.

FIG. 5AJ depicts a right trapezoid-shaped face 508 like that shown in FIG. 5I except it is rotated such that a corner having a right triangle points downward and its corner opposite and furthest from the right triangle points upward. A dashed line is used to subdivide the face 508 into a lower portion that is an isosceles right triangle having sides of length A1, A1 and c/3, where c/3=A1√2, and an upper portion that is an isosceles right triangle having sides of length c/3, c/3, and A2. The lower portion is an isosceles right triangle like that of FIG. 5H except it is smaller in size.

FIG. 5AK depicts a second truncated corner reflector 506a like that of FIG. 5G with dashed lines corresponding to a corner reflector 100 having three faces 504a-504c each being an isosceles right triangle having two sides of length A1 and a side of length c/3 and having an opening corresponding to an equilateral triangle having three sides of length c/3. Referring to FIG. 5AK, the three faces 504a-504c of the second truncated corner reflector 506a also include upper portions each being an isosceles triangle having sides of length c/3, c/3, and A2.

FIG. 5AL depicts a third truncated corner reflector 506b like that of FIG. 5J with dashed lines corresponding to a corner reflector 100 having three faces 508a-508c each being an isosceles right triangle having two sides of length A1 and a side of length c/3 and having an opening corresponding to an equilateral triangle having three sides of length c/3. Referring to FIG. 5AL, the three faces 508a-508c of the third truncated corner reflector 506b also include upper portions each being an isosceles triangle having sides of length c/3, c/3, and A2.

FIG. 5AM depicts an exemplary array (or cell) 514 of three of the second truncated corner reflectors 506a and three of the third truncated corner reflectors 506b arranged in a circular pattern having an outer boundary having a hexagonal shape. Shown inside the three of the second truncated corner reflectors 506a and three of the third truncated corner reflectors 506b are corresponding six corner reflectors 100a-100e. In the middle of the array 514, upper portions of three of the faces 504 of the three second truncated t corner reflectors 506a and upper portions of three of the faces 508 of the three third truncated corner reflectors 506a form a right triangular pyramid 516 as indicated by the thicker dashed line. The right triangular pyramid 516 has a triangular base with three sides of length 2c/3 and has three triangular faces that are each isosceles triangles with two sides of length A2 and one side of length 2c/3. Whereas each corner reflector 100 can be described as a retro-reflecting component of the array 514, the right triangular pyramid 516 can be described as being a scattering component, where larger arrays such as the array 512 may include multiple right triangular pyramids 516. Moreover, the array 514 is made up of faces 504 and 508, where each face corresponds to a portion of a corner reflect 100 (or retro-reflecting component) and a portion of a right triangular pyramid 416 scattering component, where each of the two components can both retro-reflect or scatter energy depending on the direction of energy reflecting off of the components.

FIG. 5AN depicts a projected view of the right triangular pyramid 516 of FIG. 5AM.

FIG. 5AO depicts a projected view of an alternative ‘taller’ right triangular pyramid 516′ that could be used in place of the right triangular pyramid 516 in the array 514. Referring to FIG. SAP, the alternative ‘taller’ right triangular pyramid 516′ has the same base as does the right triangular pyramid 516 but has three triangular faces that are each isosceles triangles with two sides of length A2′ and one side of length 2c/3, where A2′>A2.

FIG. 5AP depicts a projected view of an alternative ‘shorter’ right triangular pyramid 516″ that could be used in place of the right triangular pyramid 416 in the array 514. Referring to FIG. 5AP, the alternative ‘shorter’ right hexagonal pyramid 516″ has the same base as does the right hexagonal pyramid 516 but has three triangular faces that are each isosceles triangles with two sides of length A2″ and one side of length 2c/3, where A2″<A2.

FIG. 5AQ depicts a projected view of an alternative ‘inverted’ right triangular pyramid 516′″ that could be used in place of the right triangular pyramid 516 in the array 514. Referring to FIG. 5AQ, the ‘inverted’ right triangular pyramid 616′″ has the same base as does the right triangular pyramid 516 but has three triangular faces that are each isosceles triangles with two sides of length A2′″ and one side of length 2c/3, where A2′″<0. Alternatively, the right triangular pyramid 516 in the array 514 could instead be a plane in the shape of an equilateral triangle having three sides of length 2c/3 (i.e., where A2=0), which is not shown. In yet another arrangement, the right triangular pyramid 516 in the array 514 could be replaced by various triangular pyramids that are comparable to the right triangular pyramids 516, 516′, 516″, and 516′″ of FIGS. 5AN-5AQ but which are not right triangular pyramids.

In accordance with the invention, a trihedral corner reflector (e.g., a triangular trihedral corner reflector 100, a square trihedral corner reflector 200, or a circular trihedral corner reflector) can be truncated using a truncating object (e.g., an equilateral triangle shaped object), where the rotation of a truncating object relative to the reference 0° rotation can be referred to as the truncation rotation, rotation angle, truncation rotation angle, rotation of truncation, angle of truncation, truncation angle, or θ_{TR}.

It can also be noted that 0°, 120°, and 240° centered vertical equilateral triangle truncation rotations relative to a reference 0° rotation have no purpose since they correspond to no truncation of a prior art trihedral corner reflector.

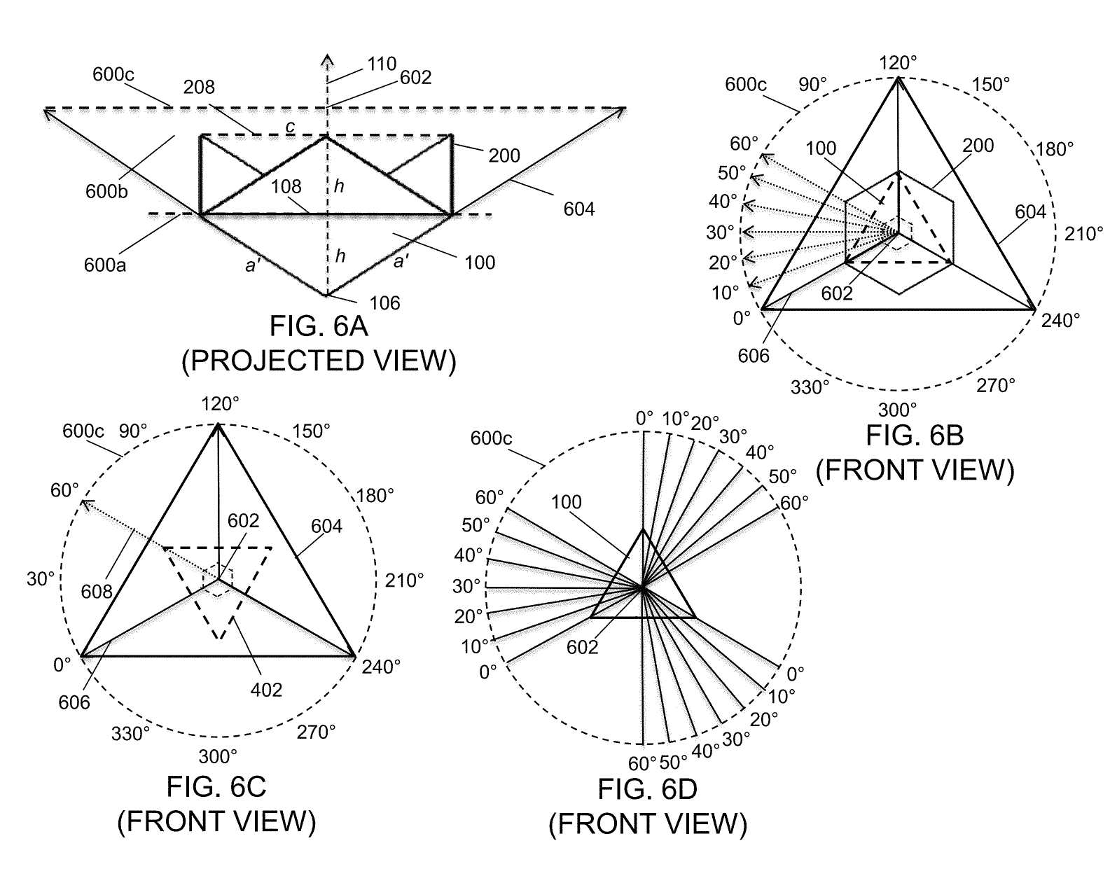

FIG. 6A depicts a projected view of an exemplary triangular trihedral corner reflector 100 such as depicted in FIG. 1B overlaid onto a projected view of an exemplary square trihedral corner reflector 200 such as depicted in FIG. 2B. Referring to FIG. 6A, the triangular trihedral corner reflector 100 and square trihedral corner reflector 200 both have a common center point 106 and common symmetry axis 110. The opening 108 of the triangular trihedral corner reflector 100 corresponds to a first plane 600a and the opening 208 of the square trihedral corner reflector 200 corresponds to a second plane 600b. A rotational coordinate system can be established along a rotational plane 600c perpendicular to the symmetry axis 110, which is also parallel to the first plane 600a and the second plane 600b. A rotation point 602 corresponds to the intersection of the symmetry axis 110 and the rotational plane 600c. As such, a rotating vector can be described as being able to rotate about the symmetry axis 110 within rotational plane 600c. Moreover, the three sides making up the triangular trihedral corner reflector 100 and/or the square trihedral corner reflector 200 can generally be treated as a trihedral corner having an opening corresponding to the rotational plane 600c, where the outermost portions of the three sides of the trihedral corner extend to the rotational plane 600c and beyond.

FIG. 6B depicts a front view of the exemplary triangular trihedral corner reflector 100, square trihedral corner reflector 200, and trihedral corner 604 of FIG. 6A, where the rotational plane 600c of FIG. 6A is shown to be a circle. A reference 0° rotation 606 is shown as well as exemplary truncation rotations at 10°, 20°, 30°, 40°, 50°, and 60° increments.

FIG. 6C depicts the exemplary trihedral corner 604 and exemplary rotational plane 600c of FIGS. 6A and 6B without the exemplary triangular trihedral corner reflector 100 and square trihedral corner reflector 200. Referring to FIG. 6C, a truncating equilateral triangle 402 is shown having a 60° truncation rotation 608 relative to the reference 0° rotation 606. Truncation by an equilateral triangle having a 60° truncation rotation and creation of a corresponding first truncated corner reflector 406 and corresponding exemplary arrays 412 and 414 of first truncated corner reflectors 406 was previously described in relation to FIGS. 4A-4X.

Vertical truncations of a trihedral corner reflector (e.g., a triangular trihedral corner reflector 100) are equivalent for 60°, 180°, and 300° truncation rotations of a truncating object centered on the symmetry axis 110. Centered vertical truncations of a trihedral corner reflector are also equivalent for truncation rotations between 0° and 60°, between 120° and 180°, and between 240° and 300°. Additionally, centered vertical truncations of a trihedral corner reflector for truncation rotations between 0° and 60°, between 120° and 180°, and between 240° and 300° are complementary (i.e., mirror images) to centered vertical truncations of a trihedral corner 100 for truncation rotations between 60° and 120°, between 180° and 240°, and between 300° and 360° (or 0°), respectively. For simplicity, the possible range of unique centered vertical truncations of a trihedral corner reflector can be described as having truncation rotation angles that are greater than or equal to 0° and less than or equal to 120° (i.e., 0°≥θ_{TR}≤120°), where any corner of the equilateral triangle corresponding to the opening of the trihedral corner reflector can be designated as being a reference 0° rotation such as is depicted in the front view of a trihedral corner reflector provided in FIG. 6D.

The described possible range of unique centered vertical truncations has been described as rotating in a clockwise manner but could have been described as rotating in a counterclockwise manner. Generally, any direction from the symmetry axis 110 could be selected as the reference 0° rotation, where a range of 120° from any selected reference 0° rotation produces the possible unique centered vertical truncations.

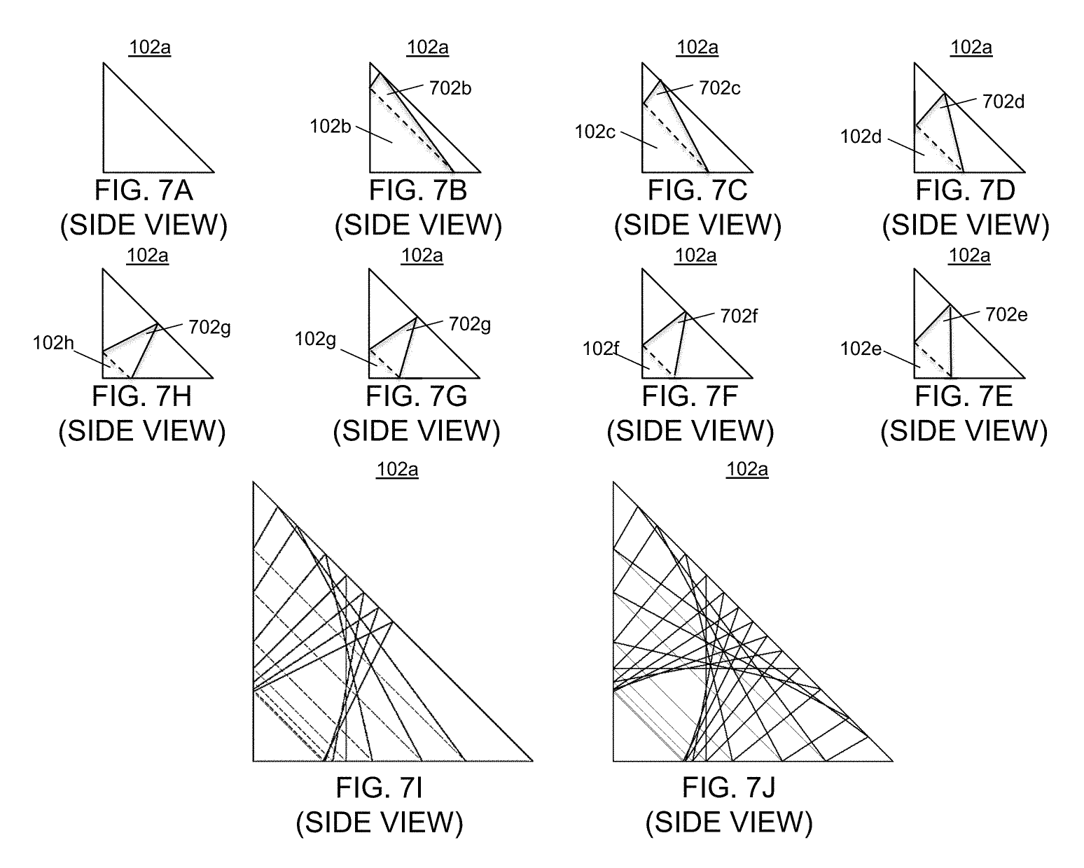

FIG. 7A depicts a side view of an exemplary isosceles right triangle 102a such as is depicted in FIG. 1D.

FIGS. 7B-7H depict side views of the exemplary isosceles right triangles 102a of FIG. 7A having dashed lines indicating the lower portions 120b-102h of the faces produced from equilateral triangle truncations of a triangular trihedral corner reflector 100 with truncation rotations of 5°, 10°, 20°, 30°, 40°, 50°, and 60°, respectively. The triangular shaped portions 702b-702h having one side that is a dashed line, which are not isosceles right triangles, correspond to the upper portions of the faces, and the remaining outer triangular portions of the isosceles right triangles 102a correspond to the truncated (or removed) portions of the isosceles right triangles 102a.

FIG. 7I depicts the exemplary isosceles right triangle 102a of FIG. 7A having dashed and solid lines that indicate the lower, upper, and truncated portions of the isosceles right triangle 102a corresponding to truncation rotations of 5°, 10°, 20°, 30°, 40°, 50°, and 60°.

FIG. 7J depicts the exemplary isosceles right triangle 102a of FIG. 7A having dashed and solid lines that indicate the lower, upper, and truncated portions of the isosceles right triangle 102a corresponding to truncation rotations of 5°, 10°, 20°, 30°, 40°, 50°, 60°, 70°, 80°, 90°, 100°, 110°, and 115°.

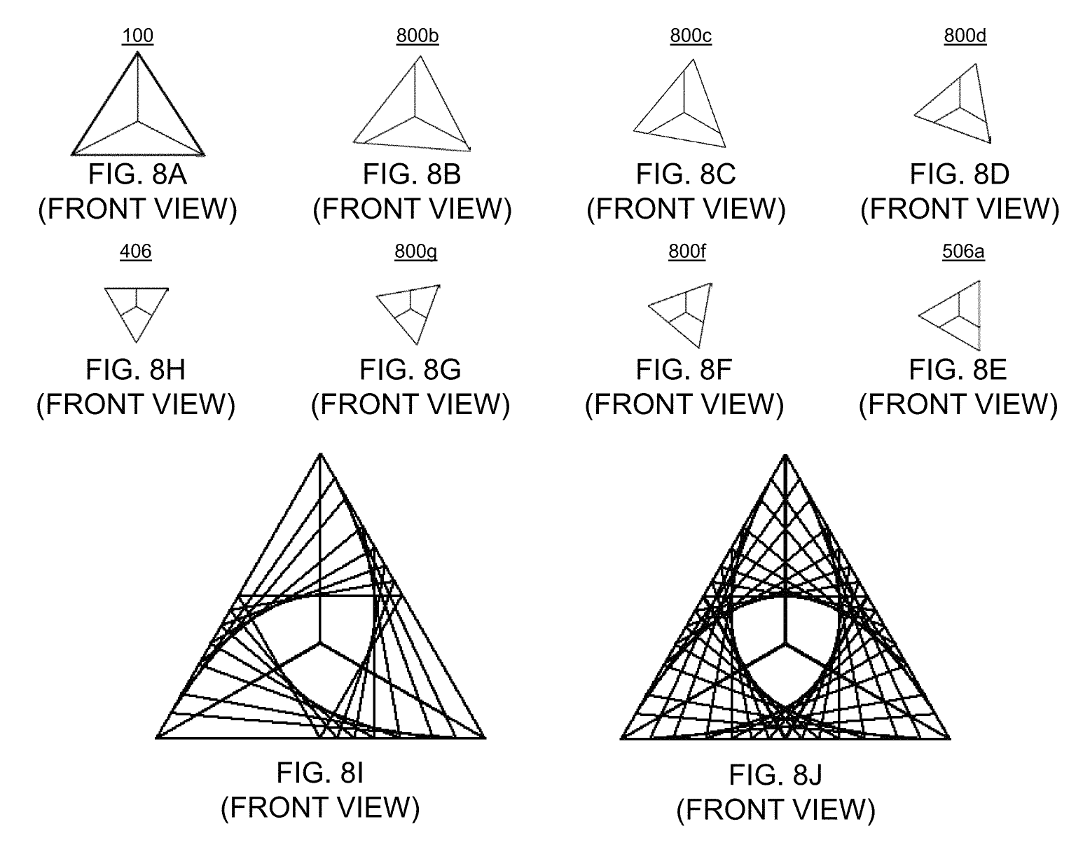

FIG. 8A depicts a front view of a triangular trihedral corner reflector 100 without a truncating equilateral triangle.

FIG. 8B-8G depict front views of equilateral triangle truncated triangular trihedral corner reflectors 800b-800d, 506a, 800f, 800g, and 406 that correspond to equilateral triangular truncations of a triangular trihedral corner reflector 100 in accordance with the invention at 5°, 10°, 20°, 30°, 40°, 50°, and 60° rotations, respectively.

FIG. 8I depicts the exemplary triangular trihedral corner reflector 100 of FIG. 8A overlaid with each of the equilateral triangle truncated triangular trihedral corner reflectors 800b-800d, 506a, 800f, 800g, and 406 that correspond to equilateral triangular truncations of a triangular trihedral corner reflector 100 in accordance with the invention at 5°, 10°, 20°, 30°, 40°, 50°, and 60° rotations, respectively.

FIG. 8J depicts the exemplary triangular trihedral corner reflector 100 of FIG. 8A overlaid with each of the equilateral triangle truncated triangular trihedral corner reflectors that correspond to equilateral triangular truncations of a triangular trihedral corner reflector 100 in accordance with the invention at 5°, 10°, 20°, 30°, 40°, 50°, 60°, 70°, 80°, 90°, 100°, 110°, and 115° rotations, respectively.

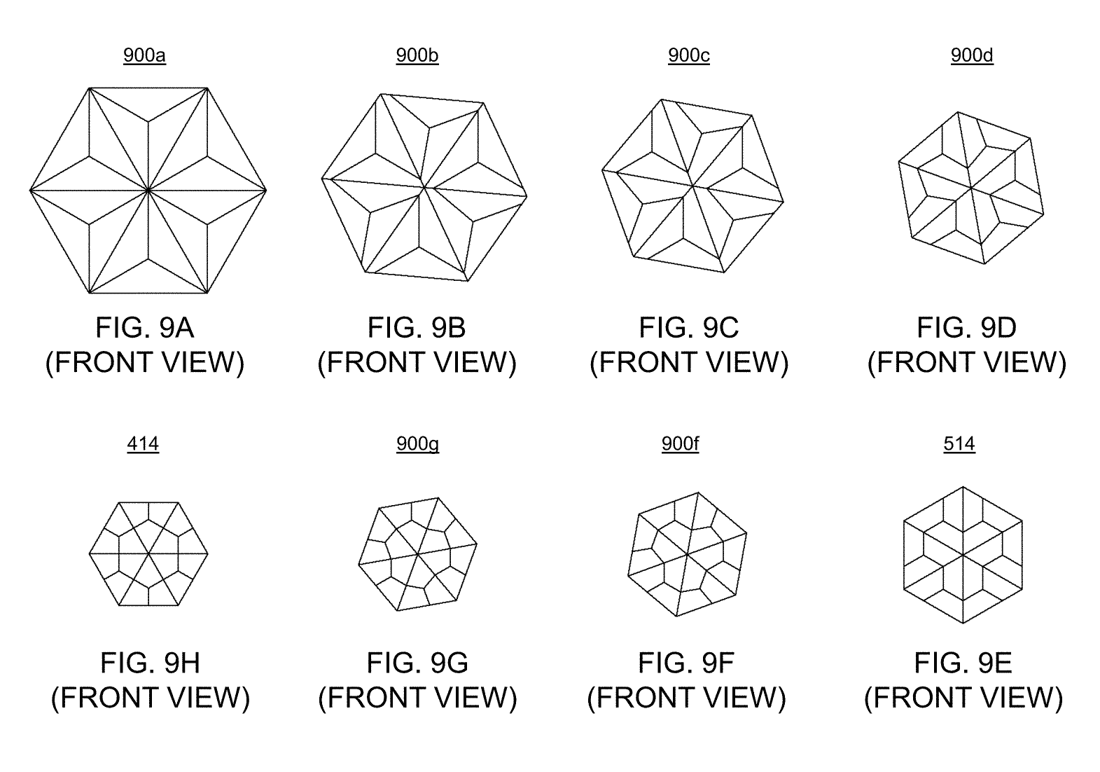

FIG. 9A depicts an exemplary array (or cell) 900a of six triangle triangular trihedral corner reflectors 100.

FIGS. 9B-9G depict front views of exemplary arrays (or cells) 900b, 900c, 900d, 514, 900f, and 900g each comprising three equilateral triangle truncated triangular trihedral corner reflectors produced by equilateral triangular truncations of a triangular trihedral corner reflector 100 in accordance with the invention at 5°, 10°, 20°, 30°, 40°, and 50° rotations, respectively, in an alternating pattern with three ‘mirror image’ equilateral triangle truncated triangular trihedral corner reflectors produced by equilateral triangular truncations of a triangular trihedral corner reflector 100 in accordance with the invention at 115°, 110°, 100°, 90°, 80°, and 70°, rotations, respectively.

FIG. 9H depicts the exemplary array 414 of six first truncated corner reflectors 406 produced in accordance with the invention using a 60° truncation rotation. It can be noted that the first truncated corner reflectors 406 produced in accordance with the invention using a 60° truncation rotation have 120° symmetrical characteristics similar to those of triangle triangular trihedral corner reflectors 100, where they tile (or pair) with themselves and therefore do not require tiling (or pairing) with mirror image equilateral triangle truncated triangular trihedral corner reflectors.

FIGS. 10A-10H depict side views of the arrays 900a, 900b, 900c, 900d, 514, 900f, 900g, and 414 of FIGS. 9A-9H. Referring to FIGS. 10A-10H, dashed lines indicate the dividing of the arrays into lower portions that retro-reflecting components and upper portions that are scattering components.

FIGS. 11A-11H depict opposite side views of the arrays 900a, 900b, 900c, 900d, 514, 900f, 900g, and 414 of FIGS. 9A-9H.

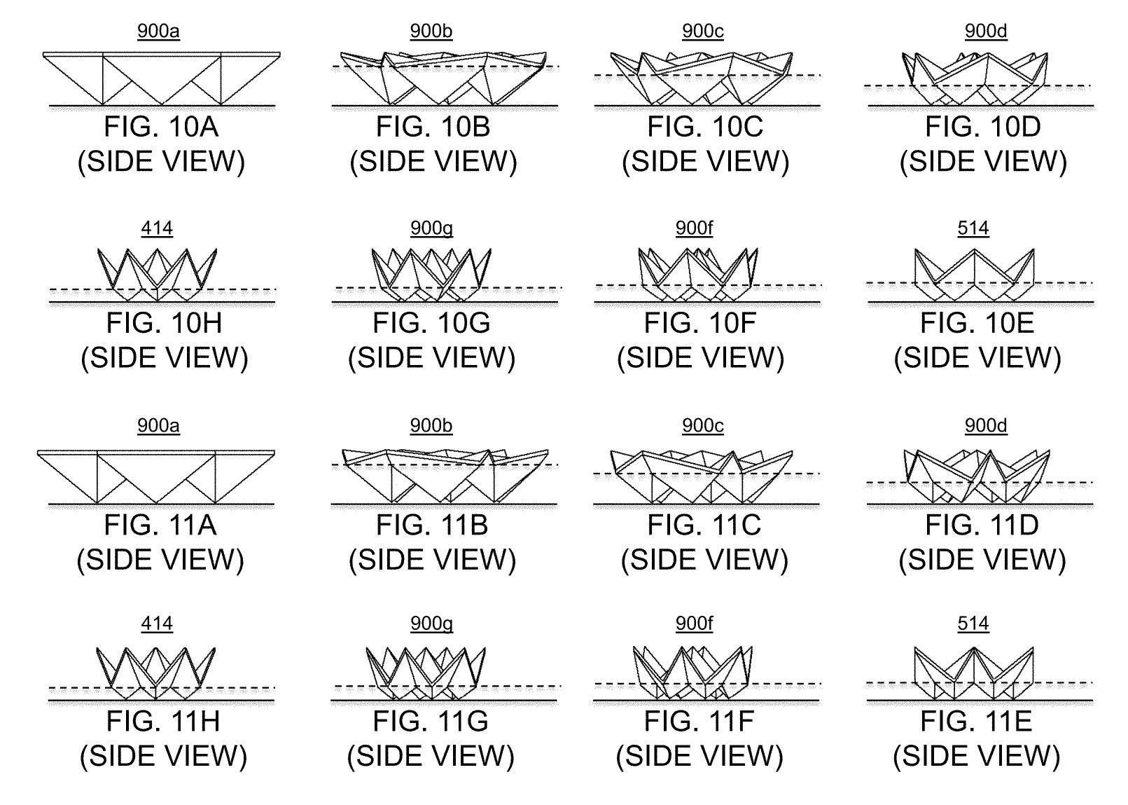

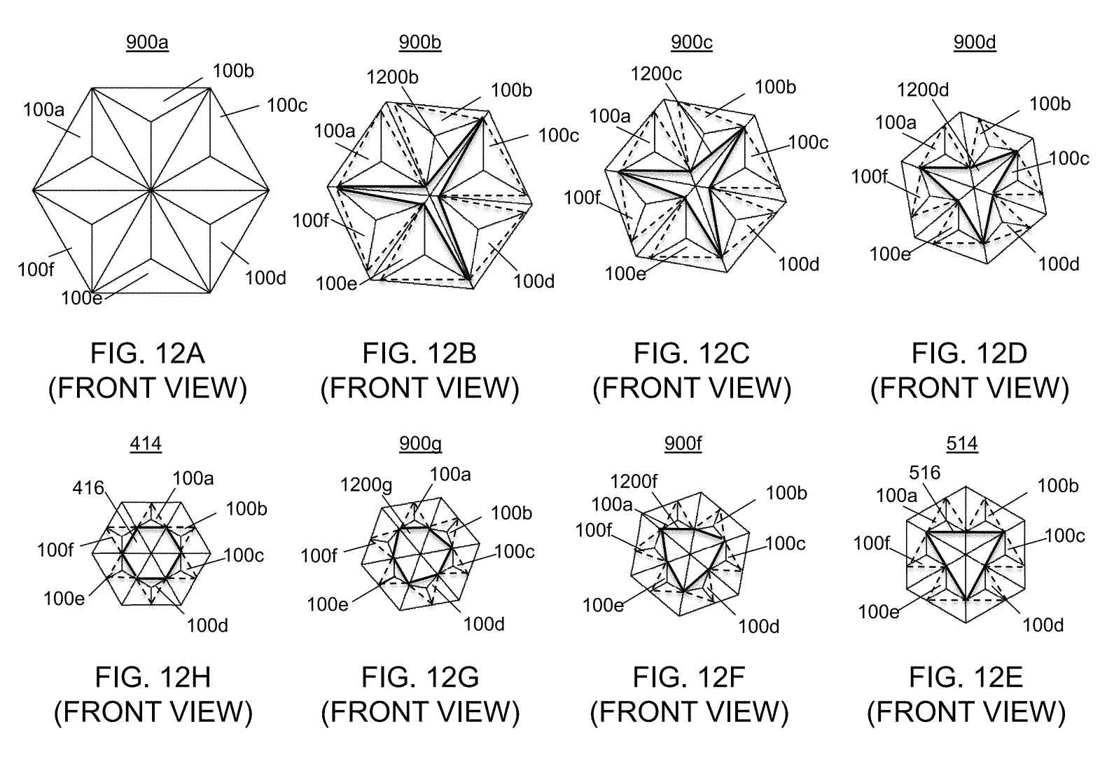

FIGS. 12A-12H depict front views of the arrays 900a, 900b, 900c, 900d, 514, 900f, 900g, and 414 of FIGS. 9A-9H each with dashed lines to indicate six triangular trihedral corner reflectors 100a-100e and with dark solid lines to indicate scattering components 1200b, 1200c, 1200d, 516, 1200f, 1200g, and 416, respectively. Referring to FIGS. 12A-12H, as the rotation angles of the equilateral triangular truncations used to produce the six equilateral triangle truncated triangular trihedral corner reflectors of the respective arrays 900a, 900b, 900c, 900d, 514, 900f, 900g, and 414 increases from 5° to 60° rotations, the seven triangular trihedral corner reflectors 100a-100e change in size and in orientation to each other and the scattering components in the middle of the arrays 900b, 900c, 900d, 514, 900f, 900g, and 414 incrementally change shape from being a sequence of three different concave right hexagonal pyramids (i.e., for arrays 900b, 900c, and 900d) to a right triangular pyramid (i.e., 514) to two different irregular convex right hexagonal pyramids (i.e., 900f and 900g) to a (regular) right hexagonal pyramid (i.e., 414). The portions of the equilateral triangle truncated triangular trihedral corner reflectors that are outside the six triangular trihedral corner reflectors 100a-100e of each of the respective arrays 900b, 900c, 900d, 514, 900f, 900g, and 414 correspond to portions of additional scattering components 1200b, 1200c, 1200d, 516, 1200f, 1220g, and 416, respectively, which can become completed scattering components 1200b, 1220c, 1220d, 516, 1200f, 1220g, and 416 as additional equilateral triangle truncated triangular trihedral corner reflectors are added to a given array.

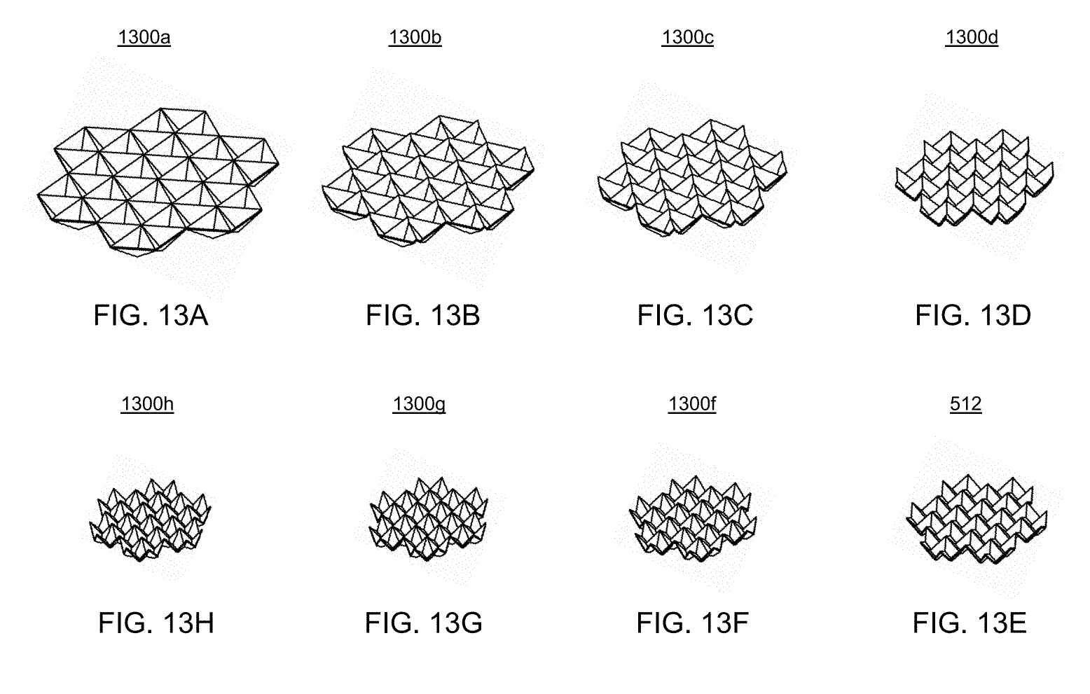

FIGS. 13A-13H depict oblique views of arrays 1300a, 1300b, 1300c, 1300d, 512, 1330f, 1330g, and 1300h that are similar to the arrays 900a, 900b, 900c, 900d, 514, 900f, 900g, and 414 of FIGS. 9A-9H except they comprise additional truncated equilateral triangle truncated triangular trihedral corner reflectors and multiple scattering components.

Generally, the ratio of scattering portions to retro-reflecting portions of truncated triangular trihedral corner reflectors and corresponding arrays of truncated triangular trihedral corner reflectors increases as the truncation rotation angle increases from 0° to 60°. This ratio decreases as the truncation rotation angle increases from 60° to 120°, increases as the truncation rotation angle increases from 120° to 180°, decreases as the truncation rotation angle increases from 180° to 240°, increases as the truncation rotation angle increases from 240° to 300°, and decreases as the truncation rotation angle increases from 300° to 360° (or 0). At 0°, 120°, and 240° rotations, the array is made up only of retro-reflecting portions such as depicted in FIG. 9A, which corresponds to an array of prior art triangular trihedral corner reflectors 100 that have not been truncated.

In accordance with an aspect of the invention, the rotation angle of the equilateral triangular truncation of a trihedral corner reflector corresponds to a percentage of retro-reflecting portions to scattering portions of both a corresponding equilateral triangular truncated trihedral corner reflector and an array of corresponding equilateral triangular truncated trihedral corner reflectors, where a rotation angle of a truncation corresponding to a given percentage can be derived, and vice versa. A percentage of retro-reflecting portions to scattering portions also corresponds to a ratio of retro-reflecting portions to scattering portions, were a rotation angle of 0° corresponds to a 100% retro-reflecting portions percentage or 1:0 retro-reflecting portions to scattering portions ratio.

FIG. 14A depicts a front view of the relative sizes and orientations of three equilateral triangles 1400a-1400c corresponding to the equilateral triangular truncation scenario involving a truncation rotation of 60° described above relative to FIGS. 4A-4Y. Referring to FIG. 14A, a first equilateral triangle 1400a corresponding to the opening of a triangular trihedral corner reflector 100a has three sides of length c. A second equilateral triangle 1400b corresponding to a truncating equilateral triangle is rotated 60° relative to the first equilateral triangle 800a and has three sides of length c_{T}, where c_{T}=c/2. The third equilateral triangle 800c corresponding to the opening of the remaining triangular trihedral corner reflector portion 100b of the truncated triangular trihedral corner reflector is rotated 60° relative to the second equilateral triangle 800b and has three sides of length c_{R}, where c_{R}=c/4.

FIG. 14B depicts a projected view of a triangular trihedral corner reflector 100 prior to equilateral triangular truncation using a truncation rotation of 60°, the first truncated corner reflector 406, and the remaining triangular trihedral corner reflector 100′ of the triangular trihedral corner reflector 100 after truncation, where the remaining triangular trihedral corner reflector 100′ is the (lower) retro-reflecting portion of the first truncated corner reflector 406. Referring to FIG. 14B, the three sides of the projected face 102a of the triangular trihedral corner reflector 100, which is an isosceles right triangle, are of lengths a, a, and c, respectively, and the three sides of the projected face 102b of the remaining triangular trihedral corner reflector 100′, which is also an isosceles right triangle, are of lengths a_{R}′, a_{R}′, and c_{R}, respectively, where a_{R}′=a′/4 and c_{R}=c/4. The triangular trihedral corner reflector 100 has a height of h. The remaining triangular trihedral corner reflector 100′ has a height of h_{R}, where h_{R}=h/4, and the (upper) scattering portion of the first truncated corner reflector 406 has a height of 3h/4.

FIG. 14C depicts a front view of the relative sizes and orientations of three equilateral triangles 1400a-1400c corresponding to the equilateral triangular truncation scenario involving a truncation rotation of 30° described above relative to FIGS. 5A-5AN. Referring to FIG. 14C, a first equilateral triangle 1400a corresponding to the opening of a triangular trihedral corner reflector 100a has three sides of length c. A second equilateral triangle 1400b corresponding to a truncating equilateral triangle is rotated 30° relative to the first equilateral triangle 800a and has three sides of length c_{T}, where c_{T}=c/√3. The third equilateral triangle 800c corresponding to the opening of the triangular trihedral corner reflector portion 100b of the truncated triangular trihedral corner reflector is rotated 30° relative to the second equilateral triangle 800b and has three sides of length c_{R}, where c_{R}=c/3.

FIG. 14D depicts a projected view of a triangular trihedral corner reflector 100 prior to equilateral triangular truncation using a truncation rotation of 30°, the second and third equilateral triangle truncated triangular trihedral corner reflectors 506a and 506b, and the remaining triangular trihedral corner reflector 100′ of the triangular trihedral corner reflector 100 after truncation, where the remaining triangular trihedral corner reflector 100′ is the (lower) retro-reflecting portion of the second and third truncated corner reflectors 506a and 506b. Referring to FIG. 14D, the three sides of the projected face 102a of the triangular trihedral corner reflector 100, which is an isosceles right triangle, are of lengths a′, a′, and c, respectively, and the three sides of the projected face 102b of the remaining triangular trihedral corner reflector 100′, which is also an isosceles right triangle, are of lengths a_{R}′, a_{R}′, and c_{R}, respectively, where a_{R}′=a′/3 and c_{R}=c/3. The triangular trihedral corner reflector 100 has a height of h. The remaining triangular trihedral corner reflector 100′ has a height of h_{R}, where h_{R}=h/3, and the (upper) scattering portions of the second and third truncated corner reflectors 506a and 506b have a height of 2h/3.

In accordance with the invention, the relative sizes and orientations of the equilateral triangles 1400a-1400c corresponding to a given equilateral triangular truncation scenario depends on the truncation rotation angle used for a given equilateral triangular truncation. FIGS. 15A-15H depict relative sizes and orientations of the equilateral triangles 1400a-1400c for truncation rotation angles of 0°, 5°, 10°, 20°, 30°, 40°, 50°, and 60°. FIGS. 16A-16H also depict relative sizes and orientations of the equilateral triangles 1400a-1400c for truncation rotation angles of 0°, 5°, 10°, 20°, 30°, 40°, 50°, and 60°.

The three equilateral triangles 1400a-1400c of FIGS. 14A and 14C can generally be referred to as the initial equilateral triangle, the truncating equilateral triangle, and the remaining equilateral triangle, where the equilateral triangles 1400a-1400c have three sides each having lengths of c, c_{T}, and c_{R}, respectively. Generally, the three equilateral triangles 1400a-1400c can be described as having initial equilateral triangle scaler length value s, truncating equilateral triangle scaler length value S_{T}, and remaining equilateral triangle scaler length value S_{R} for each of their three sides, respectively. Similarly, the three equilateral triangles 1400a-1400c can be described as having initial equilateral triangle scaler area value A, truncating equilateral triangle scaler area value A_{T}, and remaining equilateral triangle scaler area value A_{R}, respectively. Moreover the initial (pre-truncation) triangular trihedral corner reflector 100a and the remaining (after-truncation) triangular trihedral corner reflector portion 100b of the equilateral triangle truncated triangular trihedral corner reflectors (e.g., 406, 506a, and 506b) of FIGS. 14B and 14D can be described as having initial triangular trihedral corner reflector scaler length values s and remaining triangular trihedral corner reflector scaler values s_{R} for each of their two heights and an initial triangular trihedral corner reflector volume V and a remaining triangular trihedral corner reflector V_{R}, respectively.

FIG. 17 depicts an exemplary mathematical model 1700 for centered equilateral triangle vertical truncations that can be used for calculating scaler lengths, areas, and volumes based on a truncation rotation angle θ_{TR} in accordance with the invention, where a triangle has a side having a length s and a corner having an angle β that both remain constant regardless of the truncation rotation angle θ_{TR}. The triangle also has two other sides having lengths S_{T} and f and another corner having an angle α that vary with the truncation rotation angle θ_{TR}. The mathematical model 1700 has the following governing equations:

β=30°; 0°>θ_{TR}≤60°; 0°>α≤90°; α=180°−30°−θ_{TR}

sin(β)/s_{T}=sin(α)/s

s_{T}/s=s_{R}/s_{T}=1/(cos(θ_{TR})+√3 sin(θ_{TR}))

s_{R}/s=s_{T}/s*s_{R}/s_{T}32 1/(cos(θ_{TR})+√3 sin(θ_{TR}))²

h=c/√6; h_{R}=c_{R}/√6

A=c²√3/4; A_{T}=c_{T}²√3/4; A_{R}=c_{R}²√3/4

A_{T}/A=A_{R}/A_{T}=1/(cos(θ_{TR})+√3 sin(θ_{TR}))²

A_{R}/A=A_{T}A*A_{R}/A_{T}=1/(cos(θ_{TR})+√3 sin(θ_{TR}))⁴

V=Ah/3; V_{R}=A_{R}h_{R}/3

V_{R}/V=(s_{R}/s)³=((s_{T}/s)²)³=1/(cos(θ_{TR})+√3 sin(θ_{TR}))⁶

The scaler length, height, area, and volume ratios for a range of exemplary truncation rotation angles are provided in Table 1.

TABLE 1
Scaler Ratios for Example Truncation Rotation Angles

| θ_{TR} | s_{T}/s | s_{R}/s | A_{T}/A | A_{R}/A | V_{R}/V |
|---|---|---|---|---|---|
| 5° | .87172 | .75990 | .75990 | .57745 | .43881 |
| 10° | .77786 | .60507 | .60507 | .36611 | .22152 |
| 20° | .65270 | .42602 | .42602 | .18149 | .07732 |
| 30° | .57735 | 0.33333 | 0.33333 | .11111 | .03704 |
| 40° | .53209 | 0.28312 | 0.28312 | .08016 | .02269 |
| 50° | .50771 | 0.25777 | 0.25777 | .06645 | .01713 |
| 60° | .5 | .25 | .25 | .0625 | .01563 |

As shown above, the exemplary mathematical model 1700 can be applied to calculate scaler ratios for a given truncation rotation angle and to calculate a truncation rotation angle for a given scaler ratio.

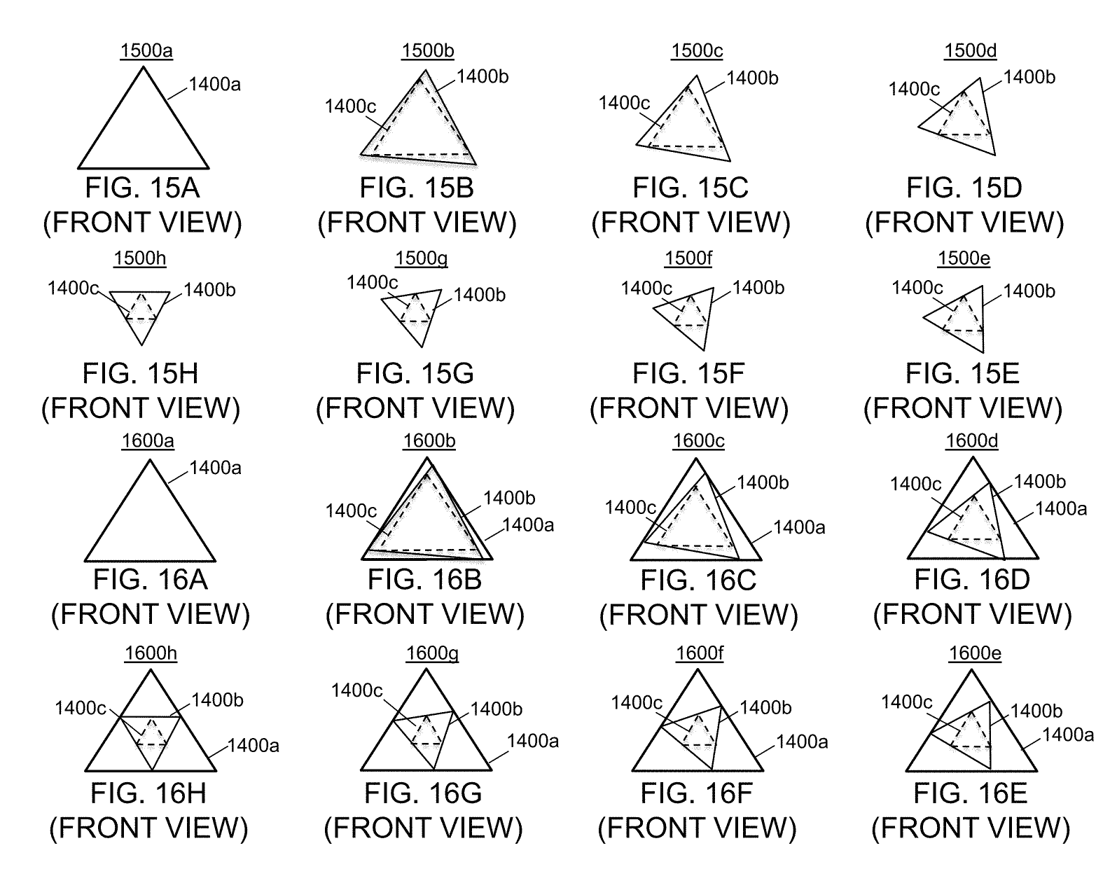

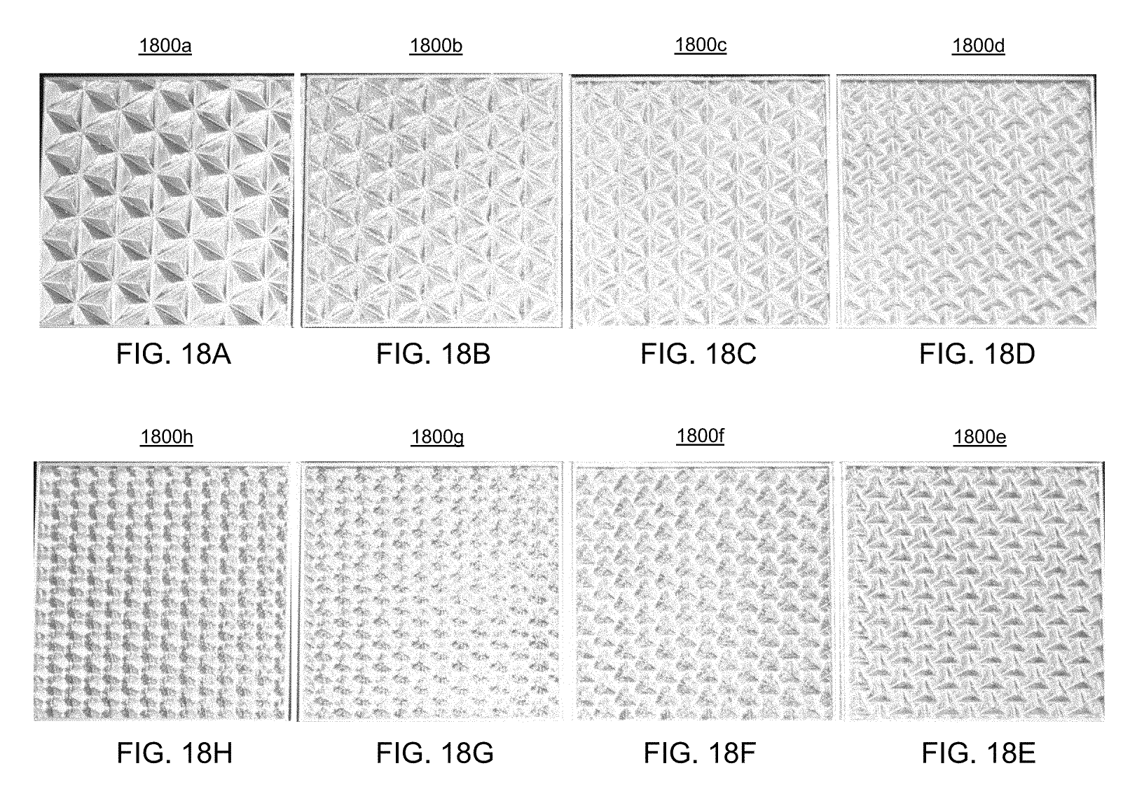

FIGS. 18A-18H depict photographs of approximately 3.5 inch×3.5 inch×0.25 inch high boxes having reflective surfaces corresponding to arrays 1800a-1800h each made up of reflective components (i.e., equilateral triangle truncated triangular trihedral corner reflectors) that are each one-quarter inches in height, which were producing using a 3D printer and spray painted using a reflective paint. The arrays are reflecting light from a lamp located several feet above and somewhat to the right of the arrays. Referring to FIG. 18A, the reflective components in the array 1400a are all triangular trihedral corner reflectors 100 and thus the array 1400a can be described in accordance with the invention as having a 100% retro-reflecting portion percentage and a 1:0 retro-reflecting portions to scattering portions ratio. Referring to FIGS. 18B-18H, the reflective components in the arrays 1800b-1800h correspond to rotation angles 5°, 10°, 20°, 30°, 40°, 50°, and 60°, that include both retro-reflecting portions and scattering portions and have retro-reflecting portions to scattering portions ratios corresponding to the s_{R}/s column in Table 1.

In accordance with the invention, a triangular trihedral corner reflector 100 can be truncated using an isosceles right triangle to produce an isosceles right triangle truncated triangular trihedral corner reflector, which can be included in an isosceles right triangle truncated triangular trihedral corner reflector array.

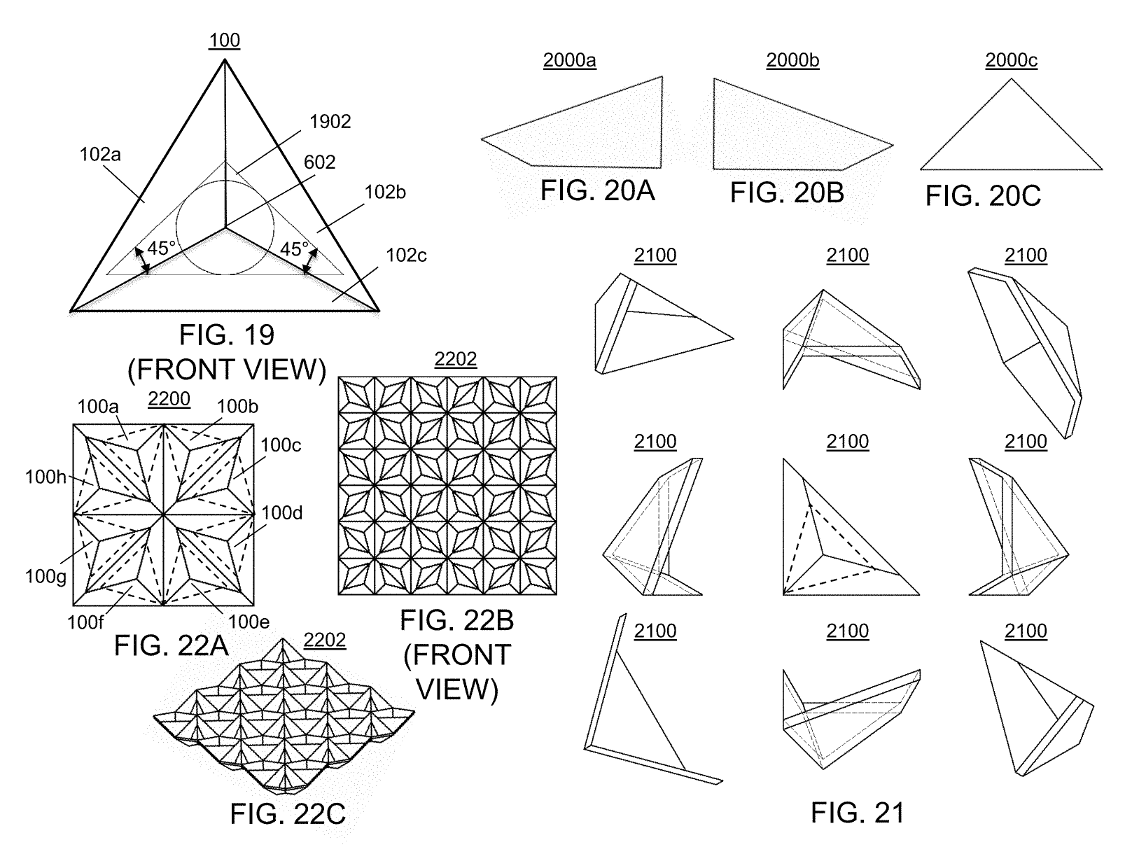

FIG. 19 depicts a front view of an exemplary vertical isosceles right triangle truncation of a triangular trihedral corner reflector 100 using an isosceles right triangle shaped truncating object 1902 having a 0° truncation rotation angle in accordance with the invention, where the center of the truncating isosceles right triangle corresponds to the center of a circle sized to intersect the three sides of the truncating isosceles right triangle at three points and the corner of the right triangle shaped truncating object that has a right angle is aligned with one of the three outer corners of the triangular trihedral corner reflector 100.

FIGS. 20A-20C depict exemplary faces 2000a-2000c produced by truncating the triangular trihedral corner reflector 100 using an isosceles right triangle shaped truncating object having a 0° truncation rotation angle in accordance with the invention.

FIG. 21 depicts multiple views of an isosceles right triangle truncated triangular trihedral corner reflector 2100 produced by truncating the triangular trihedral corner reflector 100 using an isosceles right triangle shaped truncating object having a 0° truncation rotation angle in accordance with the invention. The centermost view includes dashed lines to indicate the lower retro-reflecting portion versus the upper scattering portion of the isosceles right triangle truncated triangular trihedral corner reflector 2100.

FIG. 22A depicts an exemplary array (or cell) 2200 of isosceles right triangle truncated triangular trihedral corner reflectors 2100 in accordance with the invention. Referring to FIG. 22A, dashed lines indicate eight triangular trihedral corner reflectors 100a-100h, which are the retro-reflecting portions of the array 2200. The portions of the array 2200 other than the eight triangular trihedral corner reflectors 100a-100h are the scattering portions of the array 2200.

FIGS. 22B and 22C depict an exemplary larger array 2202 made up of nine of the arrays 2200, which are configured in three rows and three columns.

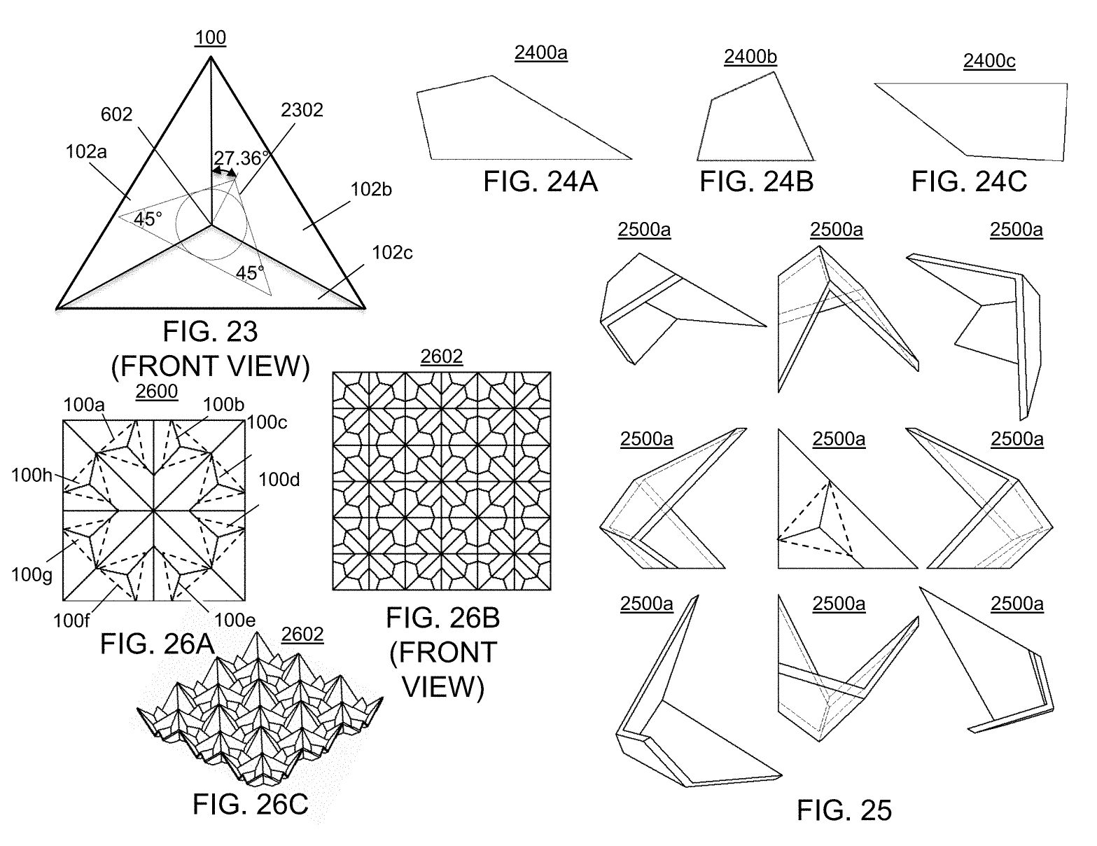

FIG. 23 depicts a front view of an exemplary vertical isosceles right triangle truncation of a triangular trihedral corner reflector 100 using an isosceles right triangle shaped truncating object 2302 having a 27.36° truncation rotation angle in accordance with the invention, where the 90° corner of the isosceles right triangle shaped truncating object is aligned 27.36° from one of the three outer corners of the triangular trihedral corner reflector 100.

FIGS. 24A-24C depict exemplary faces 2400a-2400c produced by truncating the triangular trihedral corner reflector 100 using an isosceles right triangle shaped truncating object having a 27.36° truncation rotation angle in accordance with the invention.

FIG. 25 depicts multiple views of an isosceles right triangle truncated triangular trihedral corner reflector 2500a produced by truncating the triangular trihedral corner reflector 100 using an isosceles right triangle shaped truncating object having a 26.36° truncation rotation angle in accordance with the invention. The centermost view includes dashed lines to indicate the lower retro-reflecting portion versus the upper scattering portion of the truncated corner reflector 2500a. A complementary (or mirror image) truncated corner reflector 2500b (not shown) can be produced using faces complementary to the faces 2400a-26400c of FIGS. 24A-24C (i.e., faces produced by truncating the triangular trihedral corner reflector 100 using an isosceles right triangle shaped truncating object having a 92.64° truncation rotation angle in accordance with the invention).

FIG. 26A depicts an exemplary array (or cell) 2600 of truncated corner reflectors 2500a and 2500b in accordance with the invention. Referring to FIG. 26A, dashed lines indicate eight triangular trihedral corner reflectors 100a-100h, which are the retro-reflecting portions of the array 2600. The portions of the array 2600 other than the eight triangular trihedral corner reflectors 100a-100h are the scattering portions of the array 2600.

FIGS. 26B and 26C depict an exemplary larger array 2602 made up of nine of the arrays 2600, which are configured in three rows and three columns.

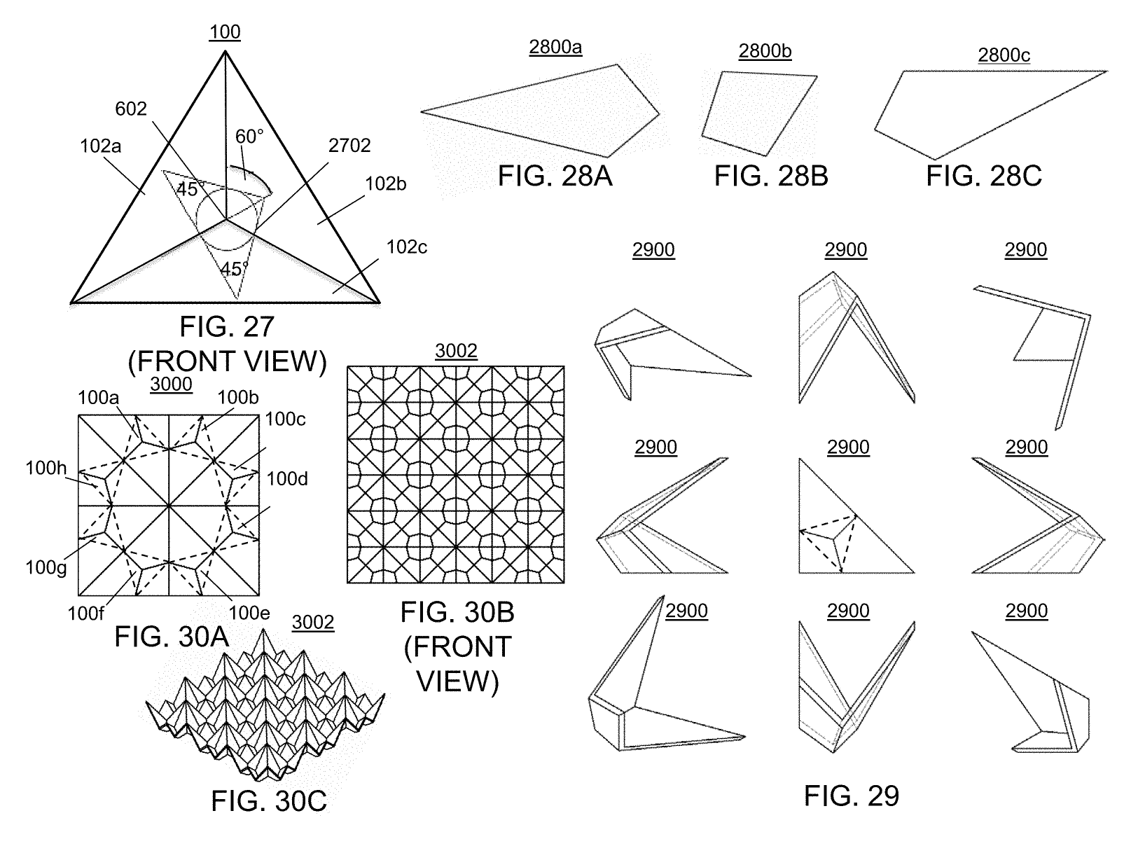

FIG. 27 depicts a front view of an exemplary vertical isosceles right triangle truncation of a triangular trihedral corner reflector 100 using an isosceles right triangle shaped truncating object 2702 having a 60° truncation rotation angle in accordance with the invention, where the 90° corner of the isosceles right triangle shaped truncating object is aligned 60° from one of the three outer corners of the triangular trihedral corner reflector 100.

FIGS. 28A-28C depict exemplary faces 2800a-2800c produced by truncating the triangular trihedral corner reflector 100 using an isosceles right triangle shaped truncating object having a 60° truncation rotation angle in accordance with the invention.

FIG. 29 depicts multiple views of an isosceles right triangle truncated triangular trihedral corner reflector 2900 produced by truncating the triangular trihedral corner reflector 100 using an isosceles right triangle shaped truncating object having a 60° truncation rotation angle in accordance with the invention. The centermost view includes dashed lines to indicate the lower retro-reflecting portion versus the upper scattering portion of the truncated corner reflector 2900.

FIG. 30A depicts an exemplary array (or cell) 3000 of truncated corner reflectors 2900 in accordance with the invention. Referring to FIG. 30A, dashed lines indicate eight triangular trihedral corner reflectors 100a-100h, which are the retro-reflecting portions of the array 3000. The portions of the array 3000 other than the eight triangular trihedral corner reflectors 100a-100h are the scattering portions of the array 3000.

FIGS. 30B and 30C depict an exemplary larger array 3002 made up of nine of the arrays 3000, which are configured in three rows and three columns.

A mathematical model for centered isosceles right triangle vertical truncations that is similar to the exemplary mathematical model 1700 for centered equilateral triangle vertical truncations described above can be used for calculating scaler lengths, areas, and volumes based on a truncation rotation angle θ_{TR} in accordance with the invention.

In accordance with the invention, a triangular trihedral corner reflector 100 can be truncated using an isosceles triangle that is not a right triangle to produce an isosceles triangle truncated triangular trihedral corner reflector, which can be included in an isosceles triangle truncated triangular trihedral corner reflector array. Generally, an isosceles triangle shaped truncating object in accordance with the invention can have any two congruent angles other than 45° and any non-congruent angle other than 90°. Various isosceles triangle truncated triangular trihedral corner reflectors can be produced by varying the angles of the corners of the isosceles triangle shaped truncating object and/or the truncation rotation angle of the isosceles triangle shaped truncating object relative to the triangular trihedral corner reflector 100 being truncated.

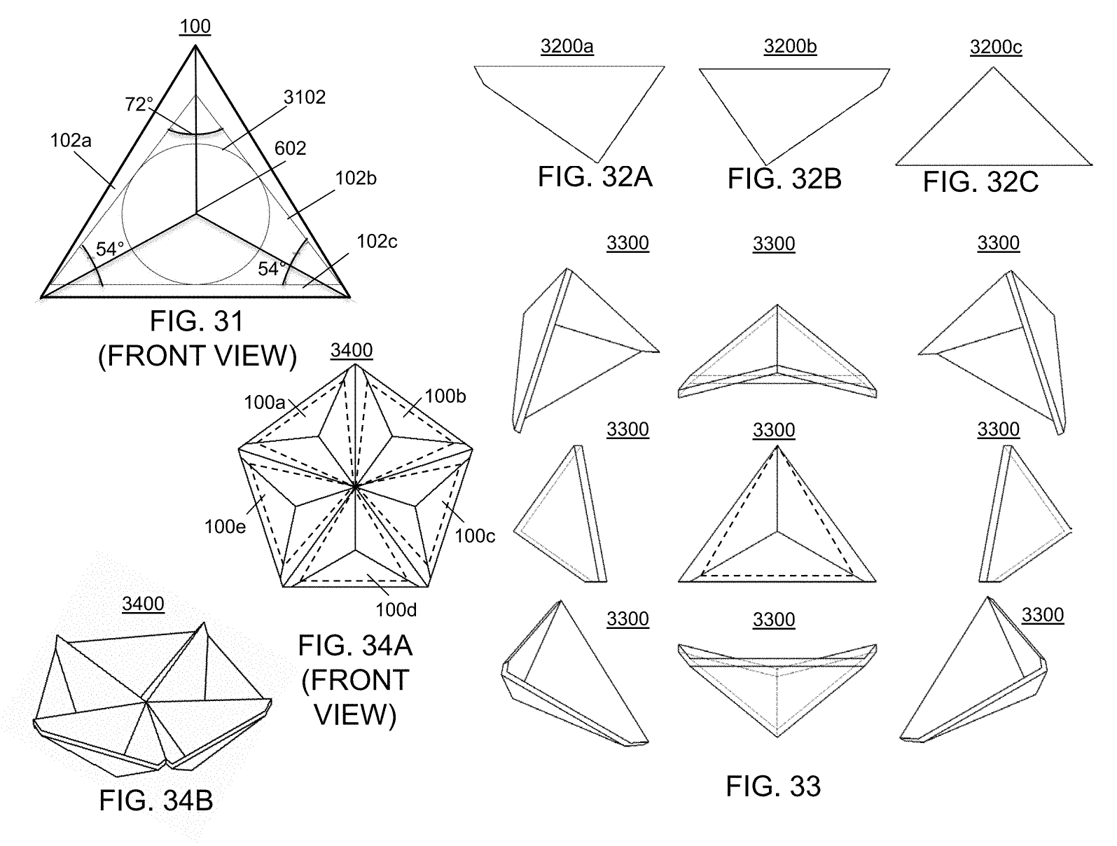

FIG. 31 depicts a front view of an exemplary vertical isosceles triangle truncation of a triangular trihedral corner reflector 100 using an isosceles triangle shaped truncating object 3102 having a 0° truncation rotation angle in accordance with the invention, where the center of the truncating isosceles triangle corresponds to the center of a circle sized to intersect the three sides of the truncating isosceles triangle at three points and a 72° non-congruent corner of the isosceles triangle shaped truncating object is aligned with one of the three outer corners of the triangular trihedral corner reflector 100. The angles of the isosceles triangle shaped truncating object were selected to produce five tileable isosceles triangle truncated triangular trihedral corner reflectors.

FIGS. 32A-32C depict exemplary faces 3200a-3200c produced by truncating the triangular trihedral corner reflector 100 using an isosceles triangle shaped truncating object having a 0° truncation rotation angle in accordance with the invention as shown in FIG. 31.

FIG. 33 depicts multiple views of an isosceles triangle truncated triangular trihedral corner reflector 3300 produced by truncating the triangular trihedral corner reflector 100 using an isosceles triangle shaped truncating object having a 0° truncation rotation angle in accordance with the invention. The centermost view includes dashed lines to indicate the lower retro-reflecting portion versus the upper scattering portion of the truncated corner reflector 3300.

FIGS. 34A and 34B depict front and oblique views of an exemplary array (or cell) 3400 of truncated corner reflectors 3400 in accordance with the invention. Referring to FIG. 34A, dashed lines indicate five triangular trihedral corner reflectors 100a-100e, which are the retro-reflecting portions of the array 3400. The portions of the array 3400 other than the five triangular trihedral corner reflectors 100a-100e are the scattering portions of the array 3400.

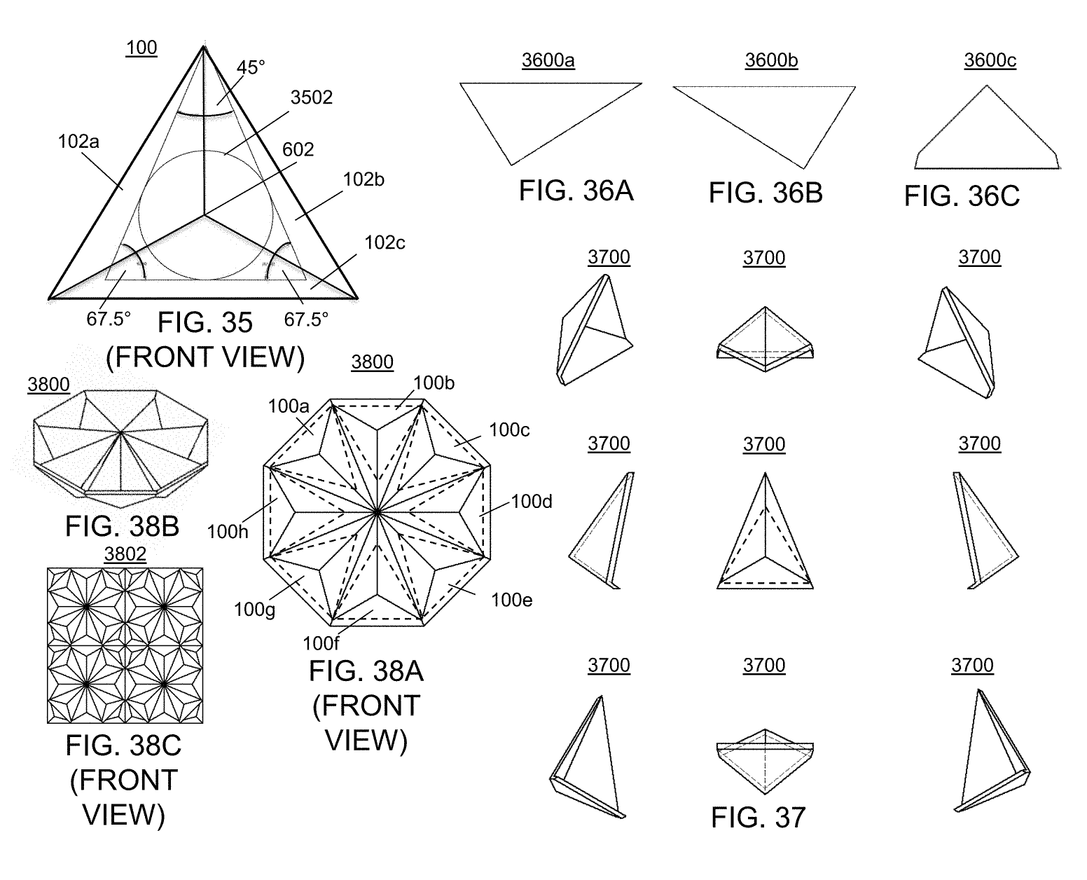

FIG. 35 depicts a front view of an exemplary vertical isosceles triangle truncation of a triangular trihedral corner reflector 100 using an isosceles triangle shaped truncating object 3502 having a 0° truncation rotation angle in accordance with the invention, where a 45° non-congruent corner of the isosceles triangle shaped truncating object is aligned 0° from one of the three outer corners of the triangular trihedral corner reflector 100. The angles of the isosceles triangle shaped truncating object were selected to produce eight tileable isosceles triangle truncated triangular trihedral corner reflectors.

FIGS. 36A-36C depict exemplary faces 3600a-3600c produced by truncating the triangular trihedral corner reflector 100 using an isosceles triangle shaped truncating object having a 0° truncation rotation angle in accordance with the invention as shown in FIG. 35.

FIG. 37 depicts multiple views of an isosceles triangle truncated triangular trihedral corner reflector 3700 produced by truncating the triangular trihedral corner reflector 100 using an isosceles triangle shaped truncating object having a 0° truncation rotation angle in accordance with the invention. The centermost view includes dashed lines to indicate the lower retro-reflecting portion versus the upper scattering portion of the isosceles triangle truncated triangular trihedral corner reflector 3700.

FIGS. 38A and 38B depict front and oblique views of an exemplary array (or cell) 3800 of truncated corner reflectors 3700 in accordance with the invention. Referring to FIG. 38A, dashed lines indicate eight triangular trihedral corner reflectors 100a-100h, which are the retro-reflecting portions of the array 3800. The portions of the array 3800 other than the eight triangular trihedral corner reflectors 100a-100h are the scattering portions of the array 3800.

FIG. 38C depicts a front view of an exemplary array 3802 produced by tiling two rows and two columns of the array 3800 of FIGS. 38A and 38B with filler structures added to the four corners of the arrays 3800 in order to fill the gaps between the arrays 3800.

Many different types of filler structures can be added to enable two non-tileable objects to be combined. Under one arrangement, a filler structure can be used that completely fills a region (i.e., an area or volume) between the two objects in three dimensions such that there is no gap between abutting edges of the objects and the filler structure. Under another arrangement, a filler structure can be used that partially fills a region between the two objects, for example, in two dimensions but not in three dimensions. Filler structures may be selected to take advantage of the shape of areas (or volumes) between two objects. For example, a triangular area may be filled with a trihedral corner reflector such as the right isosceles corner reflectors shown in the four corners of each cell of the array 3802 of FIG. 38C. Similarly, a hexagonal area may be filled with a hexagonal pyramid such as the right hexagonal pyramid 416 of FIG. 4X. Other exemplary filler structures may include a smooth flat surface, a textured flat surface, a rounded surface (i.e., convex or concave), or some other shaped surface, where any filler structure could be inverted. For certain situations, it may be desirable that a filling structure have a first side for abutting to a first object that is complementary to the first object and have a second side for abutting to a second object that is a complementary to the second object.

Two objects may tile completely or partially, where the use of filler structures between two objects is optional and gaps between two objects may be preferred.

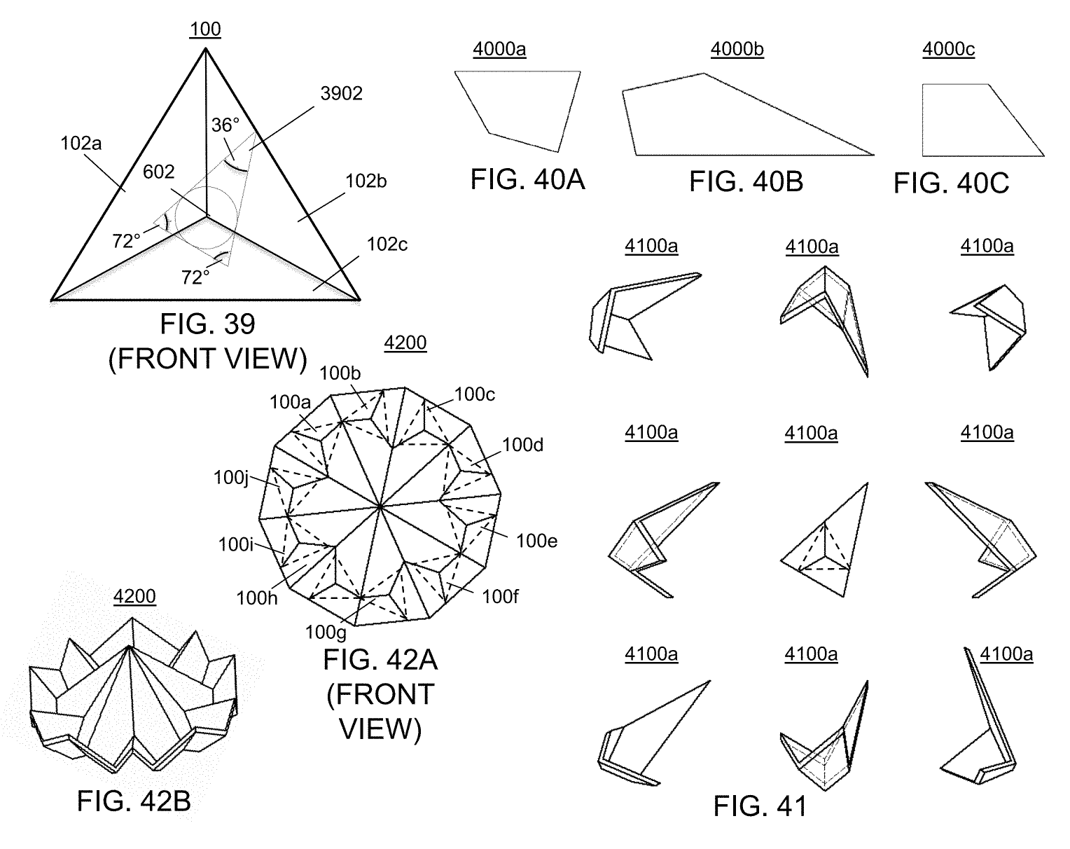

FIG. 39 depicts a front view of an exemplary vertical isosceles triangle truncation of a triangular trihedral corner reflector 100 using an isosceles triangle shaped truncating object 3902 having a 30° truncation rotation angle in accordance with the invention, where a 36° non-congruent corner of the isosceles triangle is aligned 30° from one of the three outer corners of the triangular trihedral corner reflector 100. The angles of the isosceles triangle shaped truncating object were selected to produce ten tileable isosceles triangle truncated triangular trihedral corner reflectors.

FIGS. 40A-40C depict exemplary faces 4000a-4000c produced by truncating the triangular trihedral corner reflector 100 using an isosceles triangle shaped truncating object having a 30° truncation rotation angle in accordance with the invention.

FIG. 41 depicts multiple views of an isosceles triangle truncated triangular trihedral corner reflector 4100a produced by truncating the triangular trihedral corner reflector 100 using an isosceles triangle shaped truncating object having a 30° truncation rotation angle in accordance with the invention. The centermost view includes dashed lines to indicate the lower retro-reflecting portion versus the upper scattering portion of the truncated corner reflector 4100a. A complementary (or mirror image) truncated corner reflector 4100b (not shown) can be produced using faces complementary to the faces 4000a-4000c of FIGS. 40A-40C (i.e., faces produced by truncating the triangular trihedral corner reflector 100 using an isosceles triangle shaped truncating object having a 90° truncation rotation angle in accordance with the invention).

FIGS. 42A and 42B depict front and oblique views of an exemplary array 4200 of truncated corner reflectors 4100a and 4100b in accordance with the invention. Referring to FIG. 42A, dashed lines indicate ten triangular trihedral corner reflectors 100a-100j, which are the retro-reflecting portions of the array 4200. The portions of the array 4200 other than the ten triangular trihedral corner reflectors 100a-100j are the scattering portions of the array 4200.

The exemplary arrays in FIGS. 34A, 38A, and 42A were constructed using a number of truncated corner reflectors selected such that the total of the non-congruent angles of the truncated corner reflectors adds up to 360°. Alternatively, arrays could be constructed using a number of truncated corner reflectors where the total of the non-congruent angles of the truncated corner reflectors is less than 360° such that the respective symmetry axes of the triangular trihedral corner reflectors 100 converge at some distance from an array. Or, arrays could be constructed using a number of isosceles triangle truncated triangular trihedral corner reflectors where the total of the non-congruent angles of the truncated corner reflectors is greater than 360° such that the respective symmetry axes of the triangular trihedral corner reflectors 100 diverge.

The non-congruent angles can be selected to be a divisor of 360°, where an array of triangle truncated triangular trihedral corner reflectors can be constructed such that the non-congruent angles of the truncated corner reflectors add up to 360° or the non-congruent angles can be selected to not be divisors of 360° such that an array of truncated corner reflectors cannot be constructed where the non-congruent angles of the truncated corner reflectors add up to 360°.

A mathematical model for centered isosceles triangle vertical truncations that is similar to the exemplary mathematical model 1700 for centered equilateral triangle vertical truncations described above can be used for calculating scaler lengths, areas, and volumes based on a truncation rotation angle θₘ in accordance with the invention.

In accordance with the invention, a triangular trihedral corner reflector 100 can be truncated using a rectangle to produce a rectangle truncated triangular trihedral corner reflector, which can be included in a rectangle truncated triangular trihedral corner reflector array. Generally, a rectangle shaped truncating object in accordance with the invention can have a length L and width W and a length to width ratio L/W. Various truncated corner reflectors can be produced by varying the length to width ratio and/or the truncation rotation angle of the rectangle shaped truncating object relative to the triangular trihedral corner reflector 100 being truncated.

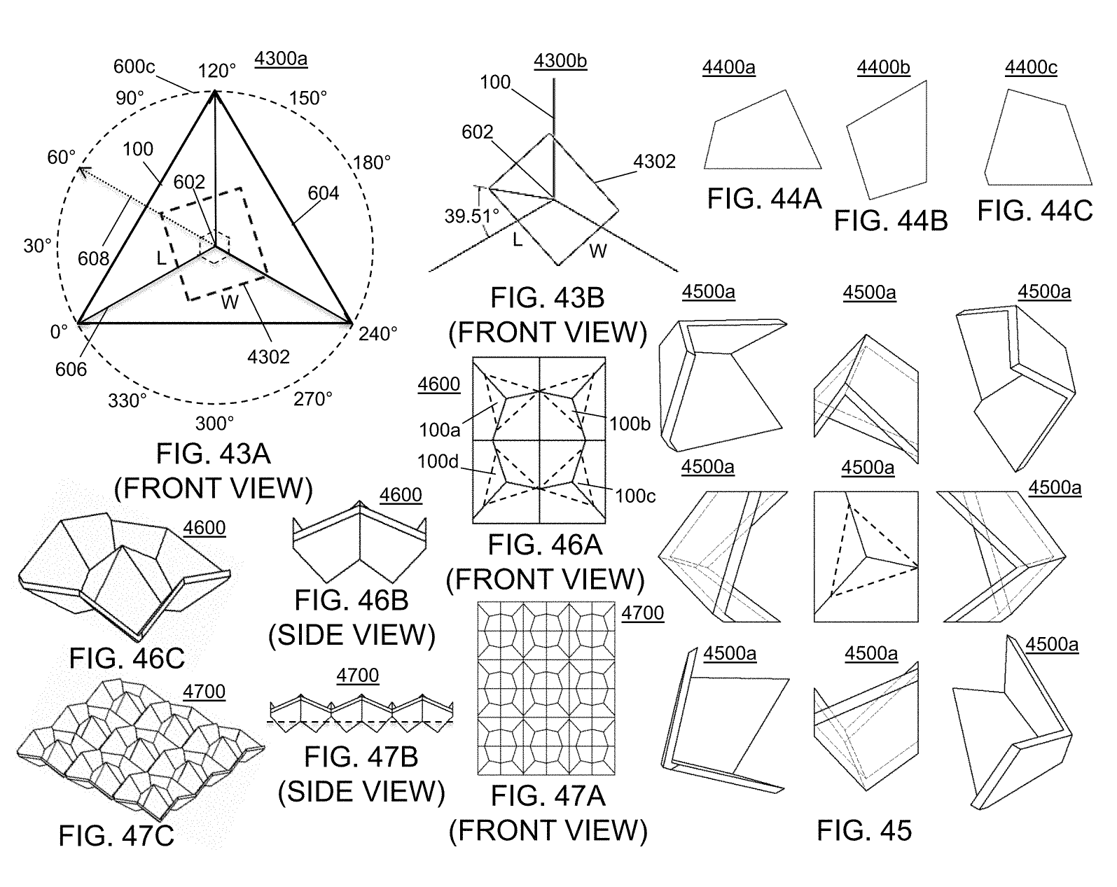

FIG. 43A depicts the exemplary trihedral corner 604 and exemplary rotational plane 600c of FIG. 6C except the exemplary truncating equilateral triangle 402 is replaced by an exemplary truncating rectangle 4302. Referring to FIG. 43A, a truncating rectangle 4302 is shown having a 60° truncation rotation 608 relative to the reference 0° rotation 606.

FIG. 43B depicts a front view of an exemplary vertical rectangle truncation of a triangular trihedral corner reflector 100 using an rectangle shaped truncating object 4302 having a 39.51° truncation rotation angle in accordance with the invention, where the rectangle shaped truncating object 4302 had a L/W ratio of approximately 1.26.

FIGS. 44A-44C depict exemplary faces 4400a-4400c produced by truncating the triangular trihedral corner reflector 100 using an rectangle shaped truncating object having a 39.51° truncation rotation angle and L/W ratio of approximately 1.26 in accordance with the invention.

FIG. 45 depicts multiple views of a rectangle truncated triangular trihedral corner reflector 4500a produced by truncating the triangular trihedral corner reflector 100 using a rectangle shaped truncating object having a 39.51° truncation rotation angle and L/W ratio of approximately 1.26 in accordance with the invention. The centermost view includes dashed lines to indicate the lower retro-reflecting portion versus the upper scattering portion of the truncated corner reflector 4500a. A complementary (or mirror image) truncated corner reflector 4500b (not shown) can be produced using faces complementary to the faces 4400a-4400c of FIGS. 44A-44C (i.e., faces produced by truncating the triangular trihedral corner reflector 100 using an isosceles triangle shaped truncating object having a 80.49° truncation rotation angle in accordance with the invention).

FIGS. 46A-46C depict front, side and oblique views of an exemplary array 4600 of truncated corner reflectors 4500a and 4500b in accordance with the invention. Referring to FIG. 46A, dashed lines indicate four triangular trihedral corner reflectors 100a-100d, which are the retro-reflecting portions of the array 4600. The portions of the array 4600 other than the four triangular trihedral corner reflectors 100a-100d are the scattering portions of the array 4600.

FIGS. 47A-47C depict front, side, and oblique views of an exemplary array 4700 comprising nine arrays 4600 of FIGS. 46A-46C.

In accordance with the invention, a vertical truncation of a triangular trihedral corner reflector 100 can be an offset truncation, where the center of the truncating object (i.e., an equilateral triangle shape truncating object, an isosceles right triangle truncating object, or an isosceles triangle truncating object) is offset from a point above the center point 106 of the triangular trihedral corner reflector 100 being truncated, where the extent to which the truncating object can be offset from a point above the center point 106 must be constrained such that the corresponding truncated corner reflector includes a portion that is a triangular trihedral corner reflector.

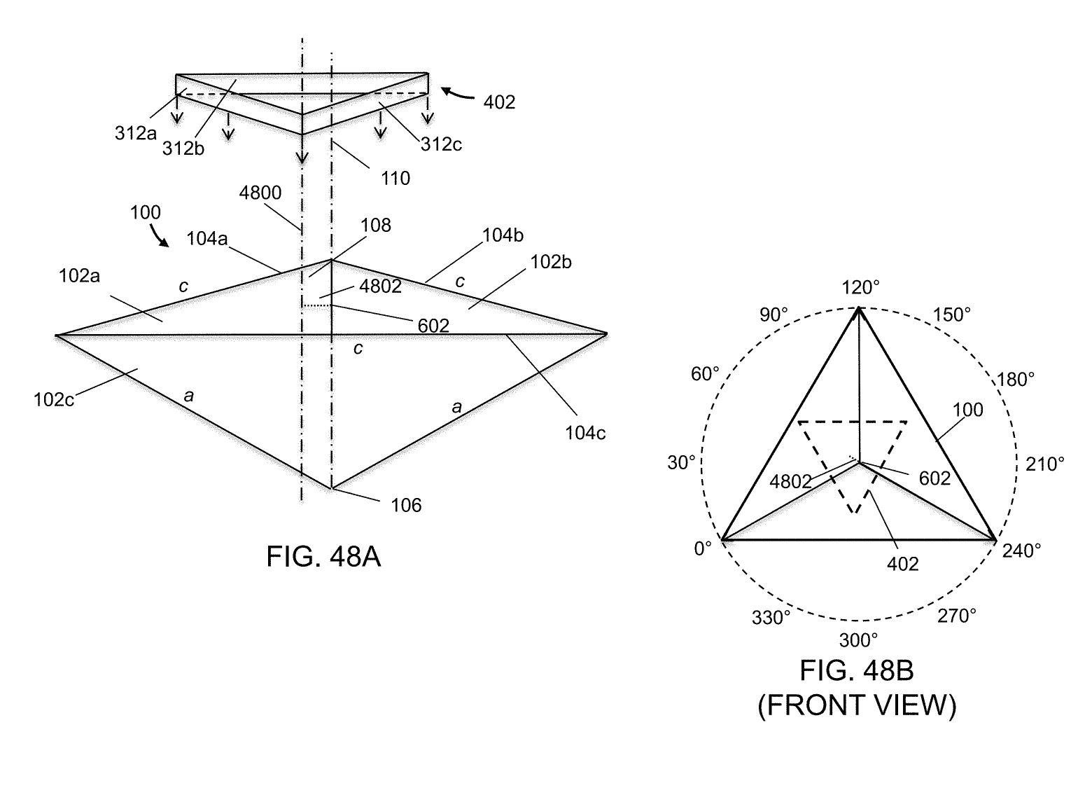

FIGS. 48A and 48B depict oblique and front views of exemplary offset equilateral triangle truncation of a triangular trihedral corner reflector 100 where the truncating equilateral triangle 402 is not centered on the symmetry axis and is instead centered on a vertical offset axis 4800 that is parallel to but offset from the symmetry axis by an offset 4802.

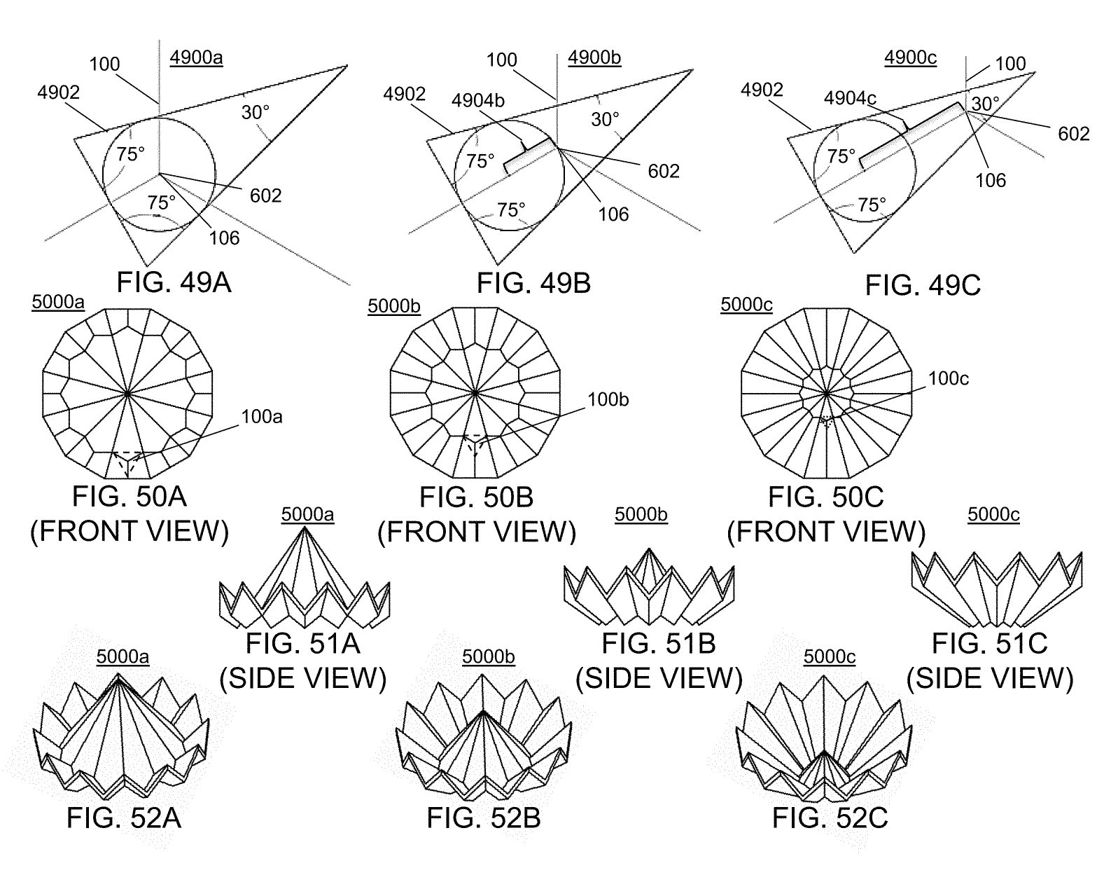

FIGS. 49A-49C depict exemplary centered versus offset isosceles triangle truncation scenarios 4900a-4900c using isosceles triangle shaped truncating objects 4902 having a 60° truncation rotation angle in accordance with the invention, where a 30° non-congruent corner of the isosceles triangle shaped truncating objects 4902 is aligned 60° from one of the three outer corners of the triangular trihedral corner reflector 100. Referring to FIG. 49A, the center of the isosceles triangle shaped truncating object 4902 and the rotation point 602 are centered above the center point 106 of the triangular trihedral corner reflector 100. Referring to FIGS. 49B and 49C, the center of the isosceles triangle shaped truncating object 4902 is shown having first and second offsets 4904b and 4904c, respectively, from the rotation point 602, which is centered over the center point 106 of the triangular trihedral corner reflector 100.

FIGS. 50A-52C depict front, side, and oblique views of exemplary isosceles triangle truncated triangular trihedral corner reflector arrays 5000a-5000c produced in accordance with the three isosceles triangle truncation scenarios 4900a-4900c of FIGS. 49A-49C. Referring to FIGS. 50A-52C, examples of the remaining triangular trihedral corner reflectors 100a-100c of the arrays 5000a-5000c are indicated using dashed lines, where it can be seen that using an offset causes the retro-reflecting portions 100a-100c to change in size and to move in location relative to the centers of the arrays 5000a-5000c and also causes the proportions of the scattering portions to change.

A mathematical model for offset vertical truncations using a given truncating object (i.e., an equilateral triangle shape truncating object, an isosceles right triangle truncating object, or an isosceles triangle truncating object) that is similar to the exemplary mathematical model 1700 for centered equilateral triangle vertical truncations described above can be used for calculating scaler lengths, areas, and volumes based on a truncation rotation angle θ_{TR} and an offset in accordance with the invention.

In accordance with an aspect of the invention, non-vertical truncation of a triangular trihedral corner reflector 100 can be performed using a truncating object (i.e., an equilateral triangle shape truncating object, an isosceles right triangle truncating object, or an isosceles triangle truncating object) to produce a truncated triangular trihedral corner reflector, where truncation is centered on a non-vertical axis that is not parallel to the symmetry axis, where the non-vertical axis may or may not be offset.

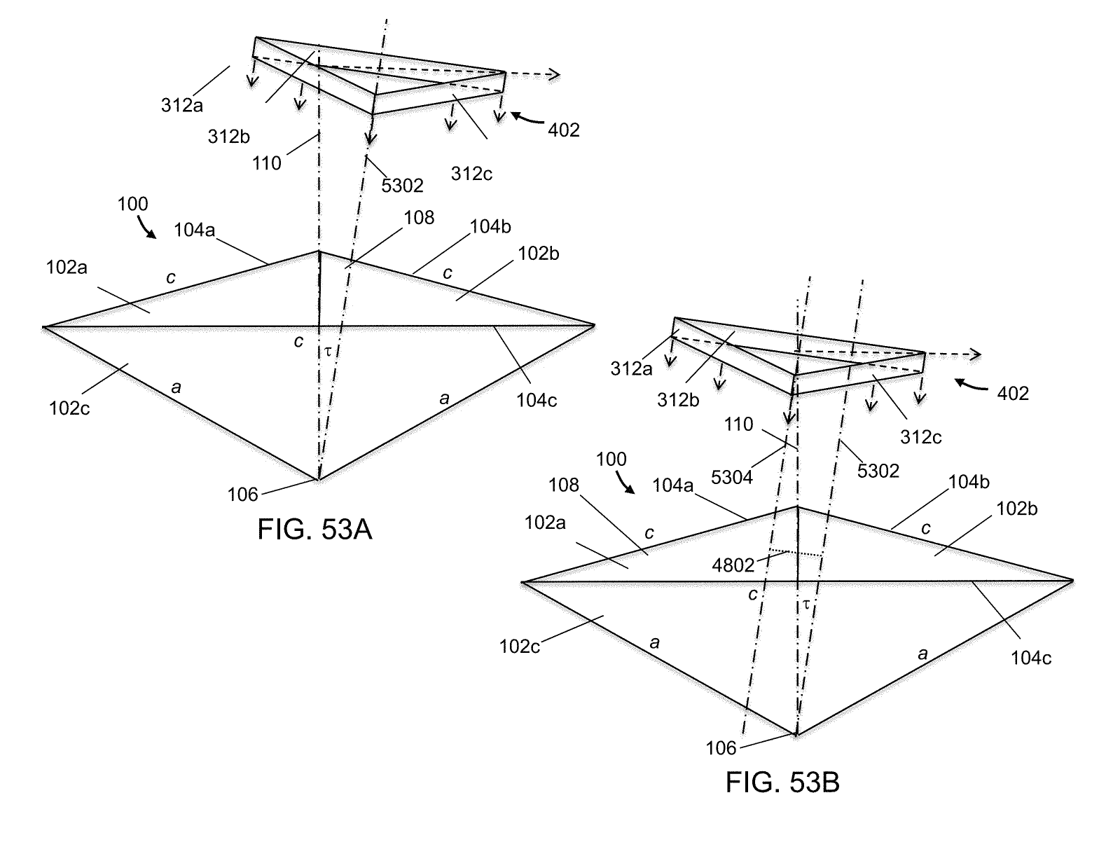

FIG. 53A depicts an oblique view of an exemplary non-vertical truncation of a triangular trihedral corner reflector 100 by a truncating equilateral triangle 402, where truncation is along a non-vertical axis 5302 that is not parallel to the symmetry axis 110 and where the non-vertical axis 5302 and the symmetry axis 110 meet at the center point 106 of the triangular trihedral corner reflector 100. An angle τ between the non-vertical axis 5302 and the symmetry axis 110 can be referred to as the non-vertical axis rotation angle, where the non-vertical axis 5302 passes through a line corresponding to the truncation rotation angle, where the angle τ between the non-vertical axis 5302 and the symmetry axis 110 must be constrained such that, after truncation, the equilateral triangle truncated triangular trihedral corner reflector will include a triangular trihedral corner reflector portion.

FIG. 53B depicts an oblique view of an exemplary offset non-vertical truncation of a triangular trihedral corner reflector 100 by a truncating equilateral triangle 402, where truncation is along an offset non-vertical axis 5304 that is not parallel to the symmetry axis 110 and where the offset non-vertical axis 5304 is offset from a non-vertical axis 5302 by an offset 4802, where both the offset 4802 and the angle τ between the non-vertical axis 5302 and the symmetry axis 110 must be constrained such that, after truncation, the equilateral triangle truncated triangular trihedral corner reflector will include a triangular trihedral corner reflector portion.

FIG. 54 depicts an exemplary non-vertical equilateral triangle truncation of a triangular trihedral corner reflector 100 using an equilateral triangle shaped truncating object 402 having a 30° truncation rotation angle and a 12.44° non-vertical axis rotation angle τ in accordance with the invention. Referring to FIG. 54, the non-vertical axis 5302 and the symmetry axis 110 converge at the center point 106 of the triangular trihedral corner reflector 100. The equilateral triangle shaped truncating object 402 is shown being in a plane 5404 that corresponds to a line between the non-vertical axis 5302 and the symmetry axis 110 that passes through the center of the equilateral triangle shaped truncating object 402 and indicates the truncation rotation angle.

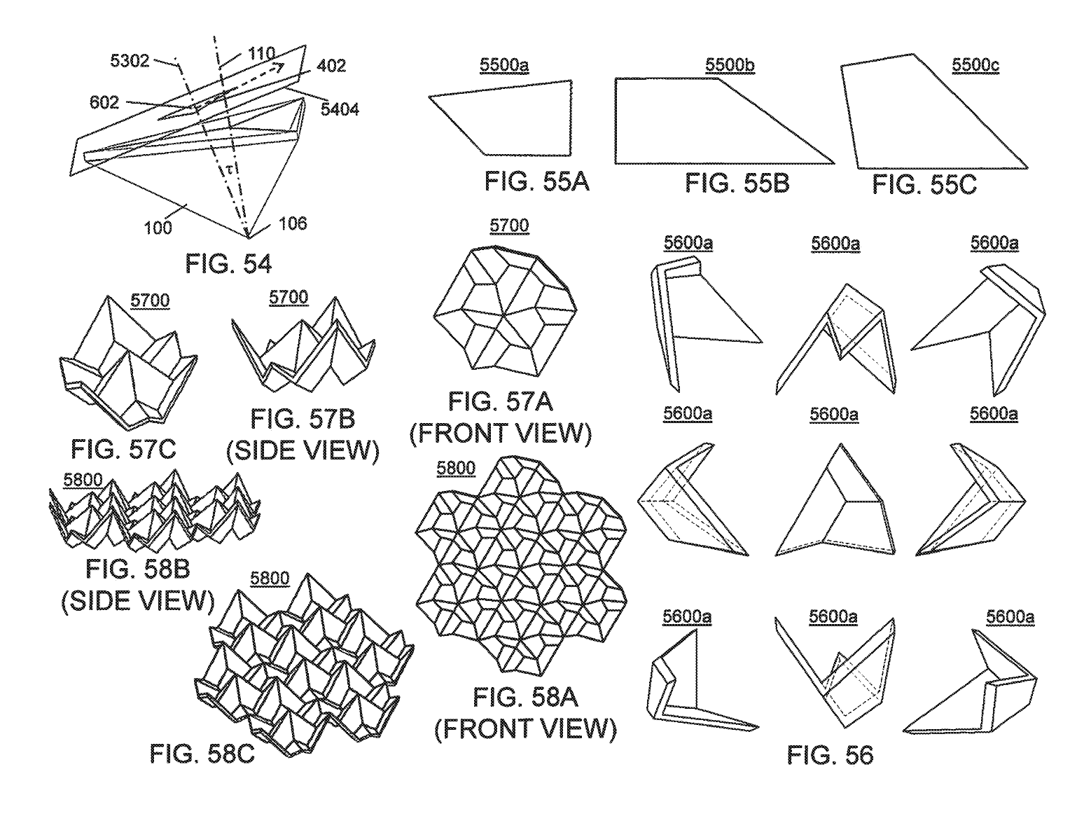

FIGS. 55A-55C depict exemplary faces 5500a-5500c produced by truncating the triangular trihedral corner reflector 100 using an equilateral triangle shaped truncating object having a 30° truncation rotation angle and a 12.44° non-vertical axis rotation angle in accordance with the invention.

FIG. 56 depicts multiple views of an equilateral triangle truncated triangular trihedral corner reflector 5600a produced by truncating the triangular trihedral corner reflector 100 using an equilateral triangle shaped truncating object having a 30° truncation rotation angle and a 12.44° non-vertical axis rotation angle in accordance with the invention. A complementary (or mirror image) equilateral triangle truncated triangular trihedral corner reflector 5600b (not shown) can be produced using faces complementary to the faces 5500a-5500c of FIGS. 55A-55C.

FIGS. 57A-57C depict front, side and oblique views of an exemplary array 5700 of equilateral triangle truncated triangular trihedral corner reflectors 5600a and 5600b in accordance with the invention.

FIGS. 58A-58C depict front, side, and oblique views of an exemplary array 5800 comprising seven arrays 5700 of FIGS. 57A-57C.

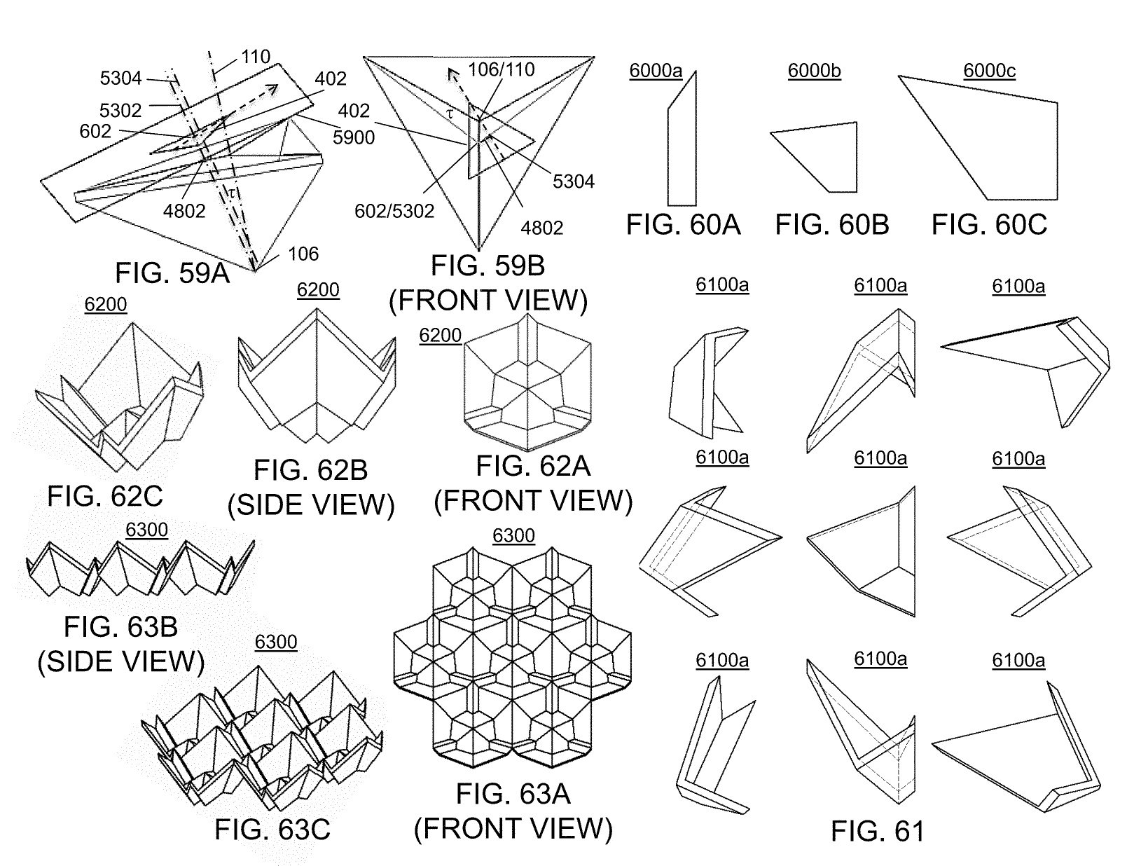

FIGS. 59A and 59B depict an oblique and front view of an exemplary offset non-vertical equilateral triangle truncation of a triangular trihedral corner reflector 100 using an equilateral triangle shaped truncating object 402 having a 30° truncation rotation angle, a 12.44° non-vertical axis rotation angle τ, and an offset 4802 in accordance with the invention. Referring to FIG. 59A, the non-vertical axis 5302 and the symmetry axis 110 converge at the center point 106 of the triangular trihedral corner reflector 100. The equilateral triangle shaped truncating object 402 is shown being in a plane 5900 that corresponds to a line between a non-vertical axis 5302 and the symmetry axis 110 that passes through the center of the equilateral triangle shaped truncating object 402 and indicates the truncation rotation angle. Truncation is along an offset axis 5304 that is offset from the non-vertical axis 5302 by the offset 4802.

FIGS. 60A-60C depict exemplary faces 6000a-6000c produced by truncating the triangular trihedral corner reflector 100 using an equilateral triangle shaped truncating object having a 30° truncation rotation angle, a 12.44° non-vertical axis rotation angle and an offset 4802 in accordance with the invention.

FIG. 61 depicts multiple views of an equilateral triangle truncated triangular trihedral corner reflector 6100a produced by truncating the triangular trihedral corner reflector 100 using an equilateral triangle shaped truncating object having a 30° truncation rotation angle, a 12.44° non-vertical axis rotation angle and an offset 4802 in accordance with the invention. A complementary (or mirror image) equilateral triangle truncated triangular trihedral corner reflector 6100b (not shown) can be produced using faces complementary to the faces 6000a-6000c of FIGS. 60A-60C.

FIGS. 62A-62C depict front, side and oblique views of an exemplary array 6200 of equilateral triangle truncated triangular trihedral corner reflectors 6100a and 6100b in accordance with the invention.

FIGS. 63A-63C depict front, side, and oblique views of an exemplary array 6300 comprising seven arrays 6200 of FIGS. 62A-62C.

The exemplary truncated triangular trihedral corner reflectors and corresponding arrays described in relation to FIGS. 54-63C were based on use of an equilateral triangle shaped truncation object and, if an isosceles triangle shaped truncation object had instead been used, the non-congruent angle of the isosceles triangle shaped truncation object can be selected such that the total of the non-congruent angles of the resulting isosceles triangle truncated triangular trihedral corner reflectors can or cannot add up to 360°.

Mathematical models for offset or non-offset non-vertical truncations using a given truncating object (i.e., an equilateral triangle shape truncating object, an isosceles right triangle truncating object, or an isosceles triangle truncating object) that are similar to the exemplary mathematical model 1700 for centered equilateral triangle vertical truncations described above can be used for calculating scaler lengths, areas, and volumes based on a truncation rotation angle θ_{TR}, a non-vertical axis rotation angle τ and an optional offset 4802 in accordance with the invention.

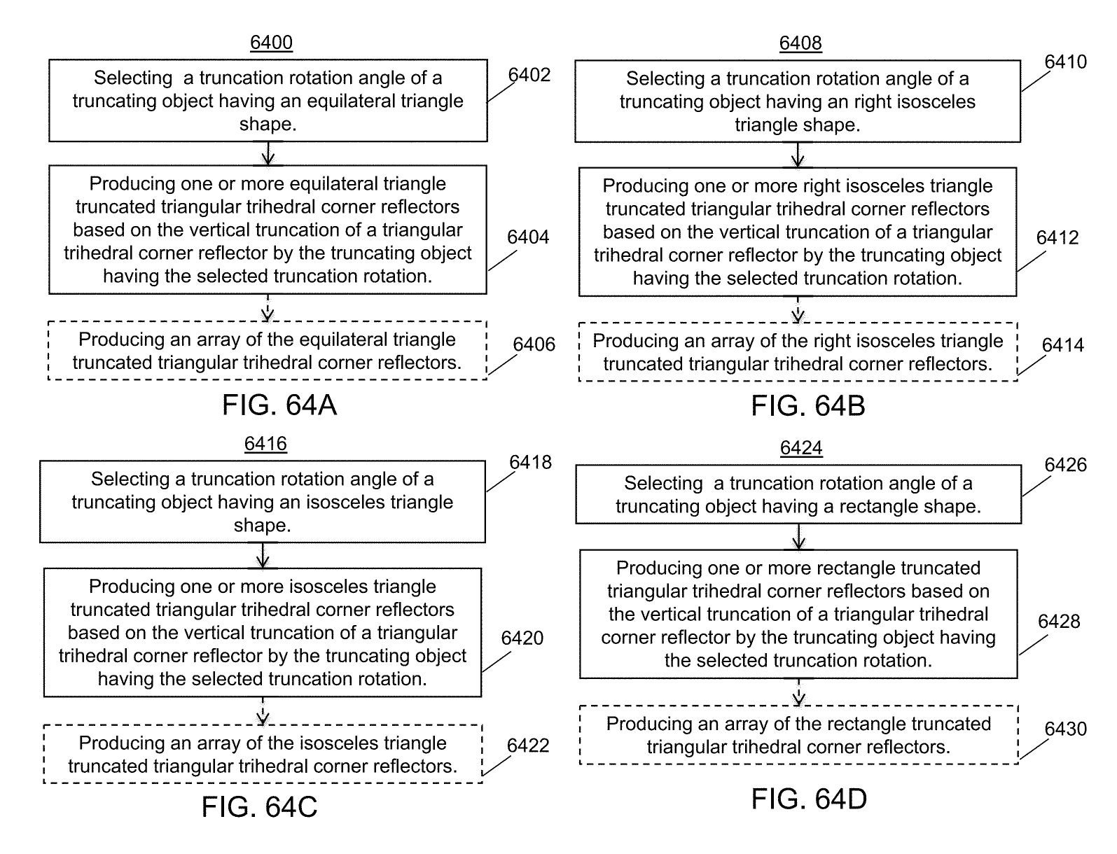

FIG. 64A depicts an exemplary method 6400 for equilateral triangle truncation of a triangular trihedral corner reflector in accordance with the invention. Referring to FIG. 64A, the method 6400 includes a first step 6402 of selecting a truncation rotation angle of a truncating object having an equilateral triangle shape and a second step 6404 of producing one or more equilateral triangle truncated triangular trihedral corner reflectors based on the vertical truncation of a triangular trihedral corner reflector by the truncating object having the selected truncation rotation. The method 6400 may also include an optional third step 6406 of producing an array of the equilateral triangle truncated triangular trihedral corner reflectors.

FIG. 64B depicts an exemplary method 6408 for right isosceles triangle truncation of a triangular trihedral corner reflector in accordance with the invention. Referring to FIG. 64B, the method 6408 includes a first step 6410 of selecting a truncation rotation angle of a truncating object having an right isosceles triangle shape and a second step 6412 of producing one or more right isosceles triangle truncated triangular trihedral corner reflectors based on the vertical truncation of a triangular trihedral corner reflector by the truncating object having the selected truncation rotation. The method 6408 may also include an optional third step 6414 of producing an array of the right isosceles triangle truncated triangular trihedral corner reflectors.

FIG. 64C depicts an exemplary method 6416 for right triangle truncation of a triangular trihedral corner reflector in accordance with the invention. Referring to FIG. 64C, the method 6416 includes a first step 6418 of selecting a truncation rotation angle of a truncating object having a right triangle shape and a second step 6420 of producing one or more right triangle truncated triangular trihedral corner reflectors based on the vertical truncation of a triangular trihedral corner reflector by the truncating object having the selected truncation rotation. The method 6416 may also include an optional third step 6422 of producing an array of the right triangle truncated triangular trihedral corner reflectors.

FIG. 64C depicts an exemplary method 6416 for isosceles triangle truncation of a triangular trihedral corner reflector in accordance with the invention. Referring to FIG. 64C, the method 6416 includes a first step 6418 of selecting a truncation rotation angle of a truncating object having an isosceles triangle shape and a second step 6420 of producing one or more isosceles triangle truncated triangular trihedral corner reflectors based on the vertical truncation of a triangular trihedral corner reflector by the truncating object having the selected truncation rotation. The method 6416 may also include an optional third step 6422 of producing an array of the isosceles triangle truncated triangular trihedral corner reflectors.

FIG. 64D depicts an exemplary method 6424 for rectangle truncation of a triangular trihedral corner reflector in accordance with the invention. Referring to FIG. 64D, the method 6424 includes a first step 6426 of selecting a truncation rotation angle of a truncating object having an rectangle shape and a second step 6428 of producing one or more rectangle truncated triangular trihedral corner reflectors based on the vertical truncation of a triangular trihedral corner reflector by the truncating object having the selected truncation rotation. The method 6424 may also include an optional third step 6430 of producing an array of the rectangle truncated triangular trihedral corner

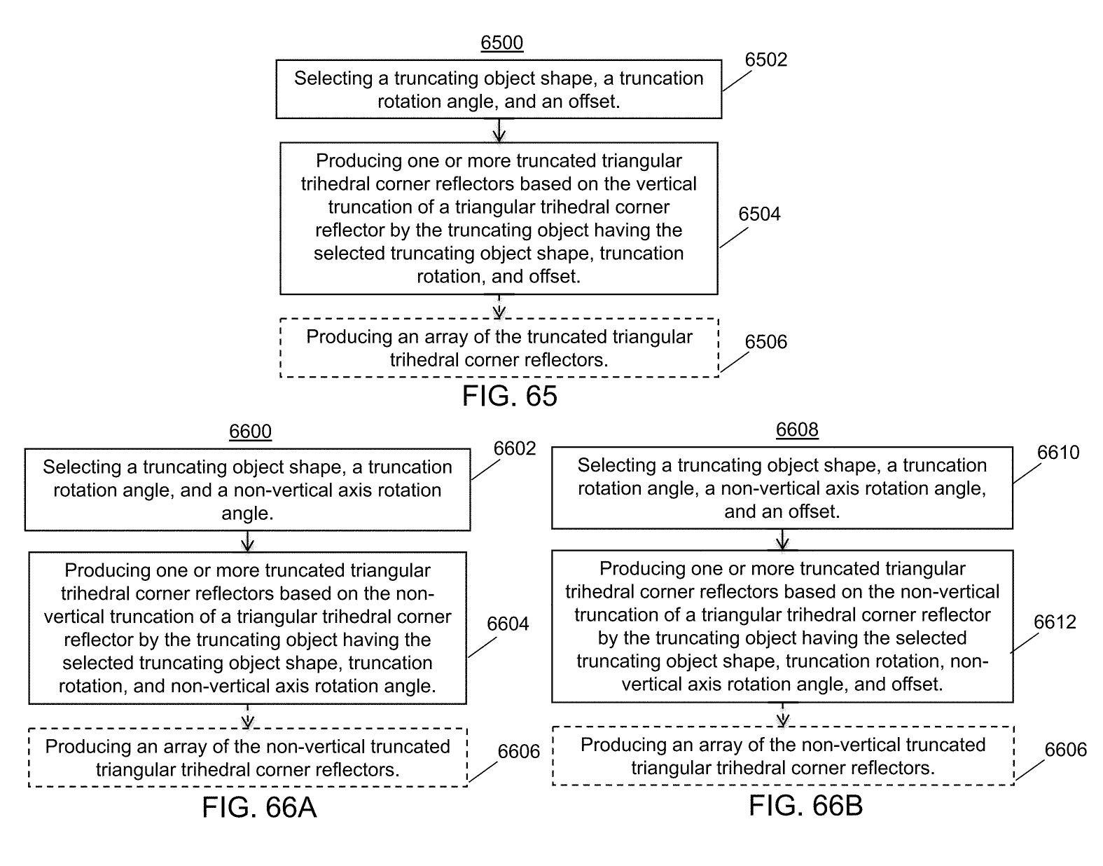

FIG. 65 depicts an exemplary method 6500 for vertical truncation of a triangular trihedral corner reflector using an offset in accordance with the invention. Referring to FIG. 65, the method 6500 includes a first step 6502 of selecting a truncating object shape, a truncation rotation angle, and an offset and a second step 6504 of producing one or more truncated triangular trihedral corner reflectors based on the vertical truncation of a triangular trihedral corner reflector by the truncating object having the selected truncating object shape, truncation rotation, and offset. The method 6500 may also include an optional third step 6506 of producing an array of the truncated triangular trihedral corner reflectors.

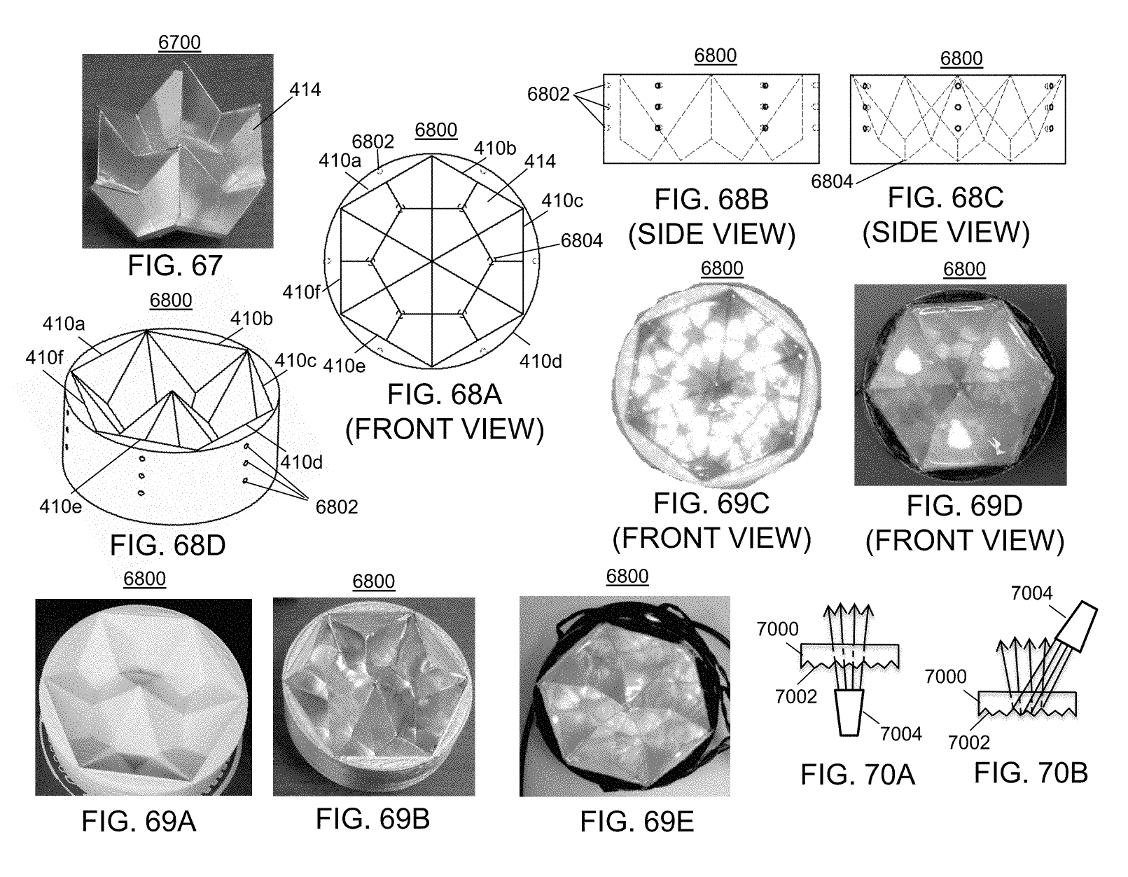

FIG. 66A depicts an exemplary method 6600 for non-vertical truncation of a triangular trihedral corner reflector in accordance with the invention. Referring to FIG. 66A, the method 6600 includes a first step 6602 of selecting a truncating object shape, a truncation rotation angle, and a non-vertical axis rotation angle and a second step 6604 of producing one or more truncated triangular trihedral corner reflectors based on the non-vertical truncation of a triangular trihedral corner reflector by the truncating object having the selected truncating object shape, truncation rotation, and non-vertical axis rotation angle. The method 6600 may also include an optional third step 6606 of producing an array of the non-vertical truncated triangular trihedral corner reflectors.

FIG. 66B depicts an exemplary method 6608 for non-vertical truncation of a triangular trihedral corner reflector in accordance with the invention. Referring to FIG. 66B, the method 6608 includes a first step 6610 of selecting a truncating object shape, a truncation rotation angle, a non-vertical axis rotation angle, and an offset and a second step 6612 of producing one or more truncated triangular trihedral corner reflectors based on the non-vertical truncation of a triangular trihedral corner reflector by the truncating object having the selected truncating object shape, truncation rotation, non-vertical axis rotation angle, and offset. The method 6608 may also include an optional third step 6606 of producing an array of the non-vertical truncated triangular trihedral corner reflectors.

In accordance with an aspect of the invention, a truncated trihedral corner reflector or a truncated trihedral corner reflector array can be manufactured from various materials including metal (e.g., steel, aluminum, tin, gold, silver, etc.), glass, plastic, rubber, foam, wood, cardboard, etc. in various well known ways including 3D printing, using a mold, machining, glass cutting, chemical vapor deposition, laser etching, metal stamping, and the like. Under one arrangement, it may be desirable that the surfaces of the truncated trihedral corner reflector or of the truncated trihedral corner reflector array be substantially smooth (e.g., like a mirror surface), while in other arrangements it may be desirable that the surfaces be less than smooth (e.g., like a 3D printed surface). It may even be desirable that some of the surfaces are smooth while others are less than smooth. For example, the retro-reflecting portions of a truncated trihedral corner reflector array may be smooth while the scattering portions of the array may be less than smooth, or vice versa. A given surface can be painted with different types (e.g., satin versus gloss) or colors (e.g., gray-scaled) of paint or otherwise coated with various types of materials having different reflective characteristics (e.g., magnesium oxide, Spectralon®).

FIG. 67 depicts a photo of an exemplary fixture 6700 consisting of an array 414 of six of the first equilateral triangle truncated triangular trihedral corner reflectors 406a-406e constructed by cutting six corners off of plastic BallCube® memorabilia display cases that were each disassembled into three pieces, which were manually crafted into approximations of the right kite-shaped face 404 depicted in FIG. 4E and reassembled to become the array 414 six first equilateral triangle truncated triangular trihedral corner reflectors 406a-406e. Polyken® foil tape was then applied to the top surfaces of each of the faces 404 of the array 414.

FIGS. 68A-68D depict front, side, side, and oblique views of an exemplary fixture 6800 having a surface corresponding to the exemplary array 414 of FIG. 4W in accordance with the invention. Referring to FIGS. 68A-68D, the fixture 6800 consists of an array 414 about which six triangular faces 410a-410f have been added, where the fixture has been configured to have a round outer surface, a flat top surface with a hexagon shaped opening, and a flat bottom surface. Side pilot holes 6802 are shown on the round outer surface that can be drilled to provide openings for optional light emitting diodes (not shown) for directing light into the array 414 from the sides of the fixture 6800. Similarly, bottom pilot holes 6804 are shown located at the center points of each of the six trihedral corner reflector arrays corresponding to the retro-reflecting portions of the array 414 that can be drilled to provide openings for optional light emitting diodes (not shown) for directing light into the array 414 from the bottoms of the retro-reflecting portions of the fixture 6800.

In accordance with the invention, a truncated triangular trihedral corner reflector or a truncated triangular trihedral corner reflector array may have metal faces and be filled with a dielectric material (e.g., plastic). If filled with a dielectric material, then one or more of the metal faces of a truncated triangular trihedral corner reflector may be dispensed where a corresponding device made of a dielectric material (e.g., plastic) can be used for certain applications where total internal reflection (TIR) can be relied upon.

In accordance with the invention, a truncated triangular trihedral corner reflector or a truncated triangular trihedral corner reflector array having metal faces may include an antenna, where the truncated triangular trihedral corner reflector or the truncated triangular trihedral corner reflector array may or may not be filled with a dielectric material.

FIGS. 69A-69E depict photos of various views of the exemplary fixture 6800 of FIGS. 68A-68D. Referring to FIG. 69A, the fixture 6800 is shown shortly after being 3D printed using a white filament. Referring to FIG. 69B, the fixture is shown after being painted with a silver metallic paint and after Polyken® foil tape has been applied to the top surfaces of each of the faces 404 of the array 414 as with the fixture 6700 of FIG. 67. Referring to FIG. 69C, the fixture 6800 is shown after being filled with Alumilite® Amazing Clearcast resin dielectric material. Instead of being filled with a dielectric material such as the resin shown in FIG. 69C, a fixture 6800 could have a cover such as a glass or plastic cover. The bright light reflecting from the six retro-reflecting portions of the array 414 corresponds to the flash of a cell phone, where the photo was taken approximately four feet above the fixture in dark room. Referring to FIG. 69D, the fixture 6800 is shown with the outer portions painted black, where light emitting diodes (LEDs) are shown shining upward from the bottoms of three of the retro-reflecting portions of the array 414. Referring to FIG. 69E, another fixture 6800 is shown that is configured the same as the fixture 6800 of FIG. 69D except LEDs are shown shining inward from the sides of three of the retro-reflecting portions of the array 414. Alternatively, a fixture 6800 could be configured to have LEDs in both the bottom and sides of the fixture. Moreover, the LEDs within a fixture 6800 can be controlled such that they light up at different times, they flash or stay on for a period of time, they have colors that vary, etc., which can be controlled based on music or otherwise triggered by an event, e.g., an emergency event, a detected motion, a detected darkness, etc.

Under one arrangement, an array of truncated trihedral corner reflectors in accordance with the invention, for example, the array 412 of FIG. 4Q, can be used to produce its complement. In one arrangement, an array of truncated trihedral corner reflectors is used as a mold, where the array is filled with a dielectric material that can be removed from the mold such that the dielectric material has one surface corresponding to the complement of the geometry of the array and an opposite surface that is flat. In another arrangement, a piece of material is modified using machining or some other method such that the material will have one side having a geometry that is complementary to the array and one side that is flat. The material may be a dielectric material such as acrylic, where a dielectric-air boundary reflects energy based on total internal reflection (TIR). Examples of plastic reflective devices configured to have a first surface that is flat and having a second surface opposite the first surface that has a geometry that includes trihedral corner reflectors, where TIR is relied upon, include road reflectors, trailer reflectors, bicycle reflectors and the like. If TIR cannot be relied upon, a reflective layer (e.g., a reflective metallic paint) can be applied to the surface having the geometry that corresponds to trihedral corner reflectors.

FIG. 70A depicts a reflective device 7000 that is a solid piece of plastic (e.g., acrylic) having a flat surface on a top side and a geometry corresponding to a truncated trihedral corner reflector array 7002 in accordance with the invention on a bottom side opposite the top side, and a light source 7004 beneath (or behind) the reflecting device 7000 shining light through the array 7000. FIG. 70B depicts the reflective device 7000 of FIG. 70A with the light source 7004 illuminating the reflective device 7000 from its top side, where the light is shown reflecting off the bottom surface due to TIR and leaving the top side of the reflective device 7000.

In accordance with an aspect of the invention, a truncated trihedral corner reflector array may be modified in various ways. For example, it may be desirable to round off the top of the scattering portions to remove sharp edges so as to avoid injuries, where in one arrangement the top of a scattering portion could be made into a hemisphere or in another arrangement a top part of a scattering portion is removed such that the scattering portion has a flat top. Generally, a scattering portion may be modified to transition from having a first cross-section (e.g., a hexagonal cross section) to having a second cross section (e.g., a round cross section, some other shaped cross-section, or no cross-section). Similarly, it may be desirable to round off the bottom portion of the retro-reflecting portions, where a retro-reflecting portion may be modified to transition from having a first cross-section to having a second cross section. Surfaces of scattering portions or retro-reflecting portions could have ‘features’ added such as triangular pyramids, half-spheres, hexagonal pyramids and combinations of such features. Such additional features may have designed geometries or be random geometry surfaces.

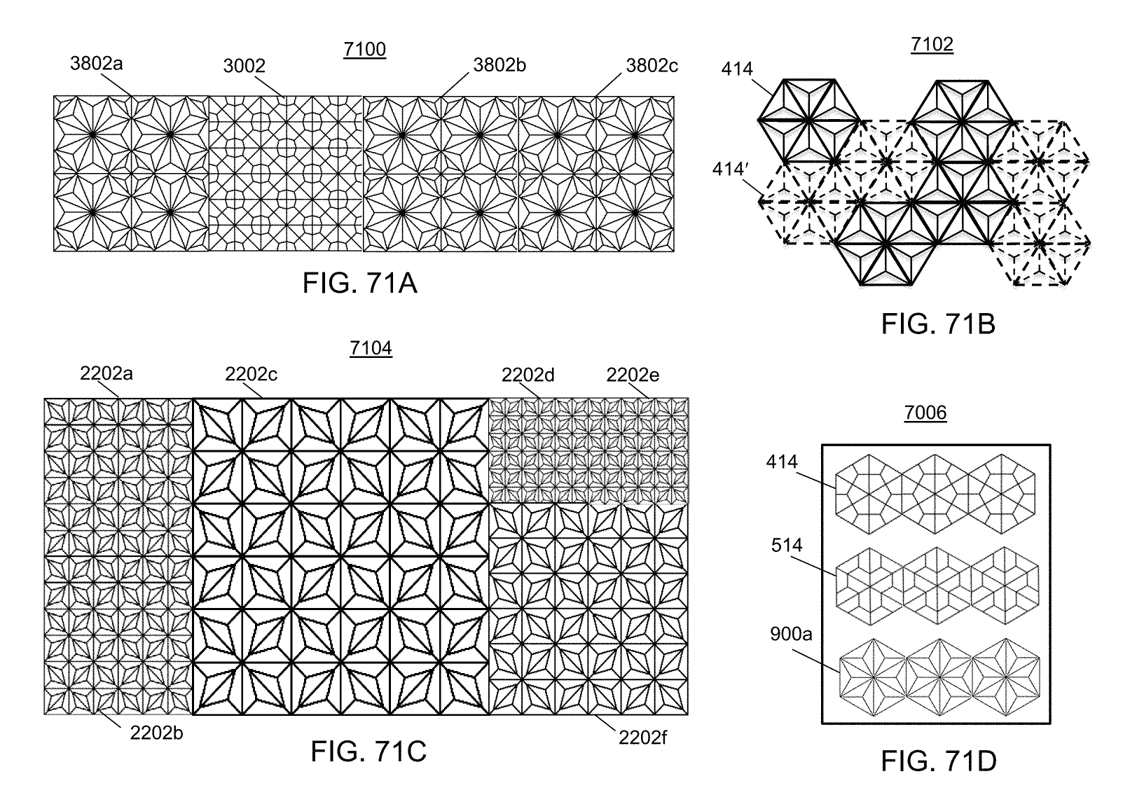

In accordance with an aspect of the invention, truncated trihedral corner reflector arrays can be combined in various ways. For example, arrays having different retro-reflecting portions to scattering portions ratios may be combined to convey information. FIG. 71A depicts a large array 7100 comprising four arrays 3802a, 3002, 3802b, and 3802c, where a light sensing device scanning from left to right can recognize different symbols, for example, ‘+−++’, which corresponds to a Barker 4 code. In FIG. 71B, a large array 7102 comprises smaller arrays 414 and inverted arrays 414′. In FIG. 71C, a large array 7104 has different areas that are made up of different sizes of a 3×3 array 2202, which might be described as having different densities. Referring to FIG. 71C, first and second arrays 2202a and 2202b form a first area having a first density, a third array 2202c forms a second area having a second density, fourth and fifth arrays 2202d and 2202d form a third area having a third density, and a sixth array 2202f forms a fourth area having a fourth density. FIG. 71D depicts a large array 7006 that comprises three separated rows of truncated triangular trihedral corner reflector arrays that can be used to determine a location or to calibrate a sensor system. Referring to FIG. 71D, the top row comprises three arrays of equilateral truncated triangular trihedral corner reflectors truncated with a 60° truncation rotation angle. The middle row comprises three arrays of equilateral truncated triangular trihedral corner reflectors truncated with a 30° truncation rotation angle and the bottom row comprises three arrays 900a of triangular trihedral corner reflectors, which correspond to a 0° (or non-truncation) truncation angle for equilateral triangle truncation of a triangular trihedral corner reflector. Similarly, arrays having different non-vertical axis angles can be combined. Moreover, energy reflections from such arrays can be used to determine a location of an object based on a priori knowledge of the configuration of the arrays having different energy reflection characteristics.

In accordance with an aspect of the invention, truncated trihedral corner reflector arrays having a known geometry having known retro-reflecting and scattering characteristics, energy sources (e.g., light sources) and sensors (e.g., light sensors) can be used to determine information about an object (e.g., an autonomous vehicle, a body, a robot, etc.) such as its location, its shape, and/or other characteristics.

In accordance with an aspect of the invention, arrays comprising truncated trihedral corner reflectors produced in accordance with the invention can be configured to form images or words. For example, an array might contain inverted portions arranged to spell out a word that can be recognized by a person. Similarly, such arrays may be arranged to include a watermark that can be detected using one or more light sources and one or more sensors.

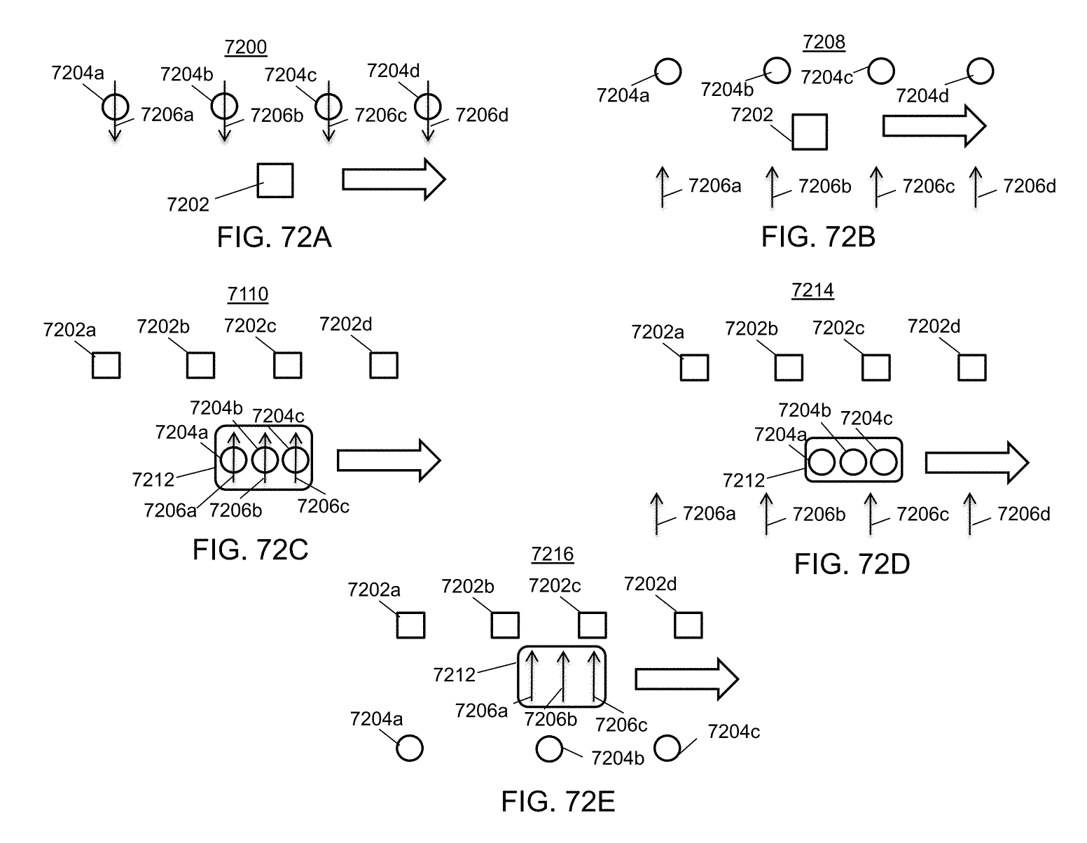

FIGS. 72A-72E depict various architectures for determining information about an object. Referring to FIG. 72A, a first architecture 7200 comprises a truncated trihedral corner array 7202 that is shown moving relative to a fixed array of four sensors 7204a-7204d co-located with an array of four energy sources 7206a-7206d. Referring to FIG. 72B, a second architecture 7208 comprises a truncated trihedral corner array 7202 that is shown moving by a fixed array of four sensors 7204a-7204d that is located separate from a fixed array of four energy sources 7206a-7206d. Referring to FIG. 72C, a third architecture 7210 comprises an object 7212 upon which a fixed array of three sensors 7204a-7204c and a fixed array of three energy sources 7206a-7206c are co-located is shown moving past an array of four fixed truncated trihedral corner arrays 7202a-7202d. Referring to FIG. 72D, a fourth architecture 7214 comprises an object 7212 upon which a fixed array of three sensors 7204a-7204c is shown moving past an array of four fixed truncated trihedral corner arrays 7202a-7202 and a separately located array of four energy sources 7206a-7206d. Referring to FIG. 72E, a fifth architecture 7216 comprises an object 7212 upon which a fixed array of three energy sources 7206a-7206c is shown moving past an array of four fixed truncated trihedral corner arrays 7202a-7202 and a separately located array of three sensors 7204a-7204d. Although the various arrays shown in the FIGS. 72A-72E are one-dimensional they could instead be two-dimensional or three-dimensional arrays.

The methods of vertical and non-vertical truncation described above could be described as using the outer perimeter of the opening of the triangular trihedral corner reflector 100 being truncated as a boundary within which a given truncating object is always contained, where the size of the truncating object is reduced as it is rotated relative to the triangular trihedral corner reflector 100 and where the two-dimensional perimeter shape (i.e., the front view) of a resulting truncated corner array always has the same perimeter shape as the truncating object (i.e., equilateral triangle, right isosceles triangle, isosceles triangle, or rectangle). In accordance with an aspect of the invention, these vertical and non-vertical truncation methods (i.e., with and without an offset) can be modified such that a unit size (1.0) for a given truncating object (i.e., equilateral triangle, right isosceles triangle, isosceles triangle, or rectangle) is defined based on the boundary of the triangular trihedral corner reflector 100 for a given truncation rotation angle but the actual size of the truncating object can be greater than the unit size, where the shape of the resulting truncated corner reflector corresponds to the portion of the truncating object that is within the boundary (or perimeter) of the opening of the triangular trihedral corner reflector 100. For simplicity, the unit size can be normalized as being the 1.0 size and the actual size of the truncating object can be described as having a relative size Z (e.g., 1.2) relative to the unit size 1.0, which means the actual size is Z times the unit size. It can be noted that a equilateral triangle truncating object having a relative size Z of 2.0 and a truncation rotation angle of 60° will produce the symmetrically truncated trihedral corner reflector 310 of FIG. 3C.

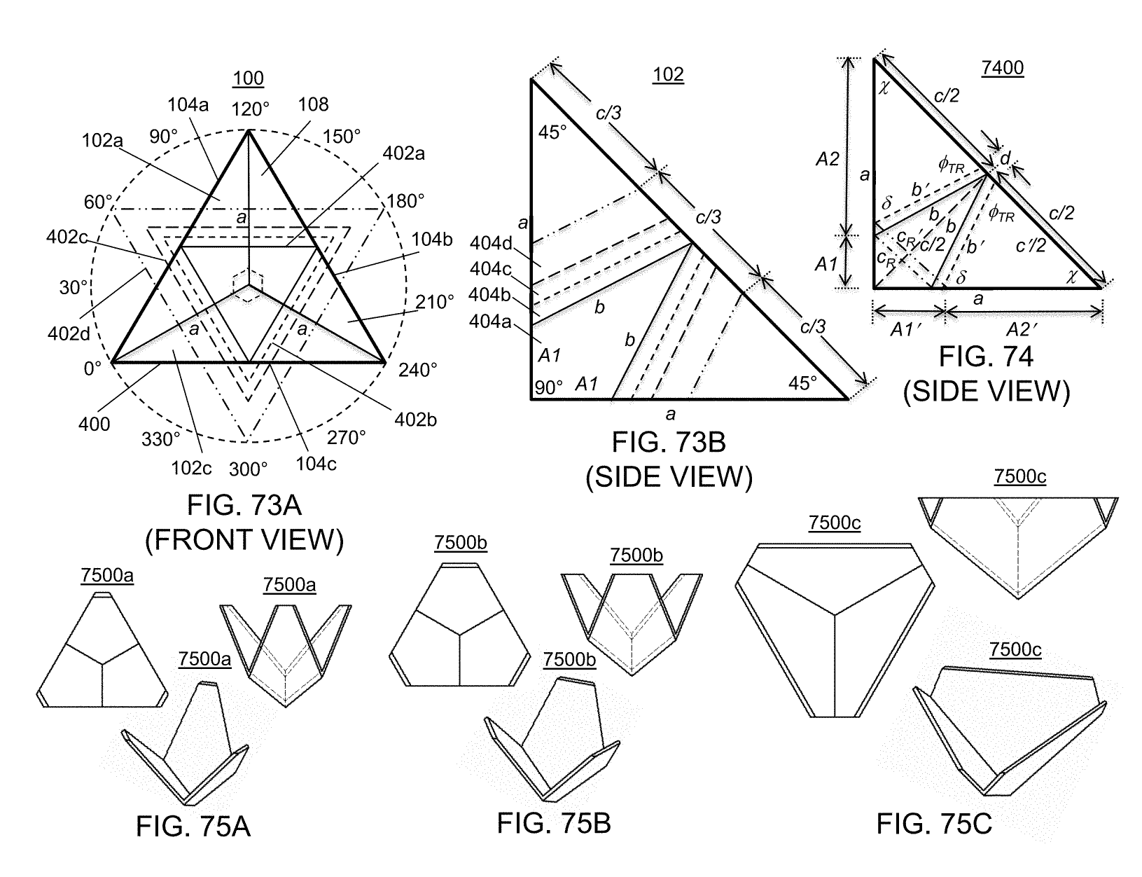

FIG. 73A depicts three exemplary centered equilateral triangle vertical truncation scenarios involving first, second, third, and fourth truncating equilateral triangles 402a-402d each having a 60° truncation rotation angle. Referring to FIG. 73A, the first truncating equilateral triangle 402a has a unit size of 1.0 as defined by the boundary of the triangular trihedral corner reflector 100 and is the same as the truncating equilateral triangle 402 shown in FIG. 4A. The second, third, and fourth truncating equilateral triangles 402b-402d have relative sizes Z of 1.25, 1.5, and 3.0 relative to the unit size 1.0 of the first equilateral triangle 402a.

FIG. 73B, which is similar to FIG. 4D, depicts an exemplary face 102 of a triangular trihedral corner reflector 100, which is a right isosceles triangle having two sides of length a and a third side of length c. Referring to FIG. 73B, a right kite shaped face 404a is shown having a solid boundary that is produced by the vertical truncation of a triangular trihedral corner reflector 100 using the unit sized truncating equilateral triangle 402a of FIG. 73A. Three other faces 404b-404d corresponding to vertical truncations using truncating equilateral triangles having sizes Z greater than unit sizes (e.g., 1.25, 1.5, 3.0) are indicated by small dashed lines, large dashed lines, and dash double dot lines, respectively, which are intended to be representative and not necessarily to scale, where the fourth face 404d corresponds to the prior art truncation of the triangular trihedral corner reflector 100 using a truncating hexagon shape such as depicted in FIG. 3C. With the modified vertical and non-vertical truncations, the maximum relative size Z of a truncating equilateral triangle having a 60° truncation rotation angle must be less than 4.0 times the unit size, where a truncating equilateral triangle that is greater than or equal to 4.0 times the unit size would not truncate the triangular trihedral corner reflector 100.

FIG. 74 depicts an exemplary mathematical model 7400 for the truncation of outer triangle shaped portions from each of the three faces of a triangular trihedral corner reflector 100 to produce the faces of a truncated triangular trihedral corner reflector in accordance with the modified centered equilateral triangle vertical truncation method described in relation to FIGS. 73A and 73B, where the outer triangle shaped portions each have a side having a length b and a corner having an angle χ that both remain constant regardless of a right isosceles triangle truncation angle ϕ_{TR}. The outer triangle shaped portions also have two other sides having lengths A2 and c′/2 and another corner having an angle δ that vary with the right isosceles triangle truncation angle ϕ_{TR}. The mathematical model 7400 has the following governing equations:

χ=45°

c_{R}/c=s_{R}/s

A1=c_{R}/√2

b=√((c_{R}/2)²+(3c/8)²)

A2=a−A 1

ϕ_{TR}=sin⁻¹(A2 sin(45°/b)

δ=180°−45°−ϕ_{TR}=135°−ϕ_{TR}

A1′=Z*A1

A2′=a−A1′

c_{R}′=Z*c_{R}

b′=sin(45°)A2′/sin(ϕ_{TR})

c′/2=sin(δ)A2′/sin(θ_{TR})

d=2(c/2−c′/2)=c−c′

In accordance with the invention, mathematical models similar to the exemplary mathematical model 7400 depicted in FIG. 74 can be produced to mathematically model the truncation of the faces of a triangular trihedral corner reflector 100 by truncating equilateral triangles or other truncating object shapes having different truncation rotation angles, offsets, and/or non-vertical axis angles (i.e., with or without offsets).

FIG. 75A-75C depict multiple views of exemplary truncated trihedral corner reflectors 7500a-7500c, which were produced in accordance with the invention using the modified centered equilateral triangle vertical truncation method and truncating equilateral triangles having 60° truncation rotation angles and relative sizes Z of 1.25, 1.5, and 3.0 times the unit size, respectively.

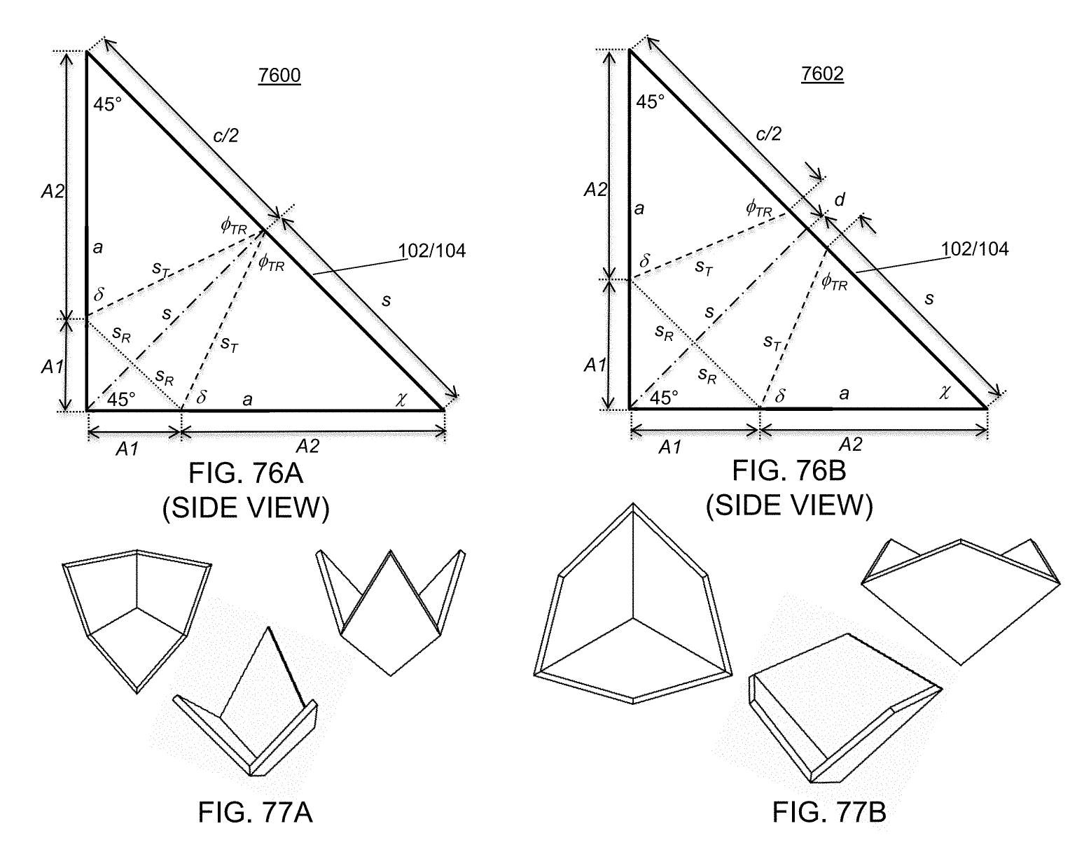

An alternative method for truncating a triangular trihedral corner reflector 100 in accordance with the invention involves truncating its three faces that are each right isosceles triangles based on the mathematical model 7600 that is depicted in FIG. 76A, where equal triangular portions of the two congruent corners of the faces are removed to produce truncated faces having various right kite shapes that can be assembled into a truncated triangular trihedral corner reflector in the same manner previously described. The equal triangular portions are defined by a right isosceles triangle truncation angle ϕ_{TR} that corresponds to the truncation rotation angle θ_{TR} of a truncating equilateral triangle used to truncate a triangular trihedral corner reflector 100 as previously described, where the right isosceles triangle truncation angle ϕ_{TR} corresponds to the angles between the hypotenuse side of the face and lines extending from a point corresponding to the halfway point of the hypotenuse side of the face being truncated to each of the two opposite faces, where the isosceles triangle truncation angle ϕ_{TR} must be greater than 0°, less than 90° and not equal to 45°. As with the previous described truncation methods, the ratio of energy retro-reflection to energy scattering by the array can be controlled based on an A2/A1 ratio, an s/s_{R} ratio, a right isosceles triangle truncation angle ϕ_{TR}, etc. The mathematical model 7600 has the following governing equations:

χ=45°

A1+A2=a

A1=√2s_{R}

A2/sin(ϕ_{TR})=s_{T}/sin(45°)=s/sin(δ)

δ=180°−45°−ϕ_{TR}=135°−ϕ_{TR}

s_{T}/s=sin(45°)/((sin(135°)cos(ϕ_{TR})−cos(135°)sin(ϕ_{TR}))=1/(cos(ϕ_{TR})+sin(ϕ_{TR}))

A2/s=sin(ϕ_{TR})/sin(δ)

sin(ϕ_{TR})=A2sin(45°)/s_{T}

s_{T}=√((s−s_{R})²+s_{R}²)

It can be noted that a right isosceles triangle truncation angle ϕ_{TR} equal to 45° produces a prior art square trihedral corner reflector 200 such as is depicted in FIGS. 2A-2C and a right isosceles triangle truncation angle ϕ_{TR} substantial equal to 71.57° produces the truncated triangular trihedral corner reflector 406 of FIGS. 4F-4X.

In accordance with another aspect of the invention, the truncation method corresponding to the mathematical model 7600 of FIG. 76A can be modified from where the right isosceles triangle truncation angle ϕ_{TR} corresponds to the angles between the hypotenuse side of the face and lines extending from a point corresponding to the halfway point of the hypotenuse side of the face being truncated to each of the two opposite faces to a truncation method corresponding to the mathematical model 702 of FIG. 76B to where the right isosceles triangle truncation angle ϕ_{TR} corresponds to the angles between the hypotenuse side of the face and lines extending from points equally offset from the halfway point of the hypotenuse side of the face being truncated to the closest sides of the two opposite faces.

FIGS. 77A and 77B depict exemplary truncated trihedral corner reflectors produced in accordance with the mathematical model 7600 of FIG. 76A for A2/A1 ratios of 2:1 and 1:2, respectively.

In accordance with the invention, a reflective surface can be defined by abutting a pyramid that has a base having N sides each of length c with N triangular trihedral corner reflectors each having an opening having sides of length c such that each side of the base of the pyramid is aligned with a side of the opening of one of the N triangular trihedral corner reflectors. In one arrangement, each of a plurality of pyramids that each has a base having N sides each of length c is abutted with N triangular trihedral corner reflectors each having an opening having sides of length c such that each side of the base of each of the plurality of pyramids is aligned with a side of the opening of one of N triangular trihedral corner reflectors, where optionally at least one triangular trihedral corner reflector abuts one of the plurality of pyramids on each of the three sides of the opening of the triangular trihedral corner reflector, where a given pyramid of the plurality of pyramids may be inverted.

In accordance with various optional aspects of the invention, one or more flat surfaces of an array may be replaced by an outer boundary about an opening, where in one arrangement a plurality of flat surfaces are replaced with outer boundaries and opening such that the array at least partially comprises a lattice. The openings of at least one corner reflector in an array may be in a first plane and the base of at least one pyramid in an array may be in a second plane different from the first plane.

The invention can be used in various applications such as:

Safety reflectors on vehicles, buildings, planes, boats, motorcycles, bicycles, trailers.

Road reflectors, Reflective coatings on signs (e.g., road signs).

Safety signage (e.g., a reflective device on a bridge, a buoy, a jetty, etc.)

Reflective panels on walls (e.g., beneath cabinets, bathroom walls) vehicles

Glass/plastic surfaces (e.g., table tops, shelving, windows, door glass)

Photography backdrops, Back reflectors for lighting, Light diffusers, lighting covers

Wall tiles, ceiling tiles, architectural tiles, ceiling medallions

Electrical outlet and switch covers

Holiday decorations and ornaments, picture frames, coasters, mirrors,

Sensor (e.g., LIDAR or radar) targets used for locating, tracking, guidance control

Reflective surfaces to support imaging (e.g., MRI)

Reflective surfaces used with LEDs, liquid crystal display (LCD) screens

While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements which embody the spirit and scope of the present invention.

1. A reflective surface, comprising:
a plurality of first truncated triangular trihedral corner reflectors each having three first faces; and
a plurality of second truncated triangular trihedral corner reflectors each having three second faces, said plurality of first truncated triangular trihedral corner reflectors and said plurality of second truncated trihedral corner reflectors being configured into an array where outer edges of each one of the three first faces of a first truncated triangular trihedral corner reflector of said plurality of first truncated triangular trihedral corner reflectors aligns with outer edges of a corresponding one of the three second faces of a corresponding second truncated triangular trihedral corner reflector of said plurality of second truncated trihedral corner reflectors, each of said three first faces and each of said three second faces comprising:
a retro-reflecting component portion; and
a scattering component portion, said retro-reflecting component portion and said scattering component portion corresponding to a truncation of a triangular trihedral corner reflector by a truncating object having a plurality of corners, a plurality of sides, and one of a triangular shape or a rectangular shape, each said first truncated triangular trihedral corner reflector of said plurality of first truncated triangular trihedral corner reflectors and each said second truncated triangular trihedral corner reflector of said plurality of second truncated triangular trihedral corner reflectors having a remaining triangular trihedral corner reflector, said scattering component portion aligning with additional scattering component portions in said array to produce a scattering component, wherein during the truncation of the triangular trihedral corner reflector no corner of the plurality of corners of the truncating object and no side of the plurality of sides of the truncating object is in alignment with a corner of an opening of the triangular trihedral corner reflector when the truncating object has a rectangular shape.

2. The reflective surface of claim 1, wherein said triangular shape is an equilateral triangle.

3. The reflective surface of claim 1, wherein said triangular shape is an isosceles triangle.

4. The reflective surface of claim 3, wherein said isosceles triangle is a rectangular isosceles triangle.

5. The reflective surface of claim 1, wherein said rectangular shape has a length to width ratio of 1.0.

6. The reflective surface of claim 1, wherein said truncation is a non-vertical truncation.

7. The reflective surface of claim 1, wherein said truncation is an offset truncation.

8. The reflective surface of claim 1, wherein the plurality of first truncated triangular trihedral corner reflectors are complementary to the plurality of second truncated triangular trihedral corner reflectors.

9. The reflective surface of claim 8, wherein each first truncated triangular trihedral corner reflector is tiled with one or more second truncated triangular trihedral corner reflectors, and each second truncated triangular trihedral corner reflector is tiled with one or more first truncated triangular trihedral corner reflectors.

10. The reflective surface of claim 1, wherein each face of each of the first truncated triangular trihedral corner reflectors has a first shape that is the mirror image of a second shape of each face of each of the second truncated triangular trihedral corner reflectors.

11. The reflective surface of claim 10, wherein said first shape and said second shape are each right trapezoids.

12. The reflective surface of claim 1, wherein each face of each of the first truncated triangular trihedral corner reflectors has the same size and shape as each face of each of the second truncated triangular trihedral corner reflectors.

13. The reflective surface of claim 1, wherein each face of each of the first truncated triangular trihedral corner reflectors and each face of each of the second truncated triangular trihedral corner reflectors is a right kite.

14. The reflective surface of claim 1, wherein a plurality of said scattering components combine to form a pyramid.

15. The reflective surface of claim 14, wherein said pyramid is a hexagonal pyramid.

16. The reflective surface of claim 1, wherein said reflective surface comprises one of a metal material, a glass material, a plastic material, a rubber material, a foam material, a wood material, or a cardboard material.

17. The reflective surface of claim 1, wherein said reflective surface is constructed using one of a 3D printing process, a molding process, a machining process, a glass cutting process, a chemical vapor deposition process, a laser etching process, or a metal stamping process.

18. A reflective surface, comprising:
a plurality of first truncated triangular trihedral corner reflectors each having three first faces; and
a plurality of second truncated triangular trihedral corner reflectors each having three second faces, said plurality of first truncated triangular trihedral corner reflectors and said plurality of second truncated triangular trihedral corner reflectors being configured into an array where the outer edges of each one of the three first faces of the first truncated triangular trihedral corner reflector of said plurality of first truncated triangular trihedral corner reflectors aligns with the outer edges of faces of a corresponding one of the three second faces of a corresponding second truncated triangular trihedral corner reflector of said plurality of second truncated triangular trihedral corner reflectors, each of said three first faces and each of said three second faces comprising:
a retro-reflecting component portion; and
a scattering component portion, said retro-reflecting component portion and said scattering component portion corresponding to a truncation of a triangular trihedral corner reflector by a truncating object having an equilateral triangular shape and having a truncation rotation that is one of 30°, 60°, or 90° relative to said triangular trihedral corner reflector.

19. A method for producing a reflective surface, comprising:
producing a plurality of first truncated triangular trihedral corner reflectors each having three first faces; and
producing a plurality of second truncated triangular trihedral corner reflectors each having three second faces, said plurality of first truncated triangular trihedral corner reflectors and said plurality of second truncated trihedral corner reflectors being configured into an array where outer edges of each one of the three first faces of a first truncated triangular trihedral corner reflector of said plurality of first truncated triangular trihedral corner reflectors aligns with outer edges of a corresponding one of the three second faces of a corresponding second truncated triangular trihedral corner reflector of said plurality of second truncated trihedral corner reflectors, each of said three first faces and each of said three second faces comprising:
a retro-reflecting component portion; and
a scattering component portion, said retro-reflecting component portion and said scattering component portion corresponding to a truncation of a triangular trihedral corner reflector by a truncating object having a plurality of corners, a plurality of sides, and one of a triangular shape or a rectangular shape, each said first truncated triangular trihedral corner reflector of said plurality of first truncated triangular trihedral corner reflectors and each said second truncated triangular trihedral corner reflector of said plurality of second truncated triangular trihedral corner reflectors having a remaining triangular trihedral corner reflector, said scattering component portion aligning with additional scattering component portions in said array to produce a scattering component, wherein during the truncation of the triangular trihedral corner reflector no corner of the plurality of corners of the truncating object and no side of the plurality of sides of the truncating object is in alignment with a corner of an opening of the triangular trihedral corner reflector when the truncating object has a rectangular shape.

20. The method of claim 19, wherein said truncating object has an equilateral triangular shape and a truncation rotation that is one of 30°, 60°, or 90° relative to said triangular trihedral corner reflector.
